(19) United States
(12) Patent Application Publication
(10) Pub. No.: US 2010/0025641 A1
(43) Pub. Date: Feb. 4, 2010

(54) INFRARED REGION SELECTIVE REFLECTION COAT AND INFRARED REGION SELECTIVE REFLECTION FILM

(75) Inventors: Yoshihiro Jimbo, Fujinomiya-shi (JP); Masaki Okazaki, Minami-ashigara-shi (JP); Yasuhiro Aiki, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/533,460

(22) Filed: Jul. 31, 2009

(30) Foreign Application Priority Data
Aug. 4, 2008 (JP) 2008-201307

(51) Int. Cl. G02B 5/26

(52) U.S. Cl. 252/587

(57) ABSTRACT

An infrared region selective reflection coat, having a layer exhibiting a structural color of which a central wavelength of a selective reflection band is in the range of 700 nm to 2,000 nm,

wherein the infrared range selective reflection coat satisfies at least one of the following requirements A and B:
A: the layer exhibiting a structural color contains a compound having a light-sensitive functional group; and
B: the infrared range selective reflection coat further comprises a layer containing an infrared-absorbing dye or pigment having absorption maximum in the range of 700 nm to 2,000 nm and a half bandwidth of its absorption band in the range of 20 nm to 200 nm.

### FIELD OF THE INVENTION

The present invention relates to coats and films, both of which are able to reflect selectively a ray of light in the infrared wavelength that is released together with a visible light and an ultraviolet light from the sun, particularly a ray of light in the infrared wavelength range that causes rise of temperature.

### BACKGROUND OF THE INVENTION

A great attention has been given to efforts to suppress global warming. Suppression of carbon-dioxide emissions is one of important techniques for reduction of global warming. One of the problems to be solved is to find the way how to curb energy consumption while maintaining a comfortable life at the present time.

For example, rise of temperature in a room owing to infrared ray in sunlight penetrated through a window glass increases a quantity of energy necessary for refrigerated air conditioning in the summer season. In order to suppress such rise of temperature in a room, a means for blocking off the infrared ray has been practiced by a method of reflecting or absorbing the infrared ray with a multilayer film using various kinds of inorganic or organic materials. However, such the method allows blocking of the infrared ray which is useful for rising room temperature in the winter season. On the contrary, the method eventually increases energy from a load for air heating. Particularly, a single use of absorbent is not advantageous, for example, in that the absorbent rises temperature of the window glass portion.

Accordingly, it has been desired to develop a material with which although an infrared ray is blocked in the summer season, the infrared ray is penetrated in the winter season. Further, it has been desired to respond to a demand for daily range as well as annual range in temperature. If such the function is developed by the use of window glass, it is desired to develop functions as advertising media and visual amenity developing media in addition to a designing property.

In response to the former demand, a multilayer optical film is disclosed in JP-A-2004-29181 (“JP-A” means unexamined published Japanese patent application). Further it has been desired to achieve requirements of a simple and superior method as well as a designing property.

### SUMMARY OF THE INVENTION

The present invention resides in an infrared region selective reflection coat, comprising a layer exhibiting a structural color of which a central wavelength of a selective reflection band is in the range of 700 nm to 2,000 nm,

wherein the infrared region selective reflection coat satisfies at least one of the following requirements A and B:
A: the layer exhibiting a structural color contains a compound having a light-sensitive functional group; and
B: the infrared region selective reflection coat further has a layer containing an infrared-absorbing dye or pigment having absorption maximum in the range of 700 nm to 2,000 nm and a half bandwidth of its absorption band in the range of 20 nm to 200 nm, in addition to the layer exhibiting a structural color.

Further, the present invention resides in an infrared region selective reflection film, comprising a transparent support, and the above-described infrared region selective reflection coat formed on the transparent support.

Other and further features and advantages of the invention will appear more fully from the following description.

### DETAILED DESCRIPTION OF THE INVENTION

According to the present invention, there are provided the following means:

(1) An infrared region selective reflection coat, comprising a layer exhibiting a structural color of which a central wavelength of a selective reflection band is in the range of 700 nm to 2,000 nm,
wherein the infrared region selective reflection coat satisfies at least one of the following requirements A and B:
A: the layer exhibiting a structural color contains a compound having a light-sensitive functional group; and
B: the infrared region selective reflection coat further comprises a layer containing an infrared-absorbing dye or pigment having absorption maximum in the range of 700 nm to 2,000 nm and a half bandwidth of its absorption band in the range of 20 nm to 200 nm.
(2) The infrared region selective reflection coat as described in the above item (1), wherein a selective reflection band width of the layer exhibiting a structural color is in the range of 100 nm to 400 nm.
(3) The infrared region selective reflection coat as described in the above item (1) or (2), wherein the selective reflection band width of the layer exhibiting a structural color is wider than the half bandwidth of absorption band of the infrared-absorbing dye or pigment.
(4) The infrared region selective reflection coat as described in any one of the above items (1) to (3), wherein the layer exhibiting a structural color contains a cholesteric liquid crystalline phase.
(5) The infrared region selective reflection coat as described in the above item (4), wherein at least one of compounds forming the cholesteric liquid crystalline phase is represented by formula (I):

Q¹-L¹-Cy¹-L²-(Cy²-L³)n-Cy³-L⁴-Q² Formula (I)

wherein at least one of Q¹ and Q² is a polymerizable group; when only one of Q¹ and Q² is a polymerizable group, the other represents a hydrogen atom or an alkyl group; L¹ and L⁴ each independently represent a divalent linking group; L² and L³ each independently represent a single bond or a divalent linking group; Cy¹, Cy² and Cy³ each independently represent a divalent cyclic group; and n represents 0, 1 or 2.

(6) The infrared region selective reflection coat as described in any one of the above items (1) to (5), wherein the layer containing an infrared-absorbing dye or pigment comprises at least one kind of a cyanine dye, an oxonol dye, a squarylium dye, a diimmonium dye, an azomethine dye, a phthalocyanine dye, a metal chelate dye, a rylene-series dye, an aminium dye, and a quinone dye.
(7) The infrared region selective reflection coat as described in any one of the above items (4) to (6), wherein the layer exhibiting a structural color contains a compound forming the cholesteric liquid crystalline phase together with a compound capable of changing a helical pitch owing to light-sensitivity as the compound having a light sensitive functional group.
(8) The infrared region selective reflection coat as described in the above item (7), wherein the compound having a light-sensitive functional group is selected from the group consisting of cinnamic acid derivatives, azo benzene derivatives and binaphthol derivatives.
(9) The infrared region selective reflection coat as described in any one of the above items (1) to (8), comprising a pattern formed by at least one visible range selective reflection area and at least one infrared range selective reflection area.
(10) An infrared region selective reflection film, comprising a transparent support, and the infrared range selective reflection coat as described in any one of the above items (1) to (9) formed on the transparent support.
(11) The infrared region selective reflection film as described in the above item (10), wherein the layer exhibiting a structural color and the layer containing an infrared-absorbing dye or pigment are provided with the transparent support in this order from the support.

Further, if necessary, layers other than the layer exhibiting a structural color and the layer containing an infrared dye pigment may be additionally disposed in the aforementioned coats or films. Examples of the other layers include an alignment layer (oriented film), an ultraviolet-absorbing layer, an ultraviolet reflection layer, a protective layer, and an intermediate layer.

The infrared region selective reflection coat and the infrared region selective reflection film of the present invention are explained in detail below.

In the present specification, “to” denotes a range including numerical values described before and after it as a minimum value and a maximum value.

### [Compound Having a Light-Sensitive Functional Group]

In the present invention, the compound having a light-sensitive functional group means a compound having a functional group in which its structure is changed by light absorption (hereinafter sometimes referred to as a chiral compound). Herein, the compound having a functional group in which its structure is changed is a compound that causes at least one of photo-isomerization reaction, photo-dimerization reaction, and photo-degradation reaction.

Examples of the compound capable of photo-isomerization include compounds capable of stereo-isomerization or structural isomerization when being irradiated with a light. Specific examples of the photo-isomerization compound includes azobenzene compounds (such as those described in K. Ichimura et al., Langmuir, vol. 4, page 1214 (1988); K. Aoki et al., Langmuir, vol. 8, page 1007 (1992); Y. Suzuki et al., Langmuir vol. 8, page 2601 (1992); K. Ichimura et al., Appl. Phys. Lett., vol. 63, No. 4, page 449 (1993); N. Ishizuki, Langmuir, vol. 9, page 3298 (1993); N. Ishizuki, Langmuir, vol. 9, page 857 (1993)); hydrazono-keto ester compounds (such as those described in S. Yamamura et al., Liquid Crystals, vol. 13, No. 2, page 189 (1993)); stilbene compounds (such as those described in K. Ichimura et al., KOBUNSHI RONBUNSHU (Japanese Journal of Polymer Science and Technology) vol. 47, No. 10, p. 771 (1990)); binaphthol compounds (such as those described in Japanese Patent No. 4137436, V. P. Shibaev et. al., Liquid Crystals, vol. 21, page 327 (1996), and P. L. Nordio et. al., Liquid Crystals, vol. 24, page 219 (1998)); and spiro pyran compounds (such as those described in K. Ichimura et al., Chemistry Letters, page 1063 (1992); K. Ichimura et al., Thin Solid Films, vol. 235, page 101 (1993)). Among these compounds, when the compound is a polymer, the polymer having a residue of the compound at a main chain or a side chain is further included in the photo-isomerization compound. Among them, photo-isomerization compounds containing double bond structure of C═C or N═N are preferred, and azobenzene compounds containing double bond structure of N═N, succinic acid derivatives containing double bond structure of C═C, and stilbene compounds are particularly preferred.

Examples of the compound capable of photo-dimerization include compounds that can undergo addition reaction of two intermolecular groups to cyclize when being irradiated with a light. Specific examples of the photo-dimerization compounds include succinic acid derivatives such as those described in M. Schadt et al., J. Appl. Phys., vol. 31, No. 7, p. 2155 (1992); cumarine derivatives such as those described in M. Schadt et al., Nature, vol. 381, p. 212 (1996); chalcone derivatives such as those described in Toshihiro Ogawa et. al., Pre-Text of Liquid Crystal Discussion Meeting, 2AB03 (1997), and benzophenone derivatives such as those described in Y. K. Jang et al., SID Int. Symposium Digest, P-53 (1997); and further polymers having a residue of these compounds at a main chain or a side chain. Among them, succinic acid derivatives, cumarine derivatives and polymers having a residue of these compounds at a main chain or a side chain are preferable, and succinic acid derivatives and polymers having a residue of the succinic acid derivatives at a side chain are more preferable. Further, photochromic compounds (for example, spiropyran, fulgide, diarylethene) are also preferable.

The compound having a light-sensitive functional group is preferably selected from the group consisting of cinnamic acid derivatives, azo benzene derivatives and binaphthol derivatives, as described above. A use amount of the compound having a light-sensitive functional group is preferably in the range of 0.01 g/m² to 2.0 g/m², and more preferably in the range of 0.05 g/m² to 1.00 g/m².

### [Selective Reflection]

Herein, the “selective reflection” is a property that is able to reflect only a light of a certain wavelength, but transmit a light of the other wavelengths. The selective reflection uses the phenomenon of Bragg reflection. Specifically, the property is developed by a layered product having two or more layers, each of them being different from the other layer in refractive index with the proviso that the thickness of each layer is made smaller than the objective wavelength of light. For example, the selective reflection property is developed by superposing a substance having relatively high refractive index with no light absorption of the objective wavelength and a substance having relatively low refractive index with no light absorption of the objective wavelength one after the other so as to be a smaller thickness than the wavelength of light. For example, a wavelength selective reflection layer in which an oxidized inorganic material is formed on a transparent substrate by vacuum film production has been applied to a dichroic filter that is used for a laser-dielectric mirror or a liquid crystal projector. Also in the present invention, when the aforementioned wavelength selective reflection layer is formed, these techniques may be used. In consideration of wavelength selectivity in the above-wavelength range, a difference of refractive index between each of the layers and the other layer is preferably 0.05 or more, and more preferably 0.08 or more.

Alternatively, the aforementioned wavelength selective reflection layer may be formed by coating organic materials. For example, the wavelength selective reflection layer may be formed by the steps of coating a liquid crystal that is able to be oriented (aligned) to a spiral structure or to a lattice structure, and then orienting the liquid crystal to a spiral structure or to a lattice structure, followed by fixing the oriented state. Examples of the liquid crystal phase showing such the spiral structure or lattice structure include a cholesteric liquid crystal phase, a ferroelectric liquid crystal phase, an antiferroelectric liquid crystal phase, and a blue phase, each of which may be used in the present invention. Further, if the organic material has a periodic structure of the size ranging from a half to nearly one tenth of the objective wavelength of light, it is possible to show a selective reflection property despite of the aforementioned materials. Therefore, a photonic crystal that has a stop band in a wavelength range of light may be also used.

Among these materials, it is preferable to use a cholesteric liquid crystal in the wavelength selective reflection layer from advantages in that uniformity of optical property can be easily obtained and a selective reflection wavelength is easily adjusted. Further, the wavelength selective reflection layer can be formed by coating organic materials without the vacuum step such as vapor deposition. Therefore, products can be produced cheaper.

Herein, the selective reflection band means a band of a half width of wavelength range in which selective reflection is performed.

### [Infrared Range Selective Reflection Film Having Designing Property]

The present invention relates to coats and films each of which selectively reflects infrared ray that rises temperature by irradiation of the infrared ray particularly among rays contained in the sunlight, and further relates to the coats and films having a designing property.

The central wavelength of the selective reflection band of the layer exhibiting a structural color in the present invention is in the range of 700 nm to 2000 nm, preferably from 850 nm to 1500 nm, and more preferably from 900 nm to 1300 nm.

In one exemplary embodiment (the first embodiment) of the present invention, infrared rays are selectively reflected and a designing property is developed in a certain range by selective reflection that is achieved using a structural color represented by multilayer interference and photonic crystal. This embodiment is preferable in that the selective reflection range is changed by light or heat and thereby an objective design such as letters and pictures can be developed. For example, it is possible to develop the design by applying a change ability of spiral twisting power to a chiral compound in a cholesteric liquid crystal by means of light or heat, or alternatively by applying a change ability of volume to an (inverse) opal type photonic crystal by means of light or heat. The application of the change ability of spiral twisting power to a chiral compound in a cholesteric liquid crystal composition by means of light is described below.

Further, the other exemplary embodiment (the second embodiment) of the present invention enables to control a reflection ability of infrared rays, for example, so that the reflection ability is high in clear skies during the summer days, while the reflection ability is low particularly in cloudy weather during the winter days. When a dye or a pigment that absorbs infrared rays in a relatively narrow region and preferably has substantially no absorption in the visible part is added into the film, rise of temperature is caused. For example, light energy is converted to heat owing to absorption of infrared rays by the dye or the pigment, and then the converted heat is transmitted to a cholestric liquid crystalline phase, whereby the cholestric liquid crystalline phase being swollen. As a result, the pitch of the cholestric liquid crystal gets longer. Thereby the selective reflection band is changed from the selective reflection band close to the visual range to the wide infrared range. The selective reflection efficiency is not materially deteriorated on account that absorption band of the dye or the pigment that absorbs infrared rays is narrow.

Various materials that are used to prepare the coat and the film of the present invention are explained below.

### [Cholesteric Liquid Crystal]

The wavelength selective reflection layer that is composed of a cholesteric liquid crystal may be formed according to the steps of coating the cholesteric liquid crystal, if necessary as a solution of organic solvent thereof, on a transparent support or a preliminary substrate, evaporating the solvent, and then subjecting the liquid crystalline molecule to horizontal orientation, if necessary by heating, and thereafter making helical axes of the molecule nearly perpendicular to the substrate, followed by fixation. When the wavelength selective reflection layer is formed on the preliminary substrate, the wavelength selective reflection layer may be formed by transfer the same to the transparent support from the preliminary substrate.

The cholesteric liquid crystal is a liquid crystal phase that belongs to the same phase in thermodynamic terms as a nematic liquid crystal that is widely used in a liquid crystal display device such as a liquid crystal TV set. However, the cholesteric liquid crystal is different from the nematic liquid crystal in terms of the presence of helical structure. The helix of the cholesteric liquid crystal is induced by an optically active chiral compound. Therefore it is necessary that the chiral compound be contained in the cholesteric liquid crystal. If the chiral compound itself has a cholesteric liquid crystalline phase, the cholesteric liquid crystalline layer may be formed only by the chiral compound. However, from the viewpoints of easiness of controlling the below-described helical pitch and the anisotropy of refractive index, it is preferable to form a wavelength selective reflection layer according to the steps of mixing a nematic liquid crystal with a chiral compound to prepare a cholesteric liquid crystal composition or co-polymerized polymer, and then coating the resultant composition or the co-polymer.

The cholesteric liquid crystal has a periodic helical structure, and therefore has a wavelength selective reflection property with respect to the circularly-polarized light of torsional sense of the helix. In order to make the cholesteric liquid crystal show a wavelength selective reflection property having a reflection maximum intensity value in the range of 850 nm to 1500 nm, the concentration and/or the kind of the chiral compound are controlled so that a product of average refractive index of the liquid crystal multiplied by helical cycle length (helical pitch) is in the range of 850 nm to 1500 nm. An average refractive index of the ordinary liquid crystal is in the range of 1.5 to 1.7. Therefore, in order to achieve the optical properties required by the present invention, it is preferable to adjust the helical pitch after formation of the wavelength selective reflection layer to the range of about 500 nm to 1000 nm.

The helical pitch can be shortened, if a mixing ratio of the chiral compound is increased. Further, even though the concentration of the chiral compound is same, if a chiral compound having a strong twisting power is used, the helical pitch can be shortened. The twisting power of the chiral compound and the helical pitch of the cholesteric liquid crystal can be calculated by measuring the interval of generated defect lines using a wedge shaped cell (reference of measuring methods: Ekisyo Binran (Hand Book of Liquid Crystals), Maruzen, p. 196). Further, when the wavelength selective reflection layer is formed by using a polymerizable liquid crystal in the cholesteric liquid crystal composition, and then polymerizing the liquid crystal after orientation to fix the helical structure, the thickness of a coating membrane is constricted as a result of polymerization, and also the helical pitch becomes shorter in accordance with the constriction. Therefore, it is necessary to adjust the helical pitch in consideration of the aforementioned situation. However, a change in the thickness as a result of the polymerization is minor. Specifically, a degree of the change is about 10% or less, and ordinarily about 5%.

The selective reflection band width is a product of the helical pitch of the cholesteric liquid crystal multiplied by anisotropy (Δn=ne−no, ne: extraordinary light refractive index, no: ordinary light refractive index) of refractive index of the liquid crystal. Therefore, if a liquid crystal having a large Δn is used, a selective reflection band width can be made wider. By contraries, when a selective reflection band width is made narrower, a liquid crystal having a small Δn is used. Further, a band width can be made wider by multilayer-applying wavelength selective reflection layers so that the central wavelength of the selective reflection is displaced from each other by the band width. Further, a band width can be also made wider by forming a concentration distribution of the chiral compound in the thickness direction of the coating membrane of the cholesteric liquid crystal, thereby providing a distribution of the thickness direction of the helical pitch. The anisotropy of refractive index of the liquid crystal can be measured with Abbe's refractometer (Ekisyo Binran Henshyu Iinkai (Editorial Committee of Hand Book of Liquid Crystals), Ekisyo Binran (Hand Book of Liquid Crystals), Maruzen, date of publication: Oct. 30, 2000, p. 201).

In the present invention, the selective reflection band width of the layer exhibiting a structural color is preferably in the range of 100 nm to 400 nm.

The thicker the thickness of the liquid crystal layer is, the higher the reflectance of the selective reflection is. Further, the larger the Δn of the liquid crystal layer, the higher the reflectance of the selective reflection. When a liquid crystal having Δn of 0.2 is used, the circularly polarized reflectance increases as the thickness of the liquid crystal layer becomes larger. When the thickness is about 2.5 μm, about 100% of circularly polarized reflectance is achieved. Resultantly, though the thickness is increased more than about 2.5 μm, there is no change in reflectance. The aforementioned property may be used to adjust the reflectance by mainly controlling a thickness of coating. Further, the reflectance may be controlled by forming checker wise a selective reflection layer on a transparent support, and by changing a ratio of the selective reflection layer-forming area and the non selective reflection layer-forming area. Further, even though a circularly-polarized reflectance of the cholesteric liquid crystal layer is 100%, natural light reflectance drops as much as 50 percents. Therefore, a higher degree of natural light reflectance can be achieved with a wavelength selective reflection layer formed by multilayered cholesteric liquid crystal layers that are opposite to each other in twisting sense of the helix.

The selective reflection owing to a helical structure of the cholesteric liquid crystal is an interference phenomenon. Therefore, if a wavelength range of the reflection is within the visible range, the reflected light is seen as colored. However, the reflected light itself has no absorption, and therefore a total sum of a reflected light and a transmitted light is theoretically 100%. In the present invention, a designing property can be given by controlling the reflection wavelength range into an infrared range and a visible range. Further, a material having substantially no absorption can be formed by using the below-described nematic liquid crystalline compound together with the below-described chiral compound. A used amount of the cholesteric liquid crystal is preferably in the range of 0.3 g/m² to 30 g/m², and more preferably from 0.5 g/m² to 10 g/m². <<Nematic Liquid Crystalline Compound>>

As the nematic liquid crystal, azomethines, azoxys, cyanobiphenyls, cyanophenyl esters, benzoic acid esters, cyclohexanecarboxylic acid phenylesters, cyanophenyl cyclohexanes, cyano-substituted phenylpyrimidines, alkoxy-substituted phenylpyrimidines, phenyldioxanes, tolans, and alkenylcyclohexylbenzonitryls are preferably used. Not only these low molecular liquid crystals, but also polymer liquid crystals may be used.

In the present invention, it is more preferable that orientation is fixed by polymerization of the nematic liquid crystalline compound in the case of giving only a designing property (the first embodiment). On other hand, it is more preferable to use a moderately crosslinked polymer liquid crystal for the last time in the case of giving a function capable of varying infrared selective reflecting property in accordance with climate change (the second embodiment). Examples of the polymerizable liquid crystalline compound include polymerizable rod-shaped liquid crystalline compounds described in Makromol. Chem., Vol. 190, page 2255 (1989); Advanced Materials, Vol. 5, page 107 (1993); U.S. Pat. No. 4,683,327, U.S. Pat. No. 5,622,648, U.S. Pat. No. 5,770,107, WO 95/22586, WO 95/24455, WO 97/00600, WO 98/23580, WO 98/52905, JP-A-1-272551, JP-A-6-16616, JP-A-7-110469, JP-A-11-80081, JP-A-2001-328973 and the like. The polymerizable liquid crystalline compound represented by the following formula (I) is more preferable.

Q¹-L¹-Cy¹-L²-(Cy²-L³)ₙ-Cy³-L⁴-Q² Formula (I)

In formula (I), at least one of Q¹ and Q² is a polymerizable group; when only one of Q¹ and Q² is a polymerizable group, the other represents a hydrogen atom or an alkyl group; L¹ and L⁴ each independently represent a divalent linking group; L² and L³ each independently represent a single bond or a divalent linking group; Cy¹, Cy² and Cy³ each independently represent a divalent cyclic group; and n represents 0, 1 or 2.

In formula (I), at least one of Q¹ and Q² is a polymerizable group; and when only one of Q¹ and Q² is a polymerizable group, the other represents a hydrogen atom or an alkyl group. The polymerizable group means a group capable of performing a polymerization reaction. Specifically, the polymerizable group may be a group capable of forming a bond between functional groups of the same or different sorts. Examples of the polymerizable group include substituents described in S. R. Sandler, W, Karo, Organic Functional Group Preparations, Vol. 1-2, Academic Press New York & London (1968). Of these substituents, multiple bond-containing groups, in which constituent atoms may be carbon or non-carbon, and small-membered hetero ring such as oxylane and aziridine are preferable. Further preferable substituents are double bond-containing groups, specifically an acryloyl group, a vinyloxy group, and an epoxy group, as described in the reports by R. A. M. Hikmet et al. [Macromolecules, Vol. 25, p. 4194 (1992)] and [Polymer, Vol. 34, No. 8, p. 1736 (1993)], the report by D. J. Broer, [Macromolecules, Vol. 26, p. 1244 (1993)]. It is preferable that the polymerizable group is a group capable of initiating a polymerization reaction with application of light and/or heat in the presence of a polymerization initiator or the like. Examples of the polymerizable group include an acryloyl group, a methacryloyl group, and an epoxy group.

The polymerizable group is preferably selected from the functional group capable of performing an addition polymerization reaction which may be an open ring polymerization reaction; or performing a condensation polymerization reaction. Specific examples of the polymerizable group are described below. Herein, Et represents an ethyl group, and Pr represents a propyl group.

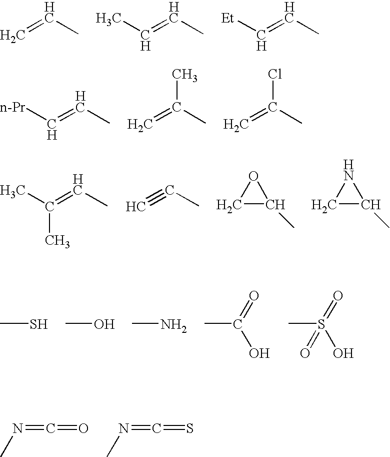

In formula (I), L¹ and L⁴ each independently represent a divalent linking group. It is preferable that the divalent linking group is selected from the group consisting of —O—, —S—, —CO—, —NR— wherein R represents a hydrogen atom (H) or a substituent selected from a methyl group, and an ethyl group, —CH═N—, —N═N—, a divalent chain group, a divalent cyclic group, and a combination of these groups. The aforementioned R² represents an alkyl group having 1 to 7 carbon atoms, or a hydrogen atom, R² is preferably an alkyl group having 1 to 4 carbon atoms, or a hydrogen atom, more preferably a methyl group, an ethyl group, or a hydrogen atom, and further preferably a hydrogen atom. Examples of the divalent linking group composed of these groups in combination are described below. Herein, the left of the divalent linking group bonds to Q (Q¹ or Q²), while the right bonds to Cy (Cy¹ or Cy³).

L-1: —CO—O-(divalent chain group)-O—
L-2: —CO—O-(divalent chain group)-O—CO—
L-3: —CO—O-(divalent chain group)-O—CO—O—
L-4: —CO—O-(divalent chain group)-O-(divalent cyclic group)-
L-5: —CO—O-(divalent chain group)-O-(divalent cyclic group)-CO—O—
L-6: —CO—O-(divalent chain group)-O-(divalent cyclic group)-O—CO—
L-7: —CO—O-(divalent chain group)-O-(divalent cyclic group)-(divalent chain group)-
L-8: —CO—O-(divalent chain group)-O-(divalent cyclic group)-(divalent chain group)-CO—O—
L-9: —CO—O-(divalent chain group)-O-(divalent cyclic group)-(divalent chain group)-O—CO—
L-10: —CO—O-(divalent chain group)-O—CO-(divalent cyclic group)-
L-11: —CO—O-(divalent chain group)-O—CO-(divalent cyclic group)-CO—O—
L-12: —CO—O-(divalent chain group)-O—CO-(divalent cyclic group)-O—CO—
L-13: —CO—O-(divalent chain group)-O—CO-(divalent cyclic group)-(divalent chain group)-
L-14: —CO—O-(divalent chain group)-O—CO-(divalent cyclic group)-(divalent chain group)-CO—O—
L-15: —CO—O-(divalent chain group)-O—CO-(divalent cyclic group)-(divalent chain group)-O—CO—
L-16: —CO—O-(divalent chain group)-O—CO—O-(divalent cyclic group)-
L-17: —CO—O-(divalent chain group)-O—CO—O-(divalent cyclic group)-CO—O—
L-18: —CO—O-(divalent chain group)-O—CO—O-(divalent cyclic group)-O—CO—
L-19: —CO—O-(divalent chain group)-O—CO—O-(divalent cyclic group)-(divalent chain group)-
L-20: —CO—O-(divalent chain group)-O—CO—O-(divalent cyclic group)-(divalent chain group)-CO—O—
L-21: —CO—O-(divalent chain group)-O—CO—O-(divalent cyclic group)-(divalent chain group)-O—CO—

In the above formula, the divalent chain group means an alkylene group, a substituted alkylene group, an alkenylene group, a substituted alkenylene group, an alkynylene group, or a substituted alkynylene group. The divalent chain group is preferably an alkylene group, a substituted alkylene group, an alkenylene group, or a substituted alkenylene group, and more preferably an alkylene group, or an alkenylene group.

The alkylene group may be branched. The carbon number of the alkylene group is preferably in the range of 1 to 12, more preferably from 2 to 10, and further preferably from 2 to 8. The alkylene moiety of the substituted alkylene group has the same meaning as those of the alkylene group. Examples of the substituent include a halogen atom.

The alkenylene group may be branched. The carbon number of the alkenylene group is preferably in the range of 2 to 12, more preferably from 2 to 10, and further preferably from 2 to 8. The alkenylene moiety of the substituted alkenylene group has the same meaning as those of the alkenylene group. Examples of the substituent include a halogen atom.

The alkynylene group may be branched. The carbon number of the alkynylene group is preferably in the range of 2 to 12, more preferably from 2 to 10, and further preferably from 2 to 8. The alkynylene moiety of the substituted alkynylene group has the same meaning as those of the alkynylene group. Examples of the substituent include a halogen atom.

Examples of the divalent chain group include ethylene, propylene, tetramethylene, 2-methyl-1,4-butylene, pentamethylene, hexamethylene, octamethylene, 2-butenylene, and 2-butynylene.

The definition and examples of the divalent cyclic group in the aforementioned formula are the same as the below-described definition and examples of Cy¹, Cy² or Cy³.

In formula (I), L² and L³ each independently represent a single bond or a divalent linking group. It is preferable that L² and L³ are each independently a divalent linking group selected from the group consisting of —O—, —S—, —CO—, —NR²—, a divalent chain group, a divalent cyclic group, and a combination of these groups, or a single bond. The aforementioned R² represents an alkyl group having 1 to 7 carbon atoms, or a hydrogen atom, preferably an alkyl group having 1 to 4 carbon atoms, or a hydrogen atom, more preferably a methyl group, an ethyl group, or a hydrogen atom, and further preferably a hydrogen atom. The definition of each of the divalent chain group and the divalent cyclic group is the same as those of L¹ and L⁴.

In formula (I), n represents 0, 1 or 2. When n is 2, two L³'s may be the same or different, and also two Cy 2's may be the same or different, n is preferably 1 or 2, and more preferably 1.

The polymerizable liquid crystalline compound represented by formula (I) is preferably represented by the following formula (I-1).

Q²¹L²¹-Cy²¹-L²³-Cy²²-L²³-Cy²³-L²⁴-Q²² Formula (I-1)

In formula (I-1), at least one of Q²¹ and Q²² is a group selected from an acryloyl group, a methacryloyl group, an epoxy group, or a vinyloxy group, and when any one of Q²¹ and Q²² is not a polymerizable group, Q²¹ or Q²² is a hydrogen atom, or an alkyl group.

L²¹ and L²⁴ are each independently a divalent linking group selected from the group consisting of —O—, —S—, —CO—, —NR— wherein R represents a hydrogen atom (H) or a substituent selected from a methyl group, and an ethyl group, —CH═N—, —N═N—, an alkylene group, a substituted alkylene group, an alkenylene group, a substituted alkenylene group, an alkynylene group, or a substituted alkynylene group and a combination of these groups.

L²² and L²³ are each independently a divalent linking group selected from the group consisting of —O—, —S—, —CO—, —NR²— wherein R represents a hydrogen atom (H) or a substituent selected from a methyl group and an ethyl group, an alkylene group, a substituted alkylene group, an alkenylene group, a substituted alkenylene group, an alkynylene group, or a substituted alkynylene group and a combination of these groups, or a single bond.

Cy²¹, Cy²² and Cy²³ each independently represent an aromatic ring group, an aliphatic ring group, or a heterocyclic group. Each of Cy²¹, Cy²² and Cy²³ may have a substituent.

In formula (I), Cy¹, Cy² and Cy³ each independently represent a divalent cyclic group. The ring of the divalent cyclic group is preferably a 5-, 6-, or 7-membered ring, more preferably a 5-, or 6-membered ring, and further preferably a 6-membered ring. The ring may be a single ring, or a condensed ring, but preferably a single ring. Further, the ring may be an aromatic ring, an alicyclic ring, or a hetero ring. Of these rings, preferable examples of the aromatic ring include a benzene ring (especially 1,4-phenylene group), and a naphthalene ring (especially naphthalene-1,5-diyl group, and naphthalene-2,6-diyl group). Preferable examples of the alicyclic ring include a cyclohexane ring (especially 1,4-cyclohexylene group), and bicyclo[2.2.2]octane ring. Preferable examples of the hetero ring include a pyridine ring (especially pyridine-2,5-diyl group), a pyrimidine ring (especially pyrimidine-2,5-diyl group), a thiophene ring (especially thiophene-2,5-diyl group), and dioxane ring. Each of Cy¹, Cy², and Cy³ may have a substituent. Preferable examples of the substituent include a halogen atom, a cyano group, a nitro group, an alkyl group having 1 to 5 carbon atoms, a halogen-substituted alkyl group having 1 to 5 carbon atoms, an alkoxy group having 1 to 5 carbon atoms, an alkylthio group having 1 to 5 carbon atoms, an acyloxy group having 2 to 6 carbon atoms, an alkoxycarbonyl group having 2 to 6 carbon atoms, a carbamoyl group, a carbamoyl group substituted with an alkyl group having 2 to 6 carbon atoms, and an acylamino group having 2 to 6 carbon atoms.

Preferable examples of the residue of the polymerizable rod-like liquid crystalline compound include a biphenyl group, a phenylenecarbonyloxybiphenyl group, a carbonyloxybiphenyl group, a terphenyl group, a naphthylenecarbonyloxyphenyl group, a phenyleneethenylenecarbonyloxybiphenyl group, a phenyleneethynylenephenyl group, a benzoic acid phenyl ester group, a benzylidene aniline group, an azobenzene group, an azoxybenzene group, a stylbene group, a phenyleneethynylenecarbonyloxybiphenyl group, a naphthylenebiphenyl group, and these groups in which the benzene ring is saturated, or the benzene ring is replace by a hetero ring.

As a cyclic group having a benzene ring, a 1,4-phenylene group is preferable. As a cyclic group having a naphthalene ring, naphthalene-1,5-diyl group, and naphthalene-2,6-diyl group are preferable. As a cyclic group having a cyclohexane ring, 1,4-cyclohexylene group is preferable. As a cyclic group having a pyridine ring, a pyridine-2,5-diyl group is preferable. As a cyclic group having a pyrimidine ring, a pyrimidine-2,5-diyl group is preferable.

Examples of the polymerizable liquid crystalline compound represented by formula (I) are described below. However, the present invention is not limited to these compounds. Herein, Et represents an ethyl group.

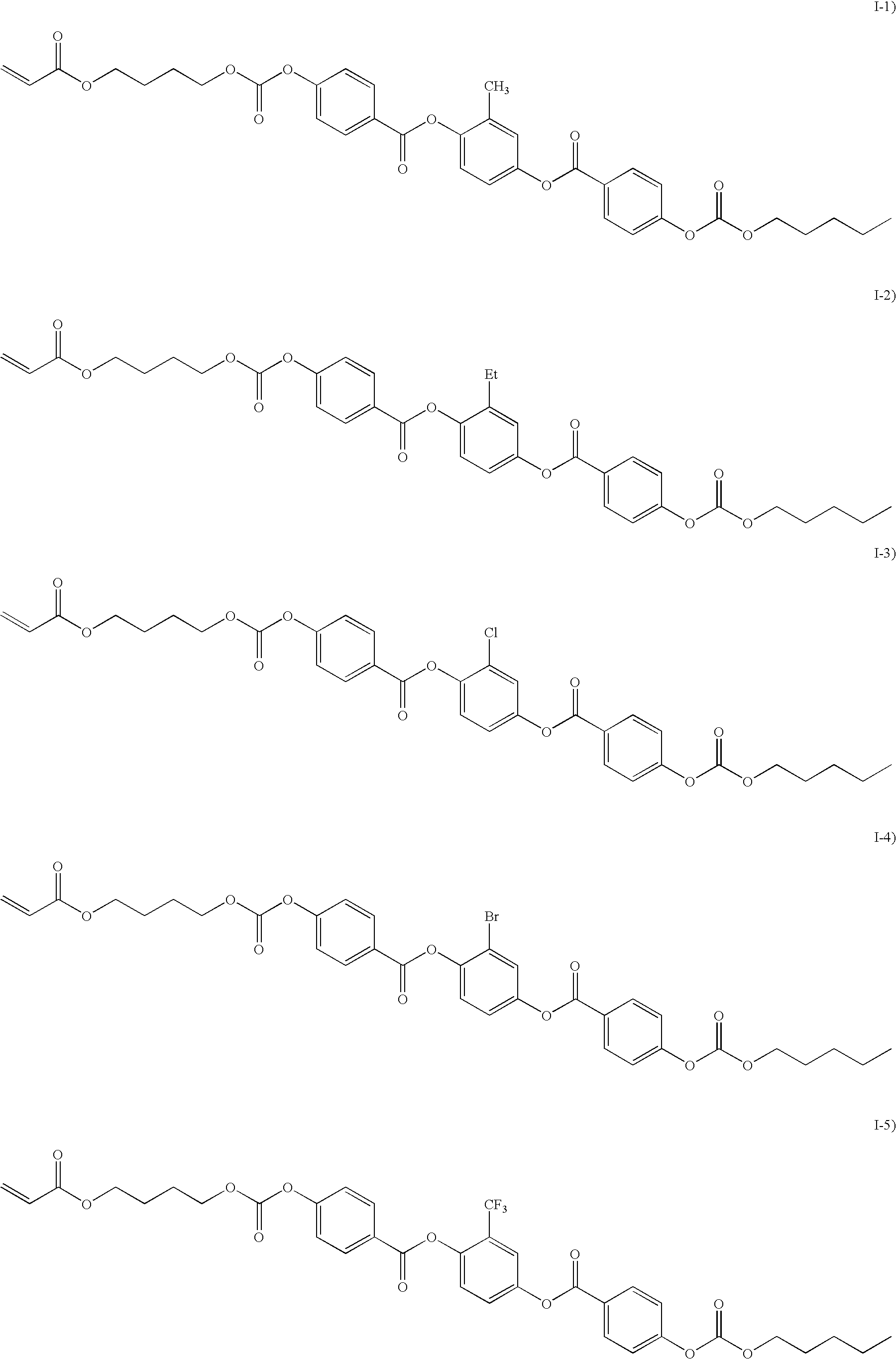

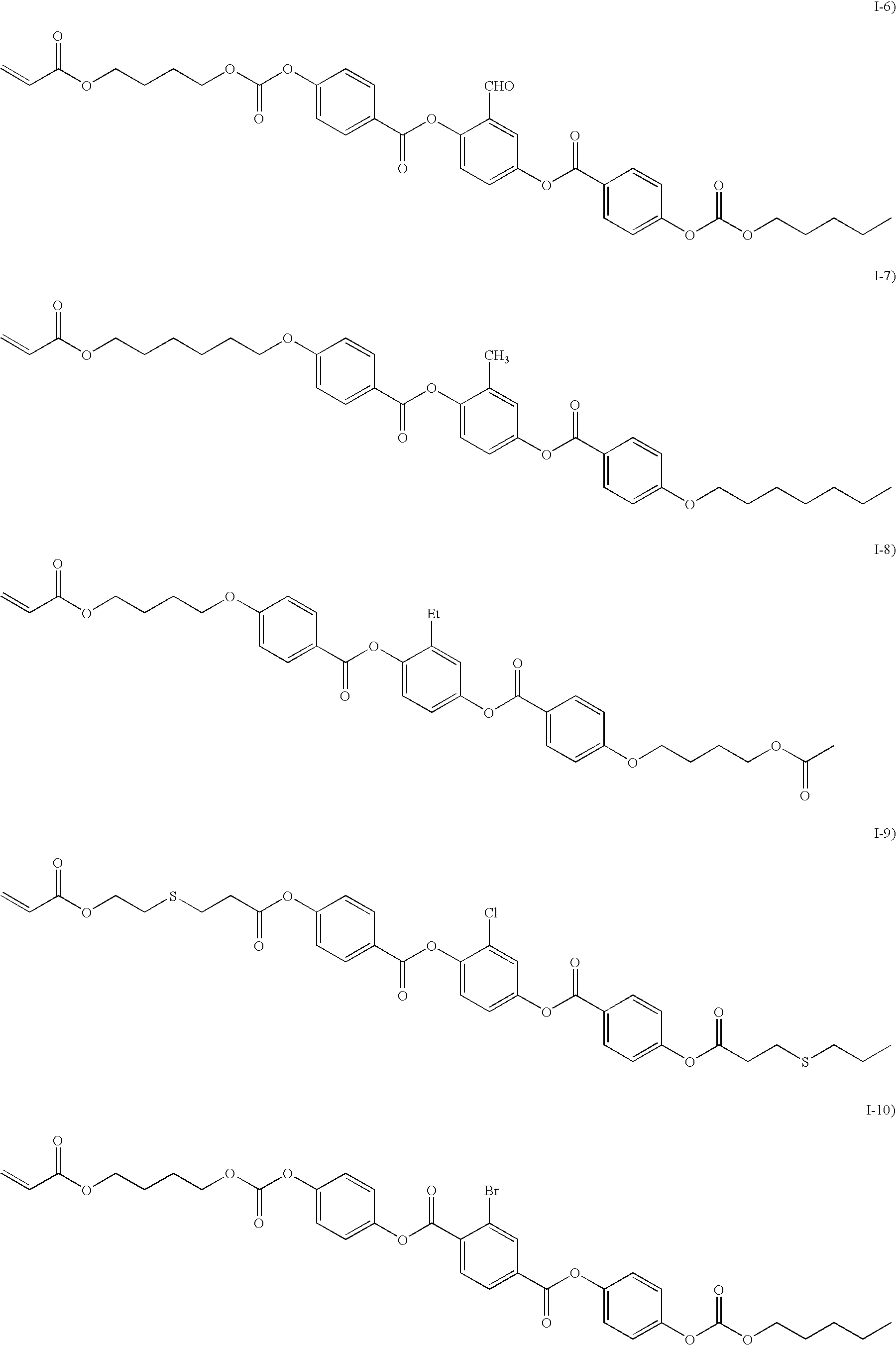

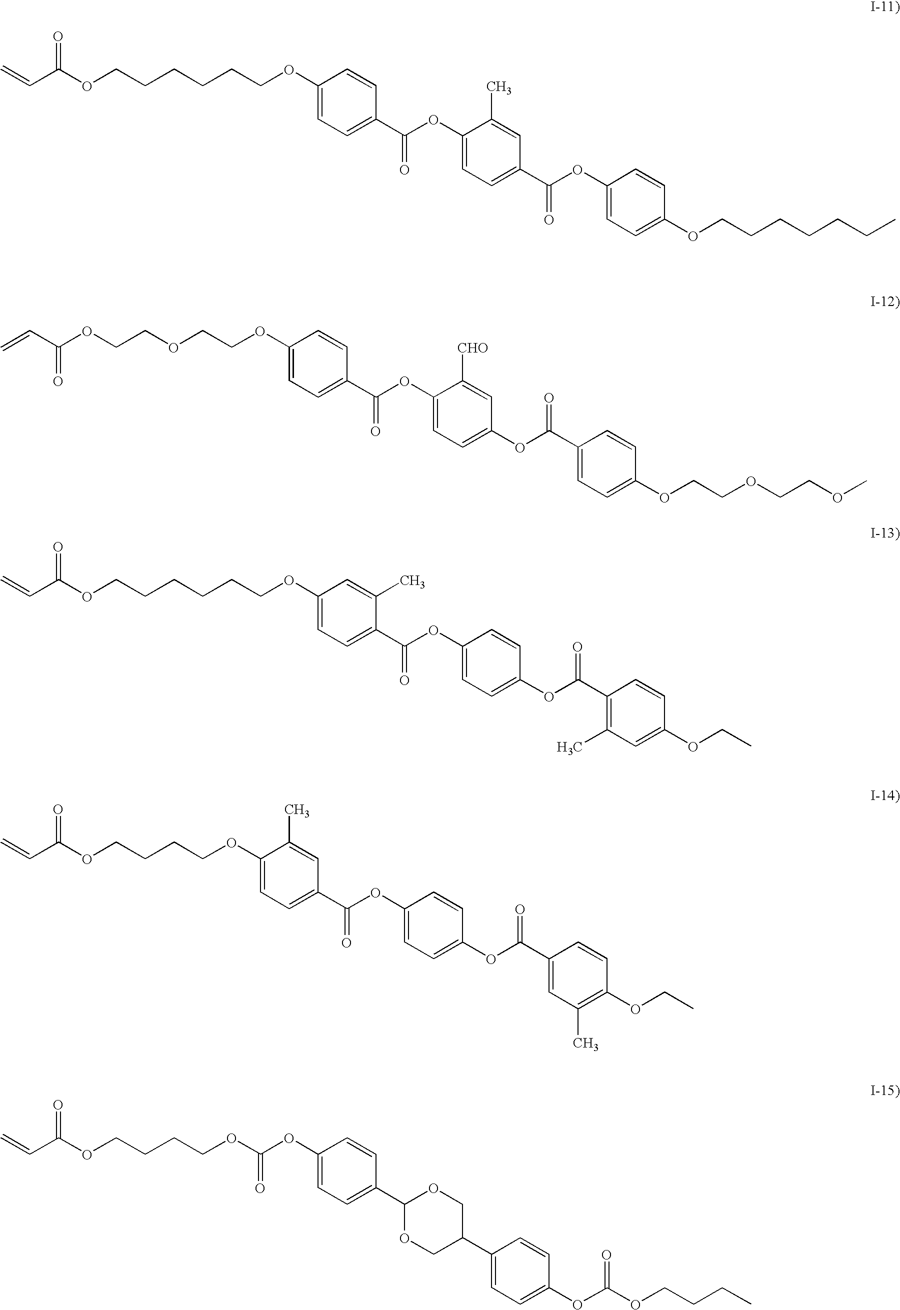

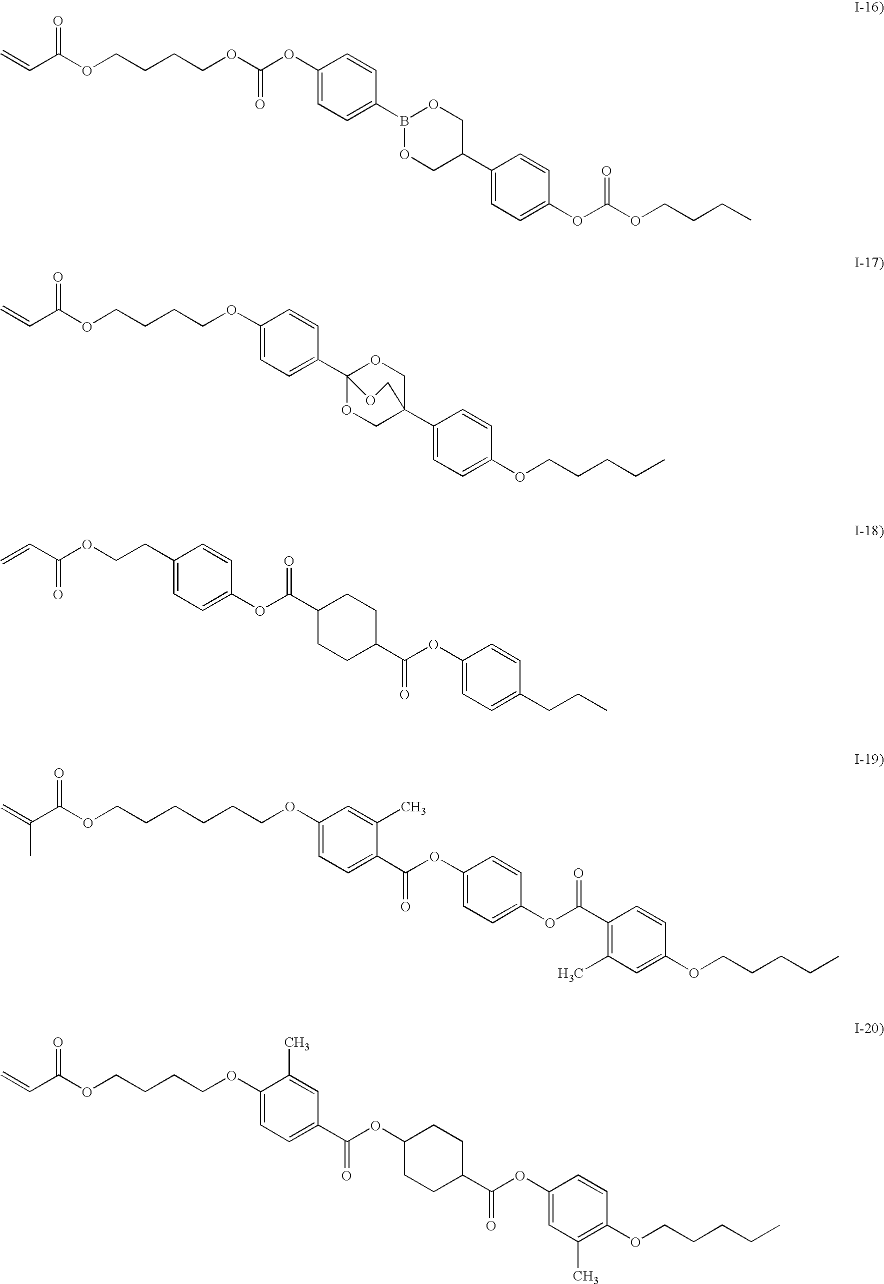

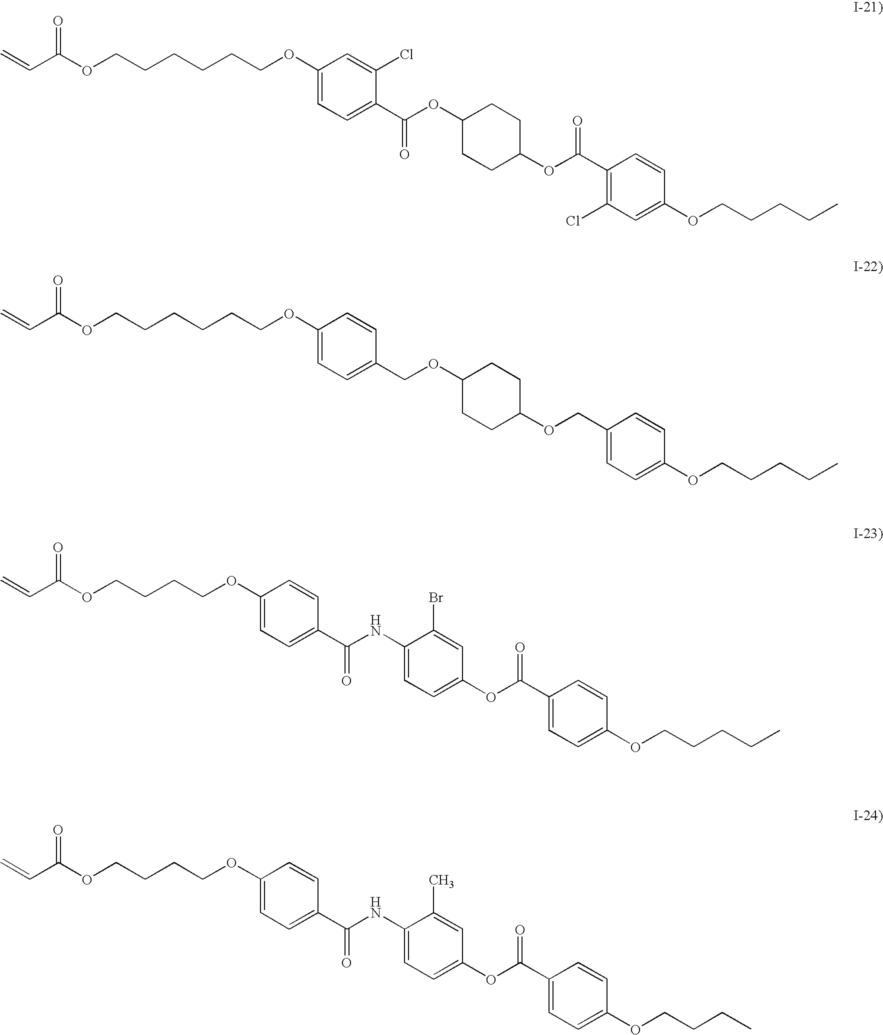

Compounds in which plural polymerizable groups have been introduced by further bonding a polymerizable group to the above-described compounds may be used as a crosslinking group.

As a rod-like liquid crystalline polymer, polymers having a recurring unit represented by formula (5) may be used.

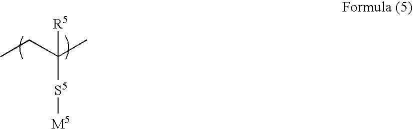

In formula (5), R⁵ represents a hydrogen atom, or a substituent; S⁵ represents a divalent linking group; and M⁵ represents a mesogenic group.

Examples of the substituent represented by R⁵ include those exemplified as the substituent of R¹ and the like. Among these examples of the substituent, an alkyl group and a halogen atom are preferable.

R⁵ is preferably a hydrogen atom, an alkyl group having 1 to 6 carbon atoms, or a chlorine atom, more preferably a hydrogen atom, a methyl group, an ethyl group, or a chlorine atom, and further preferably a hydrogen atom, or a methyl group.

S⁵ is preferably a divalent linking group selected from the group consisting of an alkylene group, an alkenylene group, an arylene group, a divalent heterocyclic residue, —CO—, —NR¹⁵— wherein R¹⁵ represents an alkyl group having 1 to 6 carbon atoms or a hydrogen atom, —O—, —S—, —S O—, —S O₂—, and a combination of these groups. The carbon atom of the alkylene group is preferably from 1 to 12. The carbon atom of the alkenylene group is preferably from 2 to 12. The carbon atom of the arylene group is preferably from 6 to 10. If possible, the alkylene group, the alkenylene group and the arylene group may be substituted with a substituent (for example, an alkyl group, a halogen atom, a cyano group, an alkoxy group, an acyloxy group). However, it is preferable that they have no substituent.

S⁵ preferably contains —O—, —CO—, —NR¹⁵— wherein R¹⁵ represents an alkyl group having 1 to 6 carbon atoms or a hydrogen atom, an alkylene group, or an arylene group, and more preferably contains —O—, —CO—, an alkylene group, or an arylene group. Further, it is preferable that S⁵ is solely constituted of —O—, —CO—, an alkylene group, or an arylene group.

As the mesogenic group represented by M⁵, it is possible to use a structure described in, for example, Macromol. Chem., Vol. 190, p. 2255 (1989), and Advanced Materials, Vol. 5, p. 107 (1993).

More preferably the mesogenic group is represented by the following formula (6).

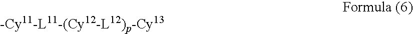

In formula (6), L¹¹ and L¹² each independently represent a single bond, or a divalent linking group; Cy¹¹, Cy¹² and Cy¹³ each independently represent a divalent cyclic group, and p represents an integer of 0 to 2; and when p is 2, the two L¹²'s may be the same or different, and also the two Cy¹²'s may be the same or different.

In formula (6), L¹¹ and L¹² are preferably a divalent linking group selected from the group consisting of —O—, —S—, —CO—, —NR¹⁶—, a divalent chain-like group, a divalent cyclic group and a combination of these groups, or a single bond. R¹⁶ represents an alkyl group having 1 to 7 carbon atoms, or a hydrogen atom, preferably an alkyl group having 1 to 4 carbon atoms, or a hydrogen atom, more preferably a methyl group, an ethyl group, or a hydrogen atom, and further preferably a hydrogen atom.

The divalent chain-like group is preferably an alkylene group, an alkenylene group, or an alkynylene group, each of which may have a substituent. As the substituent, a halogen atom is preferable. As the divalent chain-like group, an alkylene group, or an alkenylene group is preferable. An unsubstituted alkylene group, or an unsubstituted alkenylene group is more preferable. The alkylene group may be branched. The carbon number of the alkylene group is preferably in the range of 1 to 12, more preferably from 2 to 10, and further preferably from 2 to 8. The alkenylene group may be branched. The carbon number of the alkenylene group is preferably in the range of 2 to 12, more preferably from 2 to 10, and further preferably from 2 to 8.

The alkynylene group may be branched. The carbon number of the alkynylene group is preferably in the range of 2 to 12, more preferably from 2 to 10, and further preferably from 2 to 8.

Specific examples of the divalent chain-like group include an ethylene group, a trimethylene group, a propylene group, a tetramethylene group, a 2-methyl-tetramethylene group, a pentamethylene group, a hexamethylene group, an octamethylene group, a 2-buthenylene group, and a 2-butynylene group.

The divalent cyclic group has the same meaning as those of the below-described Cy¹¹, Cy¹² and Cy¹³. Preferable examples are also same as those of Cy¹¹, Cy¹² and Cy¹³.

In formula (6), p is preferably 0 or 1.

In formula (6), Cy¹¹, Cy¹² and Cy¹³ each independently represent a divalent cyclic group. The ring of the divalent cyclic group is preferably a 5-, 6-, or 7-membered ring, more preferably a 5-, or 6-membered ring, and further preferably a 6-membered ring. The ring may be a single ring, or a condensed ring, but preferably a single ring. Further, the ring may be an aromatic ring, an alicyclic ring, or a hetero ring. Of these rings, preferable examples of the aromatic ring include a benzene ring and a naphthalene ring. Preferable examples of the alicyclic ring include a cyclohexane ring. Preferable examples of the hetero ring include a pyridine ring and a pyrimidine ring. As a cyclic group having a benzene ring, a 1,4-phenylene group is preferable. As a cyclic group having a naphthalene ring, naphthalene-1,5-diyl group, and naphthalene-2,6-diyl group are preferable. As a cyclic group having a cyclohexane ring, 1,4-cyclohexylene group is preferable. As a cyclic group having a pyridine ring, a pyridine-2,5-diyl group is preferable. As a cyclic group having a pyrimidine ring, a pyrimidine-2,5-diyl group is preferable.

The cyclic group may have a substituent. Examples of the substituent include a halogen atom, a cyano group, a nitro group, an alkyl group having 1 to 5 carbon atoms, a halogen-substituted alkyl group having 1 to 5 carbon atoms, an alkoxy group having 1 to 5 carbon atoms, an alkylthio group having 1 to 5 carbon atoms, an acyloxy group having 2 to 6 carbon atoms, an alcoxycarbonyl group having 2 to 6 carbon atoms, a carbamoyl group, a carbamoyl group substituted with an alkyl group having 1 to 5 carbon atoms, and an acylamino group having 2 to 6 carbon atoms.

Specific examples of the polymer having a recurring unit represented by formula (5) are described below. However, the present invention is not limited to these polymers.

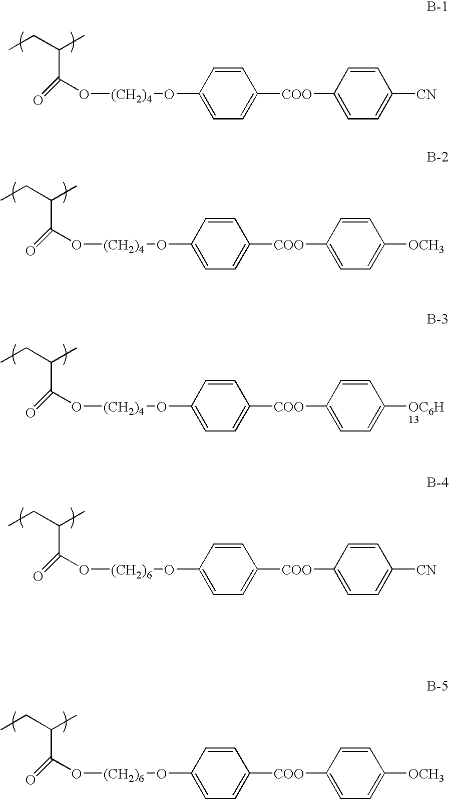

### [Partial Structure Having Chiral Property]

It is preferable that the aforementioned liquid crystal polymer has a cholesteric property and has such a structure that an optically-active center has been introduced to a side chain in order to form a cholesteric phase. It is more preferable that a partial structure having a chiral property has been introduced to the side chain.

Chiral compounds having an optically-active center and a radical polymerizable group are exemplified below. However, the present invention is not limited to these compounds.

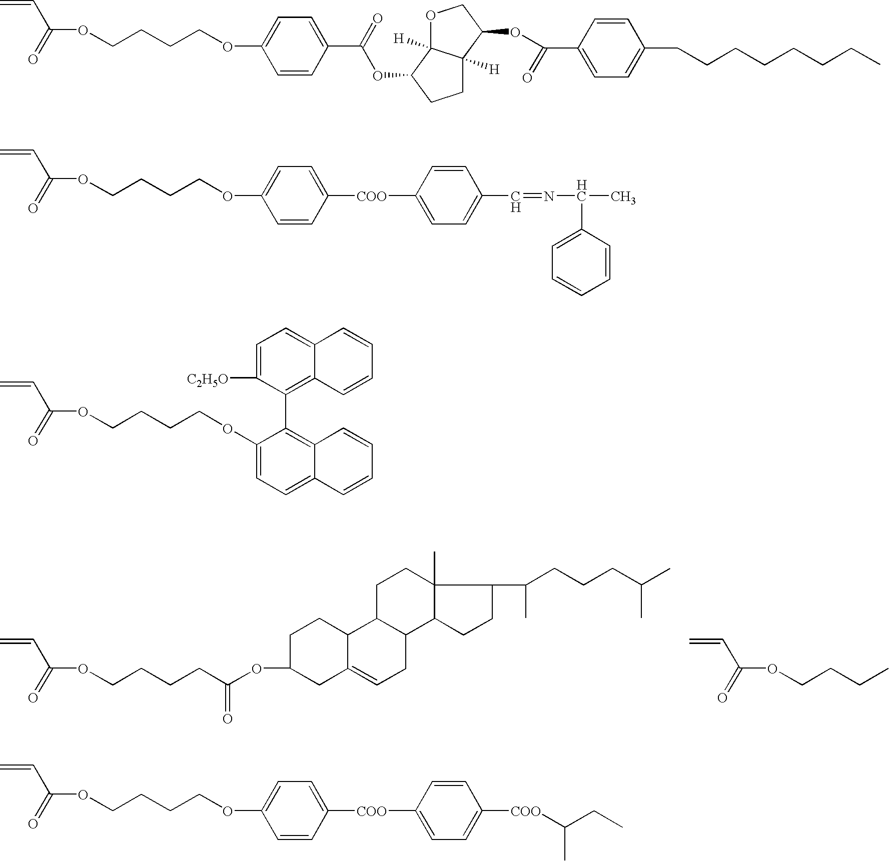

As the compound having a recurring unit having a partial structure having a chiral property that is used as a copolymerization unit of the aforementioned liquid crystal polymer, the below-exemplified compounds are preferable from the viewpoint that a twisting power is great, or a liquid crystalline property is not suppressed.

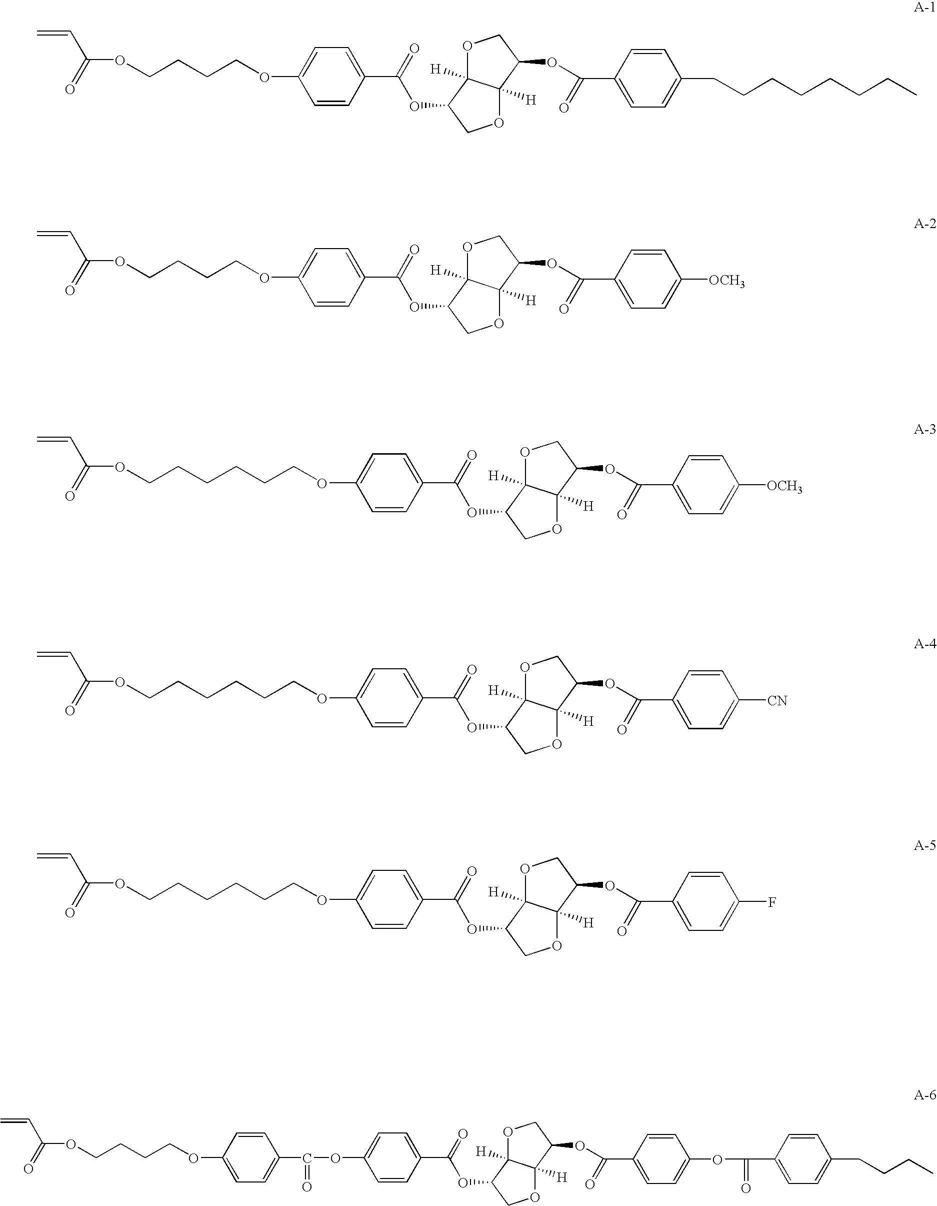

Of the aforementioned polymers, a ratio of the recurring unit having a partial structure having a chiral property is preferably 30% by mole, or less, more preferably 20% by mole, or less, and further preferably 10% by mole, or less, of the total recurring units. Herein, it is preferable that the lower limit is 1% by mole, or more. If the ratio of the recurring unit having a partial structure having a chiral property is more than 30% by mole, it is possible to exert a harmful influence to the liquid crystalline property and development of cholesteric property.

Specific examples of the polymers in which an optically-active group has been introduced to a side chain are described below. However, the present invention is not limited to these polymers.

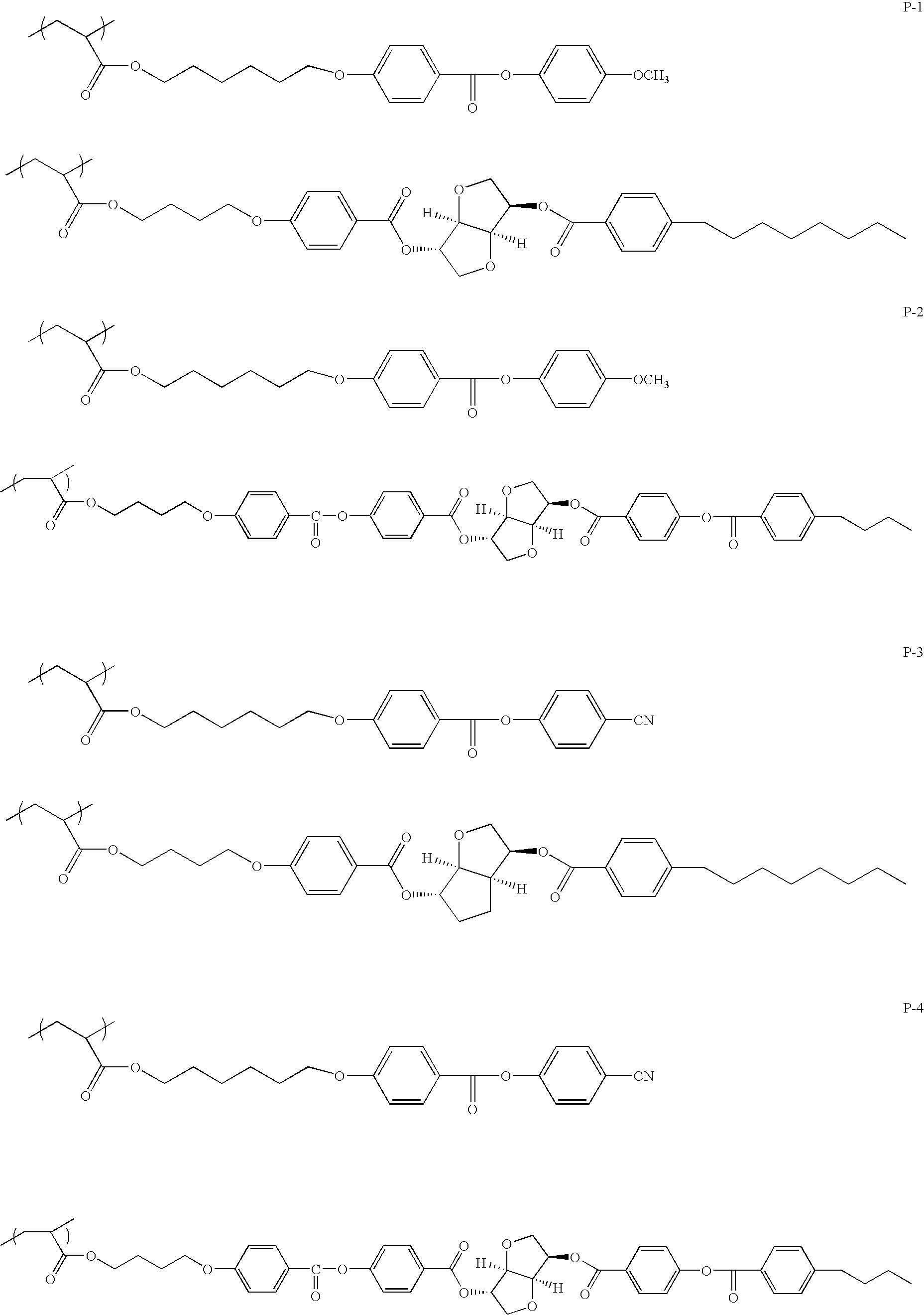

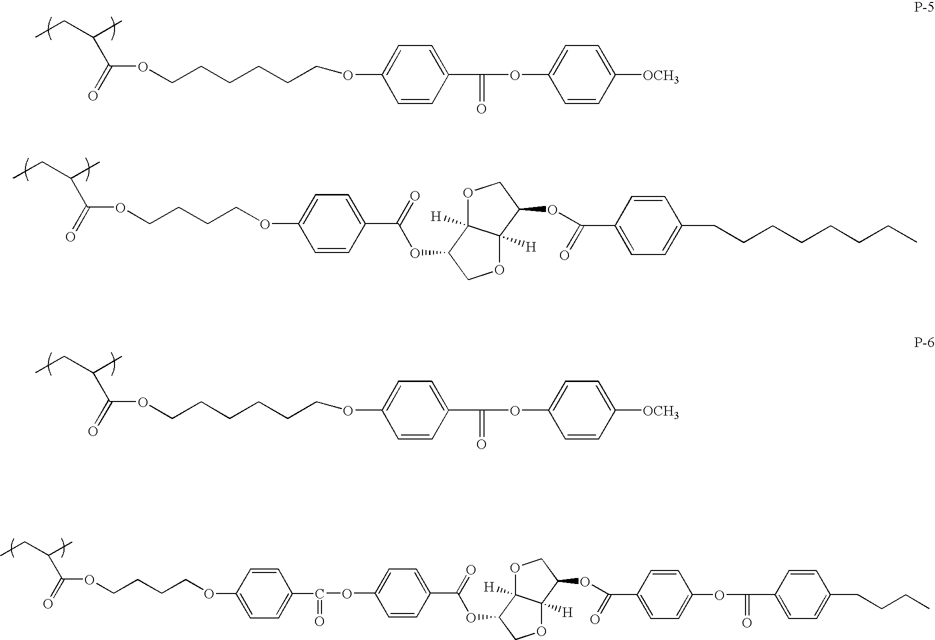

As an embodiment of the present invention, polymers that are formed by copolymerizing a radical polymerizable monomer having an optically-active group together with a liquid crystalline polymer have been described. However, it is possible in the present invention to use an embodiment in which a radical polymerizable monomer having an optically-active group, or a non-polymerizable and optically-active compound is added to the liquid crystalline polymer.

Further, a partially crosslinked polymer that is obtained by copolymerizing an appropriate amount of monomers having plural polymerizable groups may be used.

A discotic liquid crystalline compound may be used to form the aforementioned wavelength selective reflection layer. For example, the wavelength selective reflection layer may be formed by producing a helically oriented molecule of the discotic liquid crystalline compound and then immobilizing the oriented state. Examples of the discotic liquid crystalline compound usable in the invention are described in various publications (e.g., C. Destrade et al., Mol. Cryst. Liq. Cryst., Vol. 71, page 111 (1981); Quarterly Outline of Chemistry, No. 22, Chemistry of Liquid Crystal, Chap. 5, Chap. 10, Sec. 2 (1994), by the Chemical Society of Japan; B. Kohne et al., Angew. Chem. Soc. Chem. Comm., page 1794 (1985); J. Zhang et al., J. Am. Chem. Soc., Vol. 116, page 2655 (1994)). Similar to a rod-like liquid crystal, a polymer liquid crystalline molecule may be used. A compound having a partial structure that is capable of causing polymerization or a crosslinking reaction induced by active light, electron ray, or heat is preferably used. The polymerization of discotic liquid crystalline molecules is described in JP-A-8-27284.

### <<Optically-Active Compound>>

A chiral compound may be used together with a nematic liquid crystal to form the wavelength selective reflection layer. As the chiral compound, a compound capable of strongly inducing a helical structure of the cholesteric liquid crystal composition is preferable. For this reason, it is preferable to place a chiral portion at the center of a molecule, and to assemble a surrounding area of the center into a rigid structure. A molecular weight of the chiral compound is preferably 300 or more. It is especially preferable to use a chiral compound in which a twisting power is changed by the action of light irradiation in order to control the central wavelength and the width of the selective reflection band. In this embodiment, it is necessary to dispose a portion that is capable of causing isomerization reaction by the action of light irradiation in addition to the chiral portion. In order to increase a change of twisting power, it is preferable to use a compound in which a degree of structural change owing to isomerization is great, and also to approximate the chiral portion and another portion to each other, the another portion being capable of causing isomerization by the action of light irradiation.

Further, a chiral compound having a high solubility with respect to a nematic liquid crystalline polymerizeable monomer is preferable. A compound having a low melting point, or its solubility parameter SP value similar to the liquid crystalline polymerizeable monomer is more preferable. Further, if one or more polymerizeable bonding group is introduced into a chiral compound, heat resistance of the thus-formed selective reflection layer may be improved. The total content of a chiral portion as a chiral compound or a copolymer in the cholesteric liquid crystal composition may be properly selected without any particular limitation, but preferably ranges from about 2 to about 30% by mass.

As the chiral compound, those described in, for example, JP-T-2002-533742 (“JP-T” means published Japanese translation of PCT application), paragraphs [0099] to [0100], JP-A-11-193287, paragraphs [0043] to [0047], and Ekisyo Binran (Hand Book of Liquid Crystals), Maruzen, p280-p312 are known. When a designing property is given in the present invention, it is preferable to use a chiral compound (cinnamates, azo compounds, etc.) in which a twisting power is changed by the action of light irradiation among the following compounds.

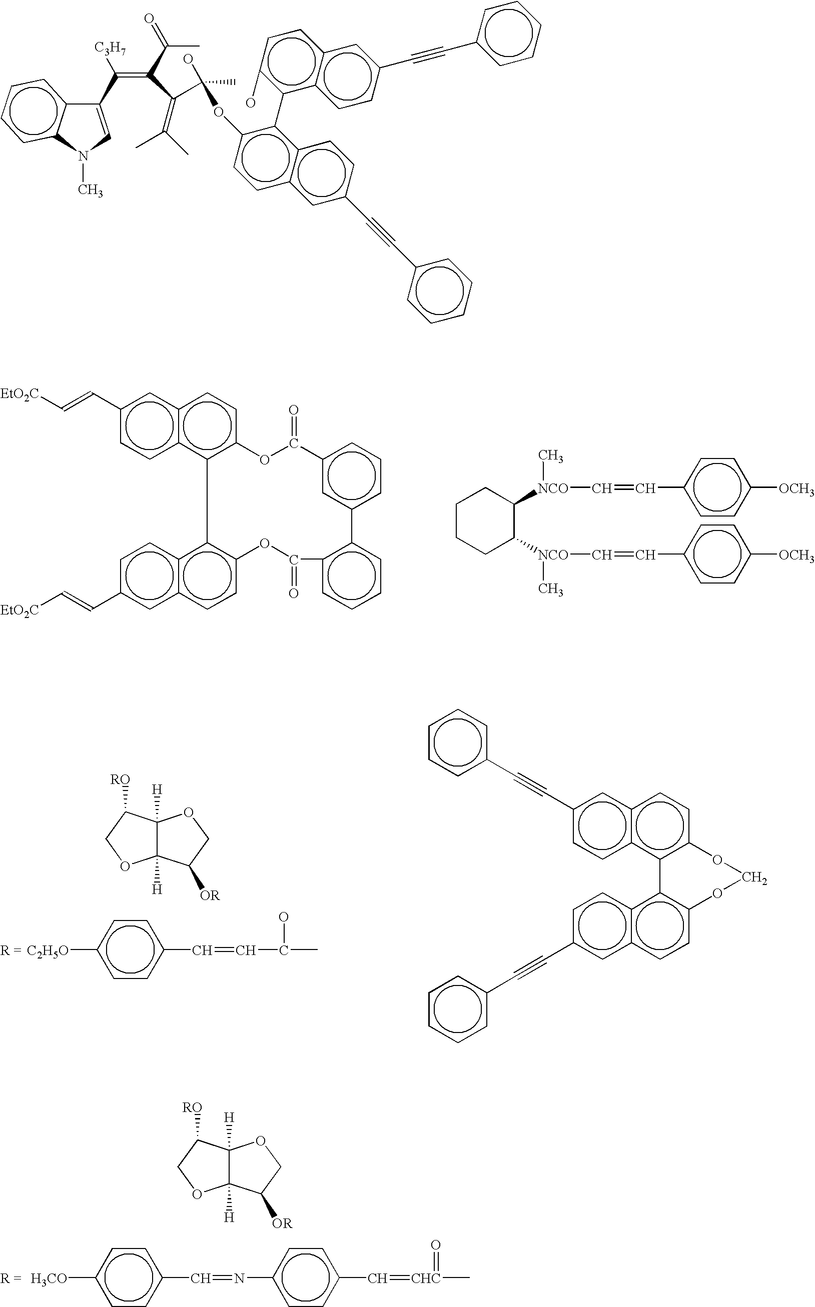

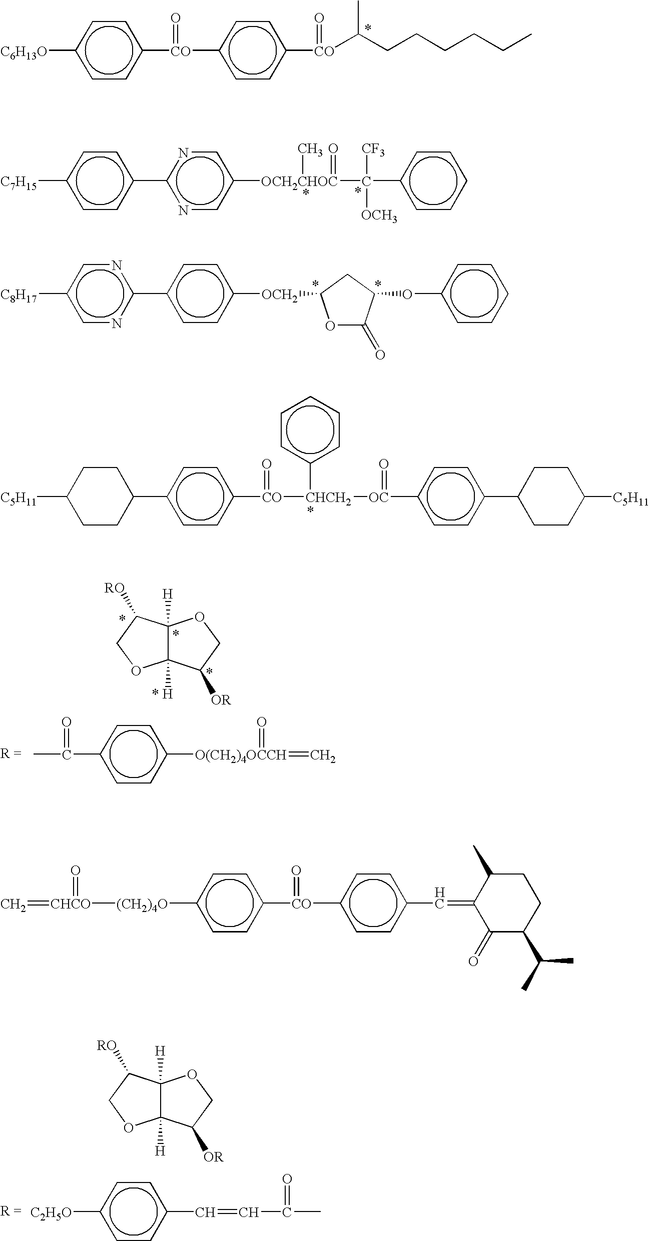

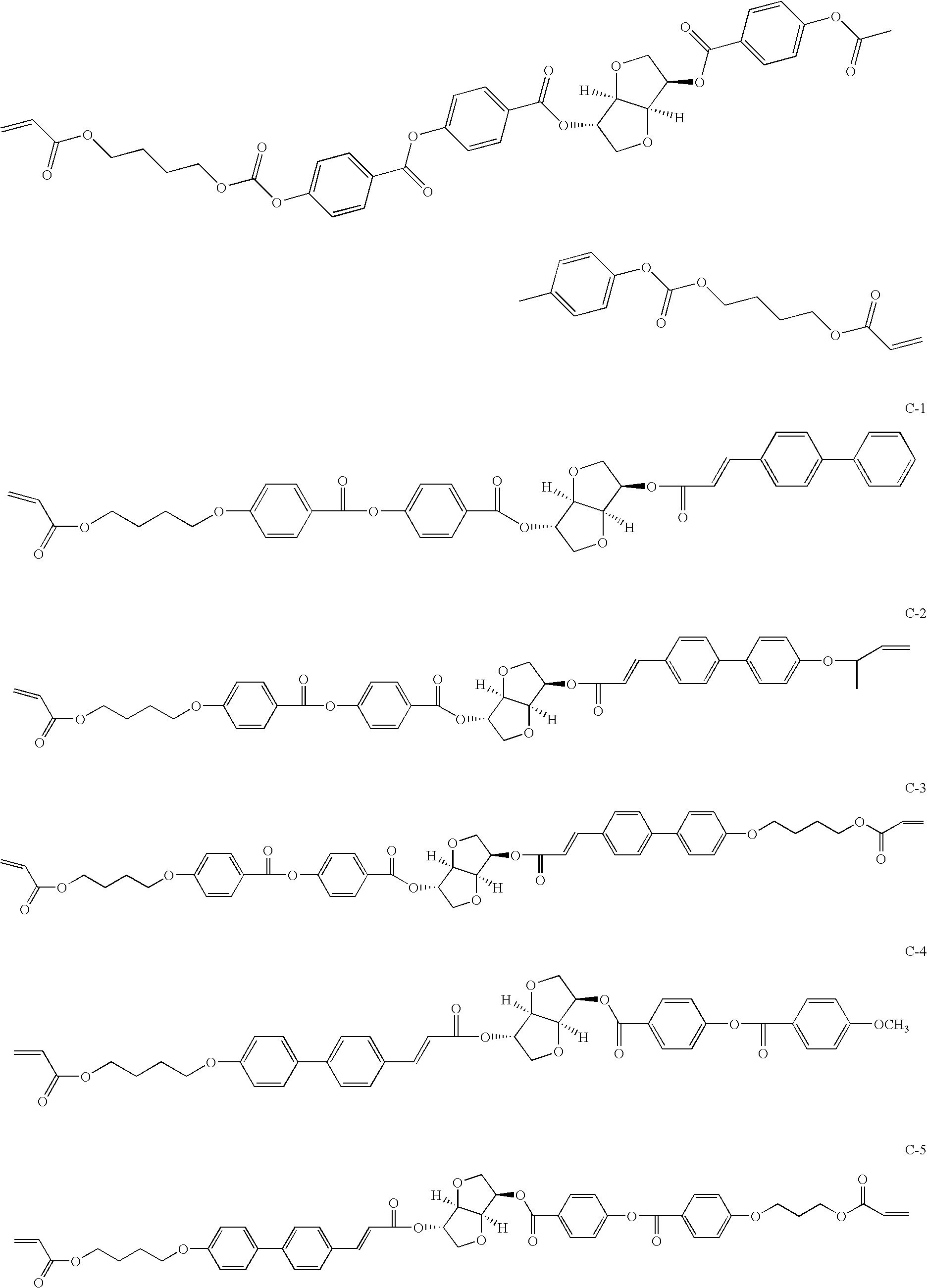

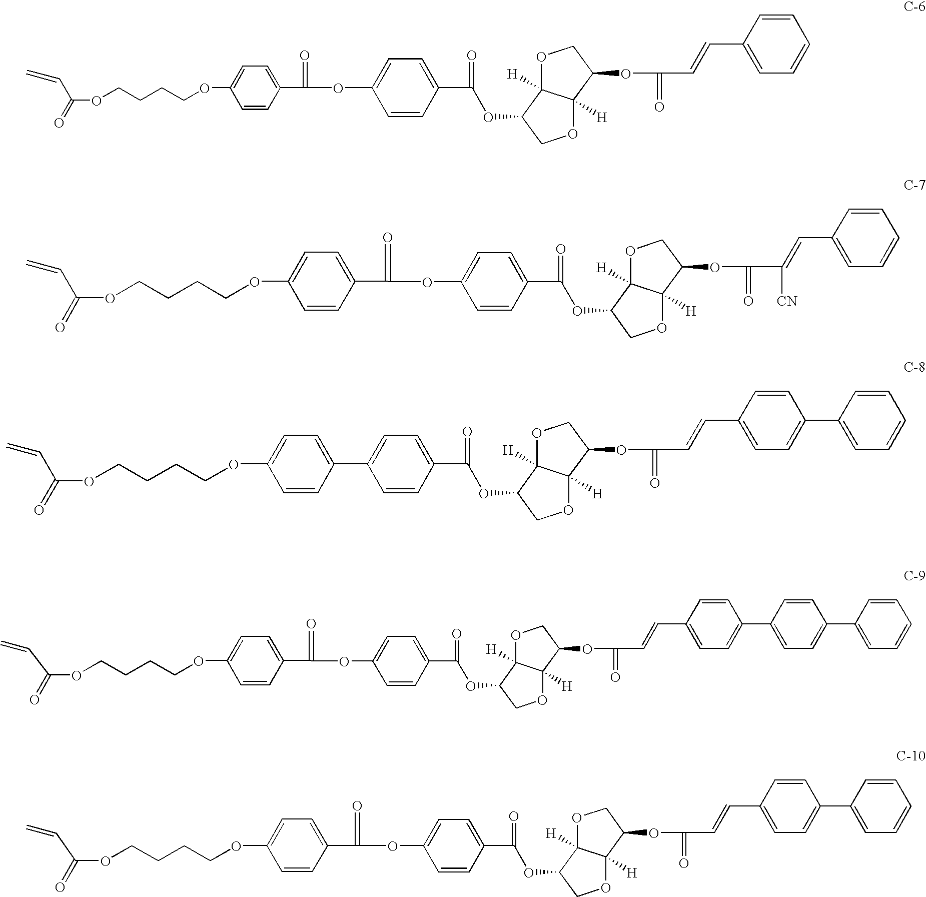

### <<Specific Forming Method of Wavelength Selective Reflection Layer>>

The wavelength selective reflection layer that is formed from a cholesteric liquid crystal composition may be formed by the steps of coating a coating liquid containing the cholesteric liquid crystal composition and optionally the below-described polymerization initiator, air interface horizontal alignment agent, and other additives on an oriented film formed on a transparent support and subjecting the coating to horizontal orientation; and then getting its helical axis almost upright to the plane of the support, and then immobilizing the orientation state. It is preferable that the thickness of the wavelength selective reflection layer is ordinarily in the range of about 0.1 μm to about 20 μm. Further, orientation may be achieved without an oriented film by magnetic field, electric field orientation, and operation of shearing stress.

The heating orientation is generally performed at the crystal phase of the liquid crystal composition/nematic phase transition temperature, or more, and at the nematic phase/isotropic phase transition temperature, or less. The period of time for the heating orientation is not particularly limited. However, the time is preferably in the range of about 10 seconds to about 3 minutes. The oriented immobilization may be performed at the temperature for the heating orientation, or alternatively at lower temperature than the heating orientation temperature, but in the range of temperature at which no crystal deposits.

### <<Horizontal Orientation Film>>

As the orientation film, various kinds of orientation films that are known before may be used. For example, it is possible to use a rubbing film that is obtained by the steps of forming a thin film composed of polyimides or polyvinyl alcohols or the like on a transparent support and then subjecting the thin film to a rubbing treatment with a rayon cloth or the like; an oblique evaporation film; an optical orientation film that is obtained by irradiating a polarized ultraviolet ray to a polymer having a photocrosslinking group such as a cinnamate, or an azobenzene, or a polyimide; or a stretched film. If a material having a high uniformity with respect to pretilt angle is used in the orientation film, a rubbing treatment may be omitted. The crosslinkable functional group of the polymer of the orientation film preferably has a polymerizable group, like the polyfunctional monomer. Specific examples of such crosslinkable functional groups include: those described in JP-A-2000-155216, paragraphs [0080] to [0100].

As a solvent used for preparing the coating fluid, an organic solvent is preferably used. Examples of the organic solvents applicable include: an amide (e.g. N,N-dimethylformamide); a sulfoxide (e.g. dimethylsulfoxide); a heterocycle compound (e.g. pyridine); a hydrocarbon (e.g. benzene, hexane); an alkyl halide (e.g. chloroform, dichloromethane); esters (e.g. methyl acetate, butyl acetate); ketones (e.g. acetone, methyl ethyl ketone); and an ether (e.g. tetrahydrofuran, 1,2-dimethoxyethane). An alkyl halide and a ketone are preferably used. Two or more kinds of organic solvent can be used in combination. The coating fluid may be applied by a known method (e.g. curtain coating, extrusion coating, roll coating, spin coating, dip coating, bar coating, spray coating, slide coating, gravure coating methods).

### <Air-Interface Vertical Alignment Agent>

In general, liquid crystalline compounds have a property of becoming oriented in a slanting direction on the air-interface side. For achieving a uniform vertically-aligned state, therefore, it is required to control liquid crystalline compound molecules present on the air-interface side so as to align vertically. To this end, it is appropriate that a compound capable of being unevenly distributed at the air-interface and acting so as to orient liquid crystalline compound molecules in the vertical direction through its excluded volume effect or antistatic effect be incorporated in a liquid crystal coating solution and then used for forming a wavelength selective reflection layer. Specifically, as such the compound, a nonionic surfactant is preferable. The compound may be used by properly selecting from known nonionic surfactants.

As such air-interface alignment agents, the compounds disclosed in JP-A-2002-20363 and JP-A-2002-129162 can be used. Further, the particulars described in JP-A-2004-53981, paragraphs [0072] to [0075], can be applied to the invention as appropriate. In addition, mixing of those compounds in a liquid crystal coating solution can improve the coating suitability and control the occurrence of unevenness and repellency in the layer coated.

The proportion of the air-interface alignment agent used in a liquid crystal coating solution is preferably from 0.05% to 5% by mass. When the air-interface alignment agent of fluorine-containing compound type is used, the proportion thereof is preferably 1% or below by mass. It is preferable to incorporate the following surfactant in the layer-forming liquid crystal composition in order to form a high uniformity of horizontal orientation state in the layer.

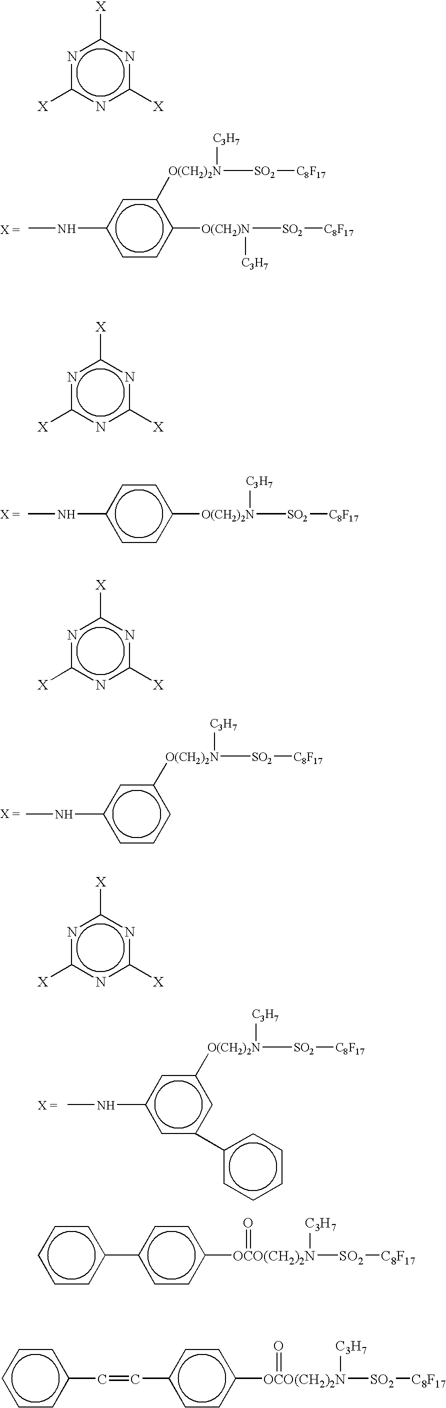

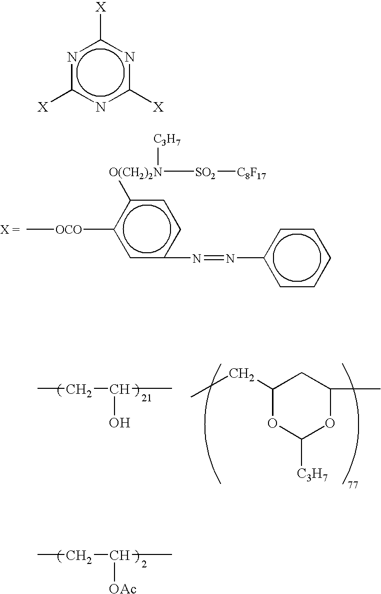

### [Polymerization Initiator]

When immobilization is performed while maintaining an orientation state of the horizontally oriented liquid crystalline compound, it is preferable that the immobilization is conducted according to polymerization reaction of the polymerizable group (P) that has been introduced in the liquid crystalline compound. It is preferable that the composition for forming the film of the present invention contains the below-described polymerization initiator. Examples of the polymerization reaction include a thermal polymerization reaction using a thermal polymerization initiator, and a polymerization reaction induced by an activated energy beam, such as a photo polymerization reaction using a photo polymerization initiator, and a polymerization reaction owing to irradiation of electron beam. In order to prevent the support from deformation or change of properties owing to heat, the photo polymerization reaction and the polymerization reaction owing to irradiation of electron beam, each of which uses an activated energy beam, are preferable. Especially, the photo polymerization reaction is preferable.

Examples of the photopolymerization initiator usable herein include the α-carbonyl compounds (disclosed in U.S. Pat. Nos. 2,367,661 and 2,367,670), the acyloin ethers (disclosed in U.S. Pat. No. 2,448,828), the α-hydrocarbon-substituted aromatic acyloin compounds (disclosed in U.S. Pat. No. 2,722,512), the polynuclear quinone compounds (disclosed in U.S. Pat. Nos. 3,046,127 and 2,951,758), the combinations of triarylimidazole dimers and p-aminophenyl ketones (disclosed in U.S. Pat. No. 3,549,367), the acridine and phenazine compounds (disclosed in JP-A-60-105667 and U.S. Pat. No. 4,239,850) and the oxadiazole compounds (disclosed in U.S. Pat. No. 4,212,970).

The amount of the photopolymerization initiator used is preferably from 0.01% to 20% by mass, more preferably from 0.5% to 5% by mass, of the solids content in the coating solution.

As light irradiation for polymerization, it is appropriate to employ irradiation with ultraviolet rays. The irradiation energy is preferably from 10 mJ/cm² to 50 J/cm², more preferably from 50 mJ/cm² to 800 mJ/cm². For speeding up the photopolymerization reaction, light irradiation may be carried out under heating. The oxygen concentration in the ambient atmosphere participates to the degree of polymerization. Therefore, when the degree of polymerization does not reach a desirable level in air, it is preferable to reduce the oxygen concentration according to the method such as nitrogen substitution. The oxygen concentration is preferably 10% by volume or less, more preferably 7% by volume or less, and further preferably 3% by volume or less.

The light source used for light irradiation can include light sources used usually, for example, lamps such as tungsten lamp, halogen lamp, xenon lamp, xenon flash lump, mercury lamp, mercury xenon lamp, and carbon arc lamp; various kinds of lasers such as semiconductor laser, helium neon laser, argon ion laser, helium cadmium laser, and YAG laser; light emission diodes and cathode ray tubes. In the light irradiation step, the polymer may be irradiated with either a non-polarized light or a polarized light. In the case of using the polarized light, it is preferably irradiated with a linearly polarized light. Further, only light having a necessary wavelength may be selectively irradiated using a filter or a wavelength conversion element or the like. Further, control of a light-sensitive chiral agent and polymerization may be conducted by applying light having different wavelength from each other. With respect to a specific method, for example, the descriptions of JP-A-2002-338575 may be referred to.

### <<Other Materials in Wavelength Selective Reflection Layer>>

A plasticizer, surfactant, polymerizable monomer, etc. may be used with the liquid crystalline compound to increase the coating uniformity, film strength, alignment of the liquid crystalline compound, etc. It is preferred that these materials have compatibility to the liquid crystalline compound and do not inhibit the alignment.

The polymerizable monomer may be a radical- or cation-polymerizable compound, and preferably a polyfunctional radical-polymerizable monomer. The monomer is preferably copolymerizable with the liquid crystalline compound having above polymerizable group. Examples of the polymerizable monomers include those described in JP-A-2002-296423, paragraphs [0018] to [0020]. The ratio of the polymerizable monomer to the liquid crystalline compound is generally 1 to 50% by mass, preferably 5 to 30% by mass.

The surfactant may be a known compound, and is particularly preferably a fluorine compound. Specific examples thereof include compounds described in JP-A-2001-330725, paragraphs [0028] to [0056] and compounds described in JP-A-2005-62673, paragraphs [0069] to [0126].

It is preferred that the polymer used in combination with the liquid crystalline compound can increase the viscosity of the coating liquid. The polymer may be a cellulose ester. Preferred examples of the cellulose esters include those described in JP-A-2000-155216, paragraph [0178]. The mass ratio of the polymer to the liquid crystalline compound is preferably 0.1 to 10% by mass, more preferably 0.1 to 8% by mass, from the viewpoint of not inhibiting the alignment of the liquid crystalline compound.

### <<Transparent Support>>

In the present invention, the wavelength selective reflection layer that has been formed from a liquid crystalline compound may be formed on a transparent support. It is preferable that the transparent support is clear. Specifically, it is preferable that the light transmission is 80% or more. Examples of the transparent support include polyvinyl chloride, polyethylene terephthalate, norbornene resin, polyvinyl alcohol, polyimide, polyarylate, cellulose ester, polycarbonate, polysulfone, polyether sulfone, polyacrylate, and polymethacrylate films as well as a glass plate. The thickness of the transparent support is preferably in the range of 20 μm to 500 μm, and more preferably from 40 μm to 200 μm. In order to improve adhesive properties between the transparent support and layers disposed above the support (i.e., an adhesive layer, an orientation film, or a wavelength selective reflection layer), the transparent support may be subjected to a surface treatment (for example, glow discharge treatment, corona discharge treatment, ultraviolet (UV) treatment, frame treatment). An adhesive layer (undercoating layer) may be disposed on the transparent support. Further, with respect to a long transparent support, in order to give a sliding property during a transportation step, and to prevent adhesion between the surface and the back surface of the rewound support, it is preferable to use an assembly that is formed by coating, on one side of the support, a polymer layer blended with inorganic particles having average particle size of about 10 nm to about 100 nm in an amount of 5% to 40% in terms of weight percentage of the solid content, or alternatively an assembly that is formed by co-flow casting of the support and the polymer layer.

### [Coating Method]

As the method of coating a liquid crystal coating fluid composition on a support, it is possible to use a method of coating the composition itself, or a method of coating a fluid wherein the composition has been dissolved in a proper solvent, and then drying. As the coating method, it is possible to use curtain coating, extrusion coating, roll coating, spin coating, dip coating, bar coating, spray coating, slide coating, gravure coating methods or the like.

### <<Ultraviolet Absorbing Layer>>

It is preferable to dispose an ultraviolet absorbing layer in order to prevent the wavelength selective reflection layer from deterioration owing to ultraviolet ray contained in sunlight. It is preferable to dispose an ultraviolet absorbing layer at the same side as the light incidence side of the film of the present invention. The ultraviolet absorbing layer may be formed by the steps of dissolving an ultraviolet absorbent together with a resin in a solvent, and then coating and drying the resultant fluid. A coating amount (solid content basis) of the ultraviolet absorbing layer is generally in the range of 0.5 g/m² to 50 g/m², and preferably from 0.5 g/m² to 20 g/m². If the coating amount (solid content basis) is more than 50 g/m², it is not preferable in that scattering loss generates and transparency reduces. On the other hand, if the coating amount (solid content basis) is less than 0.5 g/m², a substantial ultraviolet absorbing effect cannot be obtained. An addition amount of the ultraviolet absorbent is preferably in the range of 1% by mass to 50% by mass, and more preferably from 3% by mass to 30% by mass, relative to the resin respectively. If the addition amount is less than 1% by mass, addition effects cannot be sufficiently obtained. On the contrary, if the addition amount is more than 30% by mass, the ultraviolet absorbent bleeds out to the resin surface, or the ultraviolet absorbent is crystallized and deposited in the resin, and resultantly it is difficult to obtain a sufficient fastness to light. Further, antioxidants, anti aging agents, singlet oxygen quenching agents, and superoxide anion quenching agents may be used together with the ultraviolet absorbent so that ultraviolet absorbing effects are sufficiently obtained.

As the ultraviolet absorbent is preferably used one having an excellent absorption of ultraviolet rays having a wavelength of 370 nm or less and having little absorption of visible light having a wavelength of 400 nm or more. Examples thereof include a salicylic acid ester-based absorbent, a benzophenone-based absorbent, a benzotriazole-based absorbent, a benzoate-based absorbent, a cyano acrylate-based absorbent, and a nickel complex salt-based absorbent. Preferred among these ultraviolet absorbent are a benzophenone-based absorbent, a benzotriazole-based absorbent, and a salicylic acid ester-based absorbent. A plurality of ultraviolet absorbent having different absorption wavelengths are preferably used to obtain a high barrier effect within a wide wavelength range.

As the ultraviolet absorbent there may be used also compounds disclosed in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173.

Examples of the resin having high compatibility with respect to the ultraviolet absorbent include a polyester resin, a vinyl chloride resin, a vinylidene chloride resin, a vinyl chloride-vinyl acetate resin, an epoxy resin, an alkyd resin, an acryl resin, a xylene resin, a butyral resin, a melamine resin, a polyamide resin, styrene resin, a vinyl acetate-acrylic resin, and a cellulose ester resin. A polyester resin, or a vinyl chloride resin is especially preferable.

In the infrared range selective reflection film of the present invention, reflectance of the particular wavelength can be increased by using a right-handed circularly polarized light selective reflection film and a left-handed circularly polarized light selective reflection film superposed on each other. Further, it is also possible to prepare a film having widened its reflection band by using wavelength selective reflection films that are different in reflection wavelength from each other and that are superposed on each other.

### [Infrared-Absorbing Dye or Pigment]

The infrared-absorbing colorant (the same meaning as the above-described infrared-absorbing dye or pigment) that is used in the present invention is not particularly limited, but it is preferable to selectively use a dye having an absorption spectrum having a large absorption in the infrared range while having a small absorption in the visible range. The infrared-absorbing colorant includes organic compounds and inorganic compounds. It is preferable to use an infrared-absorbing colorant that is an organic compound. Examples of the infrared-absorbing colorant include a cyanine dye, an oxonol dye, a squarylium dye, an other polymethine dye, a diimonium dye, an azomethine dye, a phthalocyanine dye, a metal chelate dye, a rylene-series dye, an aminium dye, and a quinone dye. The infrared-absorbing colorant is described in Shikizai (Colarants), Vol. 61 [4] p. 215-226 (1988), and Kagaku Kogyo (Chemical Industries), p. 43-53 (May, 1986).

More specifically, examples of the infrared-absorbing colorant include dihydroperimidinesquarylium dyes described in U.S. Pat. No. 5,380,635, JP-A-10-36695; cyanine dyes described in JP-A-62-123454, JP-A-3-138640, JP-A-3-211542, JP-A-3-226736, JP-A-5-313305, JP-A-6-43583, JP-A-9-96891, and European Patent No. 0430244; pyrylium dyes described in JP-A-3-138640, JP-A-3-211542; diimonium dyes described in JP-A-3-138640, and JP-A-3-211542; pyrazolopyridone dyes described in JP-A-2-282244; indoaniline dyes described in JP-A-5-323500, JP-A-5-323501; polymethine dyes described in JP-A-3-26765, JP-A-4-190343, and European Patent No. 0377961; oxonol dyes described in JP-A-3-9346; anthraquinone dyes described in JP-A-4-13654, naphthalocyanine dyes described in U.S. Pat. No. 5,009,989; and naphtolactam dyes described in European Patent No. 0568267.

Preferable infrared-absorbing dyes are a cyanine dye represented by formula (X-1), a dihydroperimidinesquarylium dye represented by formula (X-3), a naphthooxazininsquarylium dye represented by formula (X-4), a diimonium dye represented by formula (X-5), a polymethine dye represented by formula (X-6), an azomethine dye represented by formula (X-7), an oxonol dye represented by formula (X-8), and a phthalocyanine dye represented by formula (X-9).

The cyanine dye represented by formula (X-1) is explained below.

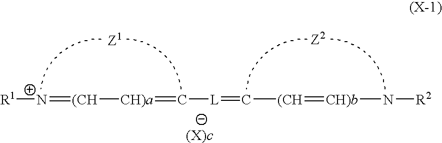

In formula (X-1), Z¹ and Z² each independently represent a group of non-metallic atoms necessary to form a 5- or 6-membered nitrogen-containing hetero ring which may be condensed; R¹ and R² each independently represent an alkyl group; L represents a linking group in which 7, 9 or 11 methine groups are bound so that double bonds are conjugated; a, b and c each independently represent 0 or 1; and X represents an anion.

In formula (X-1), Z¹ and Z² each are a group of non-metallic atoms necessary to form a 5- or 6-membered nitrogen-containing hetero ring which may be condensed. Examples of the nitrogen-containing hetero ring and its condensed ring include oxazole, isooxazole, benzoxazole, naphthoxazole, thiazole, benzothiazole, naphthothiazole, indolenine, benzoindolenine, imidazole, benzoimidazole, naphthoimidazole, quinoline, pyridine, pyrrolopyridine, fulopyrrol, indolizine, imidazoquinoxaline, and quinoxaline rings. As the nitrogen-containing hetero ring, the 5-membered ring is preferable compared to the 6-membered ring. A 5-membered nitrogen-containing hetero ring condensed with a benzene ring or a naphthalene ring is more preferable. The indolenine ring or the benzoindolenine ring is most preferable.

These nitrogen-containing hetero rings and their condensed rings may be substituted with a substituent. Examples of the substituent include an alkyl group having 10 or less carbon atoms, preferably 6 or less carbon atoms (for example, methyl, ethyl, propyl, butyl, isobutyl, pentyl, hexyl); an alkoxy group having 10 or less carbon atoms, preferably 6 or less carbon atoms (for example, methoxy, ethoxy); an aryloxy group having 20 or less carbon atoms, preferably 12 or less carbon atoms (for example, phenoxy, p-chlorophenoxy); an aryl group having 20 or less carbon atoms, preferably 12 or less carbon atoms (for example, phenyl, p-chlorophenyl); a halogen atom (for example, Cl, Br, F); an alkoxycarbonyl group having 10 or less carbon atoms, preferably 6 or less carbon atoms (for example, ethoxycarbonyl); a cyano group; a nitro group; a carboxyl group; and a sulfo group. The carboxyl group and the sulfo group each may be a free acid, or may form a salt with a cation. Further, the carboxyl group and the sulfo group each may form an inner molecular salt with N⁺. Preferable substituents are a chlorine atom, a methoxy group, a methyl group, a carboxyl group, and a sulfo group.

In formula (X-1), R¹ and R² each independently represent an alkyl group. The number of carbon atoms in the alkyl group is preferably in the range of 1 to 10, and more preferably from 1 to 6. Examples of the alkyl group include a methyl group, an ethyl group, a propyl group, a butyl group, an isobutyl group, a pentyl group, a 2-pentenyl group, a vinyl group, an allyl group, a 2-butenyl group, a 1-propenyl group, a hexyl group, a benzyl group, and a phenetyl group. The alkyl group may be substituted with a substituent. Examples of the substituent include a halogen atom (for example, Cl, Br, F), an alkoxycarbonyl group having 10 or less carbon atoms, preferably 6 or less carbon atoms (for example, methoxycarbonyl, ethoxycarbonyl); a hydroxyl group; a carboxyl group; and a sulfo group.

In formula (X-1), L is a linking group in which 7, 9 or 11 methine groups are bound so that double bonds are conjugated. The number of methine groups is preferably 5 (pentamethine compound), 7 (heptamethine compound), or 9 (nonamethine compound); more preferably 7 or 9; and further preferably 7. The methine group may be substituted with a substituent. However, it is preferable that the methine group having a substituent is a centrally-positioned (meso-position) methine group. The substituent of the methine group is explained with reference to the following formula L5 (pentamethine), formula L7 (heptamethine), and formula L9 (nonamethine).

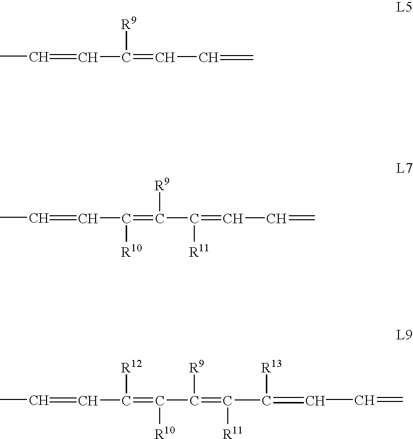

In formulae L5, L6 and L7, R⁹ represents a hydrogen atom, a halogen atom, an alkyl group, an aryl group, —NR¹⁴R¹⁵ (R¹⁴ represents an alkyl group or an aryl group; R¹⁵ represents a hydrogen atom, an alkyl group, an aryl group, an alkylsulfonyl group, an arylsulfonyl group or an acyl group; and R¹⁴ and R¹⁵ may bond to each other to form a 5- or 6-membered nitrogen-containing hetero ring), an alkylthio group, an arylthio group, an alkoxy group, or an aryloxy group; R¹⁰ and R¹¹ each represent a hydrogen atom or a group of atoms necessary to form a 5-, 6- or 7-membered ring by binding with each other; and R¹² and R¹³ each independently represent a hydrogen atom or an alkyl group.

Examples of the halogen atom include a fluorine atom, a chlorine atom, and a bromine atom. A chlorine atom is especially preferable.

The number of carbon atoms in the alkyl group is preferably in the range of 1 to 10, and more preferably from 1 to 6. Examples of the alkyl group include a methyl group, an ethyl group, a propyl group, a butyl group, an isobutyl group, a pentyl group, and a hexyl group. A methyl group is especially preferable. The alkyl group may be substituted with a substituent. Examples of the substituent include a halogen atom (for example, Cl, Br, F); an alkoxycarbonyl group having 10 or less carbon atoms, preferably 6 or less carbon atoms (for example, methoxycarbonyl, ethoxycarbonyl); and a hydroxyl group.

The number of carbon atoms in the aryl group is preferably in the range of 6 to 12. Examples of the aryl group include a phenyl group and a naphthyl group. The aryl group may be substituted with a substituent. Examples of substituent include an alkyl group having 10 or less carbon atoms, preferably 6 or less carbon atoms (for example, methyl, ethyl, propyl, butyl, isobutyl, pentyl, hexyl, allyl); an alkoxy group having 10 or less carbon atoms, preferably 6 or less carbon atoms (for example, methoxy, ethoxy); an aryloxy group having 20 or less carbon atoms, preferably 12 or less carbon atoms (for example, phenoxy, p-chlorophenoxy); a halogen atom (for example Cl, Br, F); an alkoxycarbonyl group having 10 or less carbon atoms, preferably 6 or less carbon atoms (for example ethoxycarbonyl); a cyano group; a nitro group; and a carboxyl group.

When R⁹ is —NR¹⁴R¹⁵, it is especially preferable that at least one of R¹⁴ and R¹⁵ is a phenyl group.

The number of carbon atoms in the alkylsulfonyl group is preferably in the range of 1 to 10. Examples of the alkylsulfonyl group include a mesyl group, and an ethane sulfonyl group.

The number of carbon atoms in the arylsulfonyl group is preferably in the range of 6 to 10. Examples of the arylsulfonyl group include a tosyl group, and a benzene sulfonyl group.

The number of carbon atoms in the acyl group is preferably in the range of 2 to 10. Examples of the acyl group include an acetyl group, a propionyl group, and a benzoyl group.

Examples of the nitrogen-containing heterocyclic group that is formed by combining R¹⁴ and R¹⁵ include a piperidine ring, a morpholine ring, and a piperazine ring. The nitrogen-containing heterocyclic group may be substituted with a substituent. Examples of the substituent include an alkyl group (for example, methyl), an aryl group (for example, phenyl), and an alkoxycarbonyl group (for example, ethoxycarbonyl).

It is preferable that R¹⁰ and R¹¹ bind with each other to form a 5-, 6- or 7-membered ring. When R⁹ is a hydrogen atom, it is especially preferable that R¹⁰ and R¹¹ form the ring. Examples of the ring that is formed by combining R¹⁰ and R¹¹ include a cyclopentne ring, a cyclohexene ring, and a cycloheptene ring. The ring formed by R¹⁰ and R¹¹ may be substituted with a substituent. Examples of the substituent include an alkyl group, and an aryl group.

In formula (X-1), a, b and c each independently represent 0 or 1. It is preferable that both a and b are 0. Generally, c is 1. However, when the molecule has an anionic substituent such as an carboxyl group or a sulfo group and the anionic substituent forms an intermolecular salt with N⁺, c is 0.

In formula (X-1), X is an anion. Examples of the anion include a halide ion (for example, Cl⁻, Br⁻, I⁻), a p-toluenesulfonic acid ion, an ethylsulphate ion, PF₆⁻, BF₄⁻, and ClO₄⁻.

Specific examples of preferable cyanine dyes are described below. However, the present invention is not limited thereto. Herein, Me represents a methyl group.

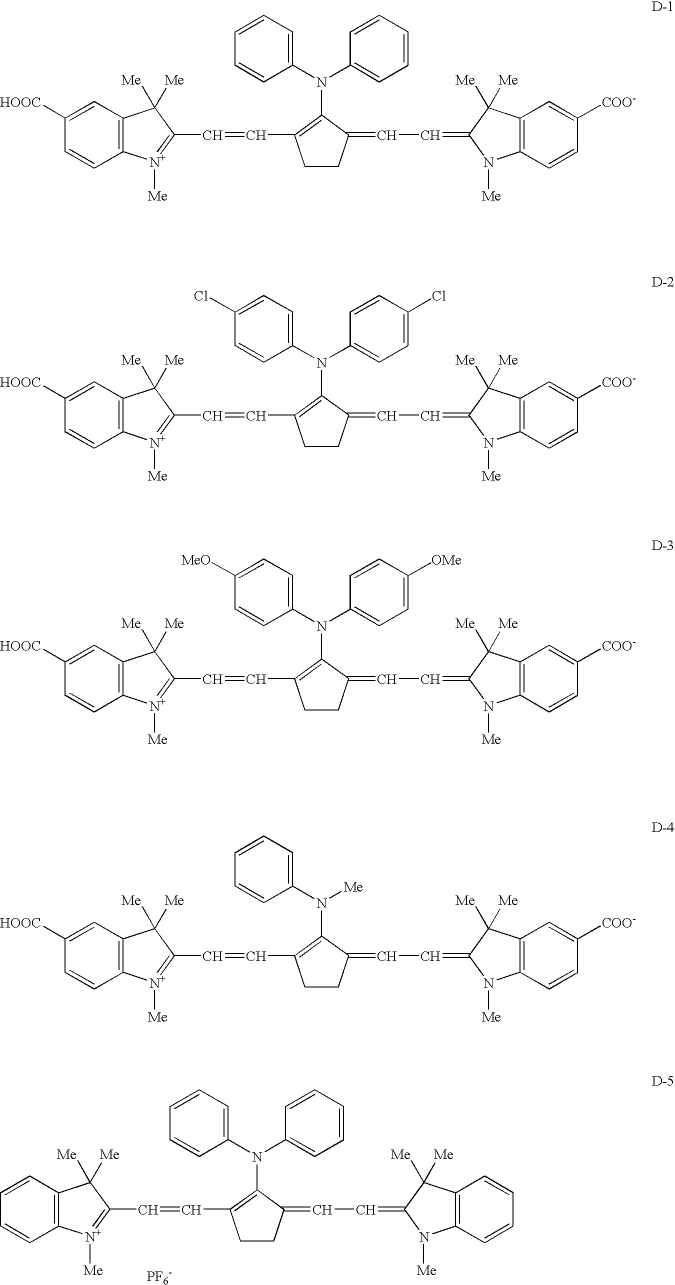

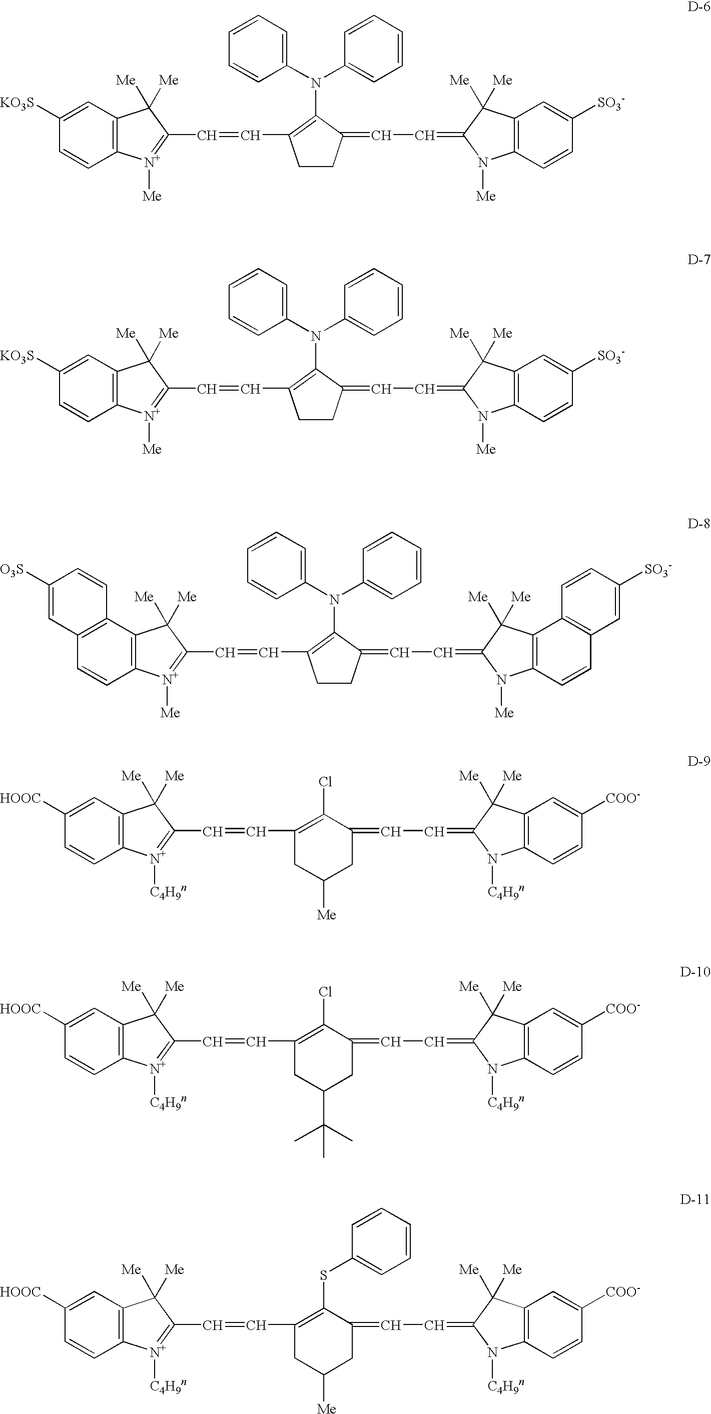

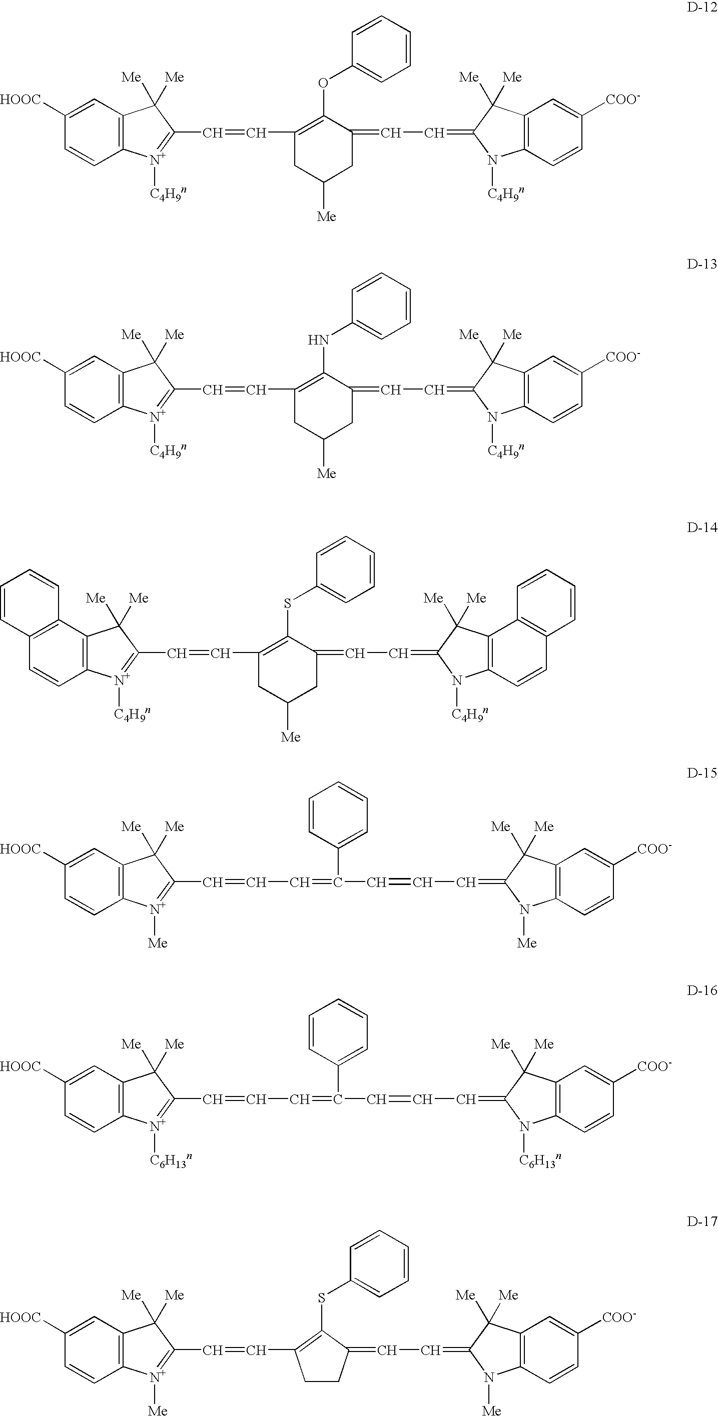

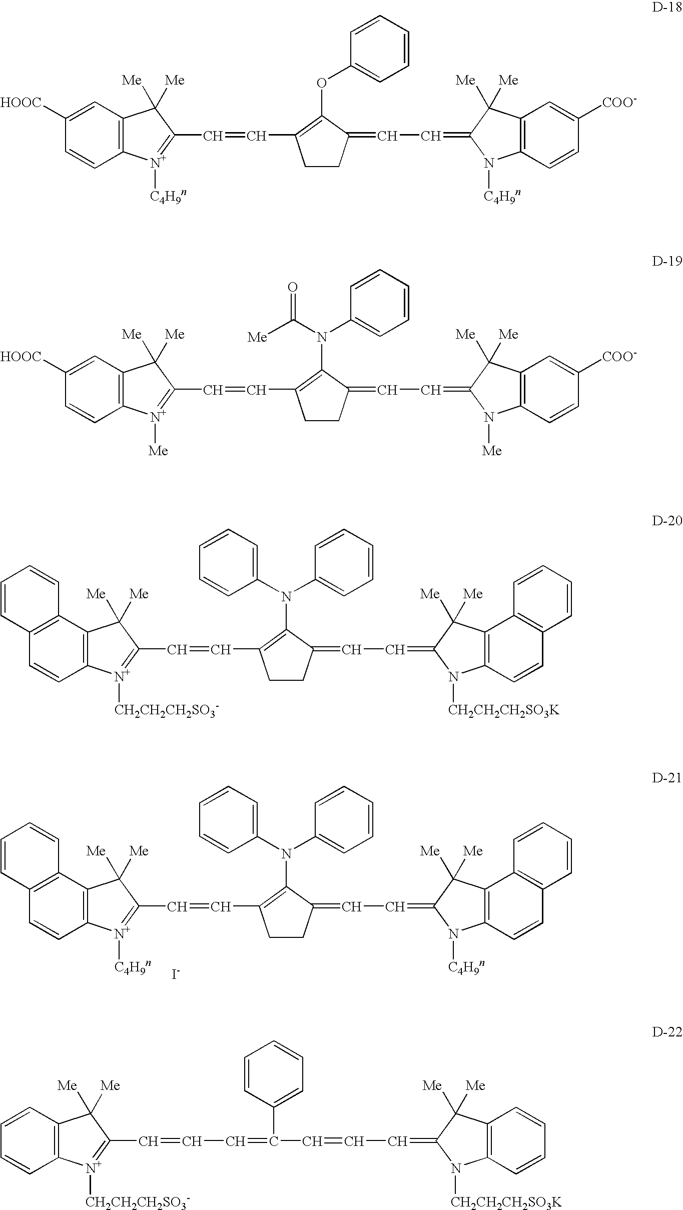

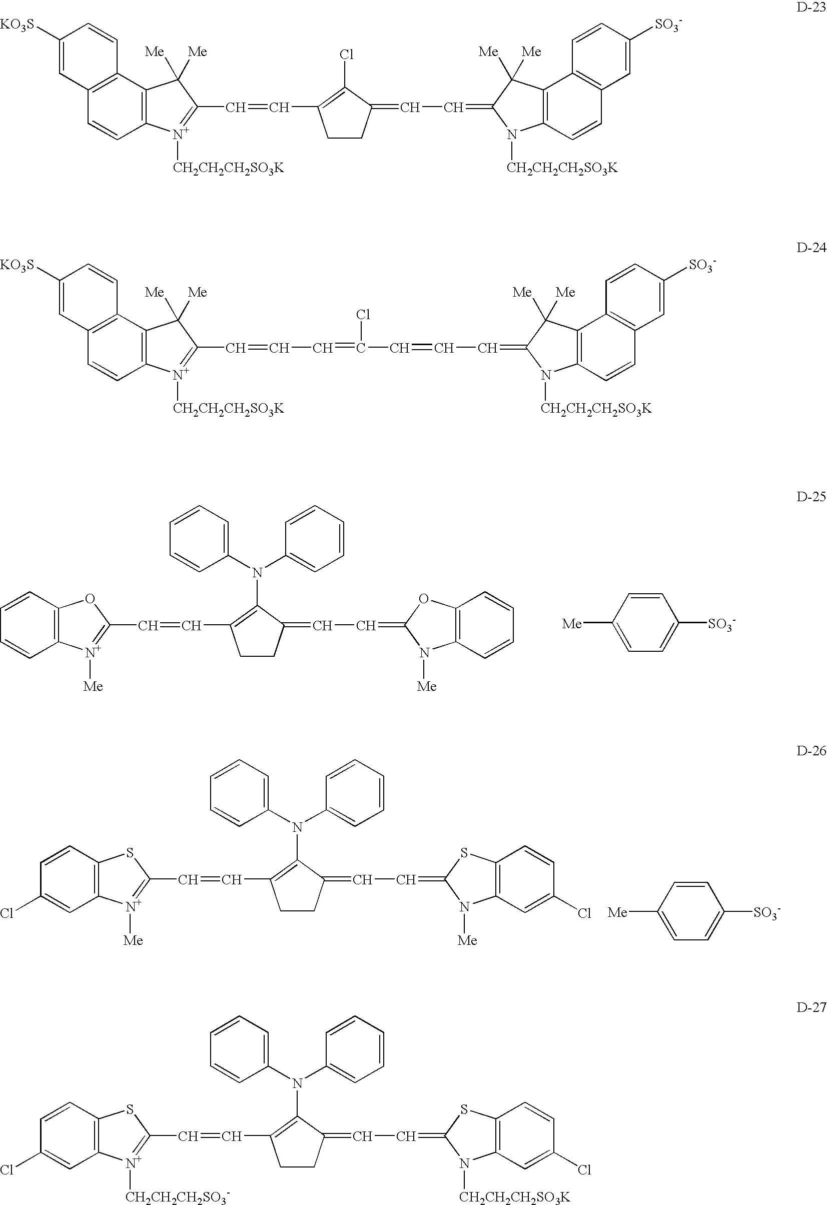

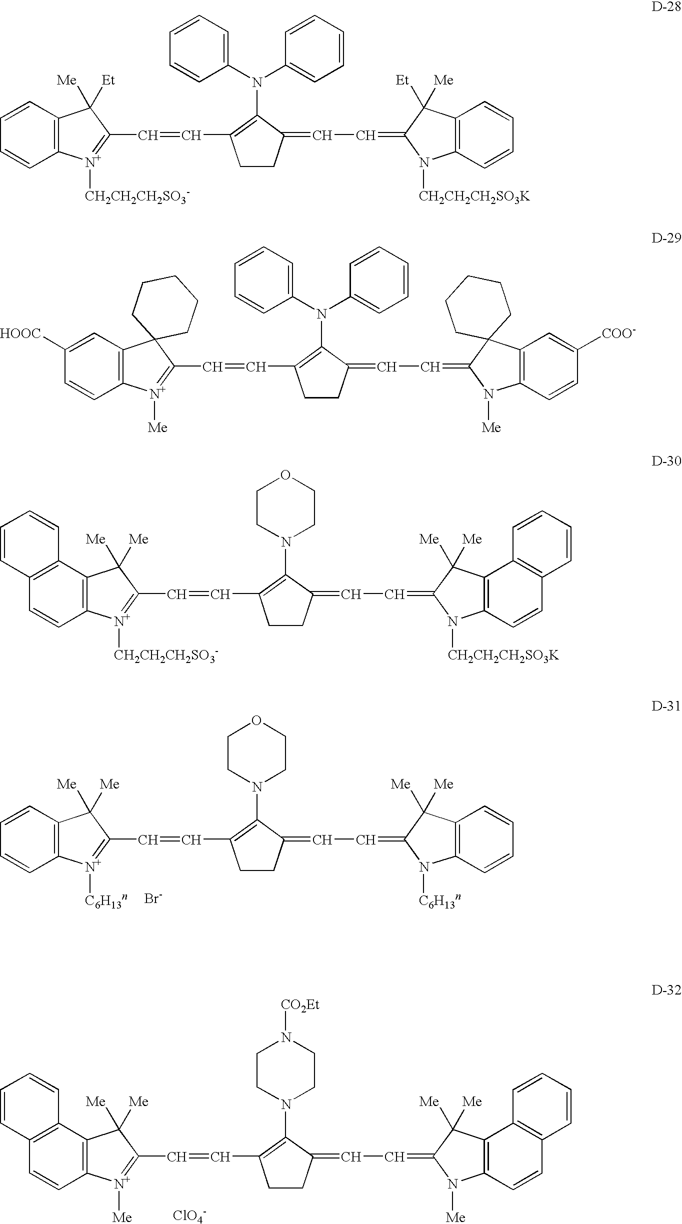

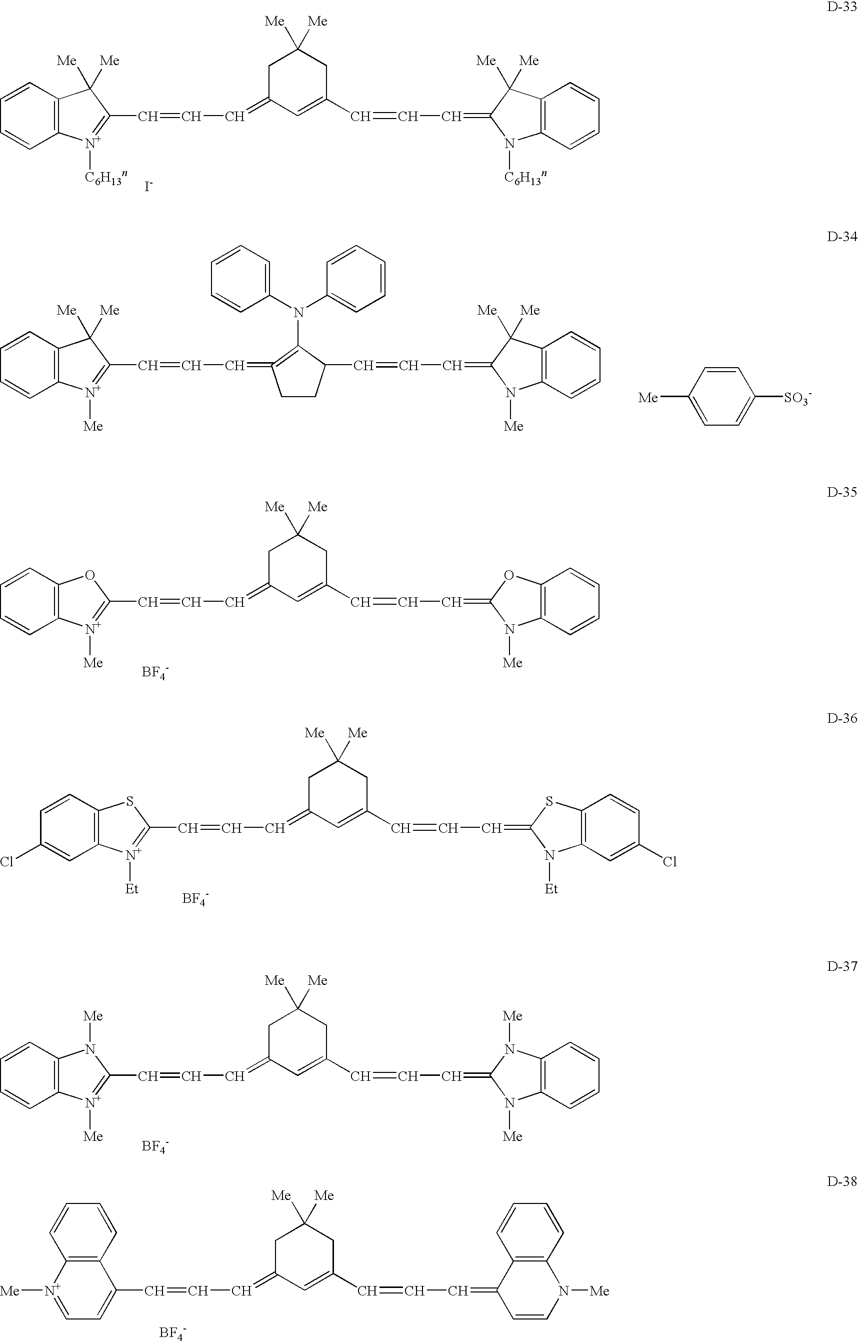

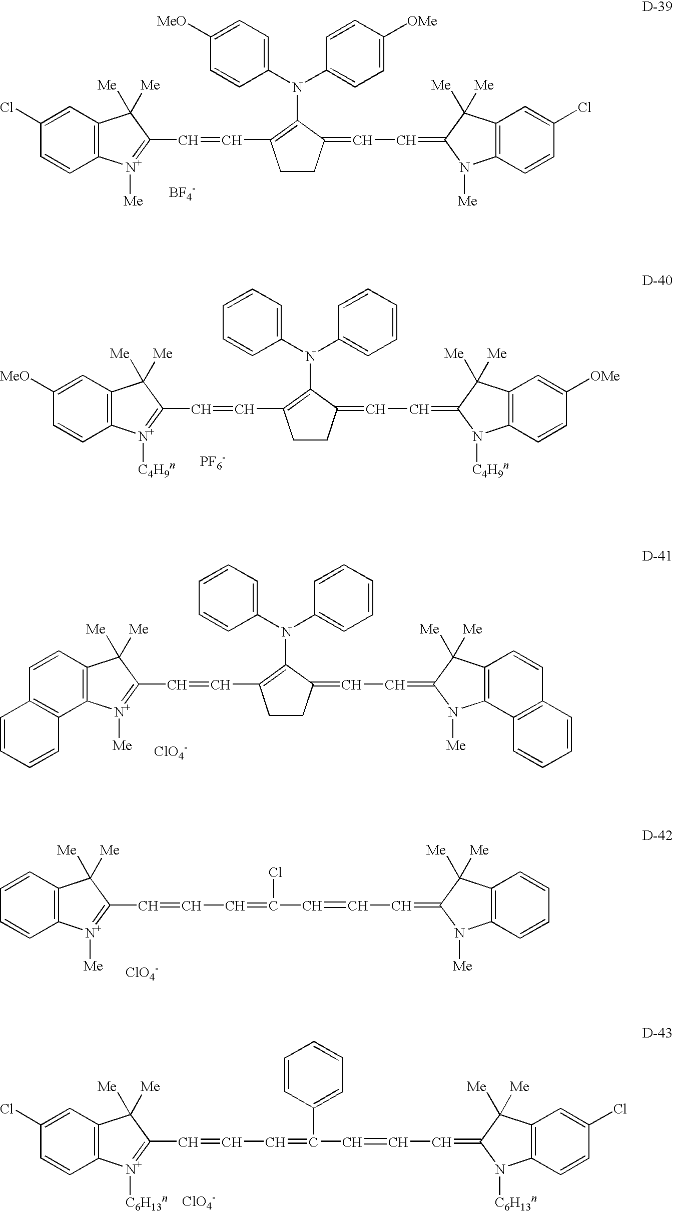

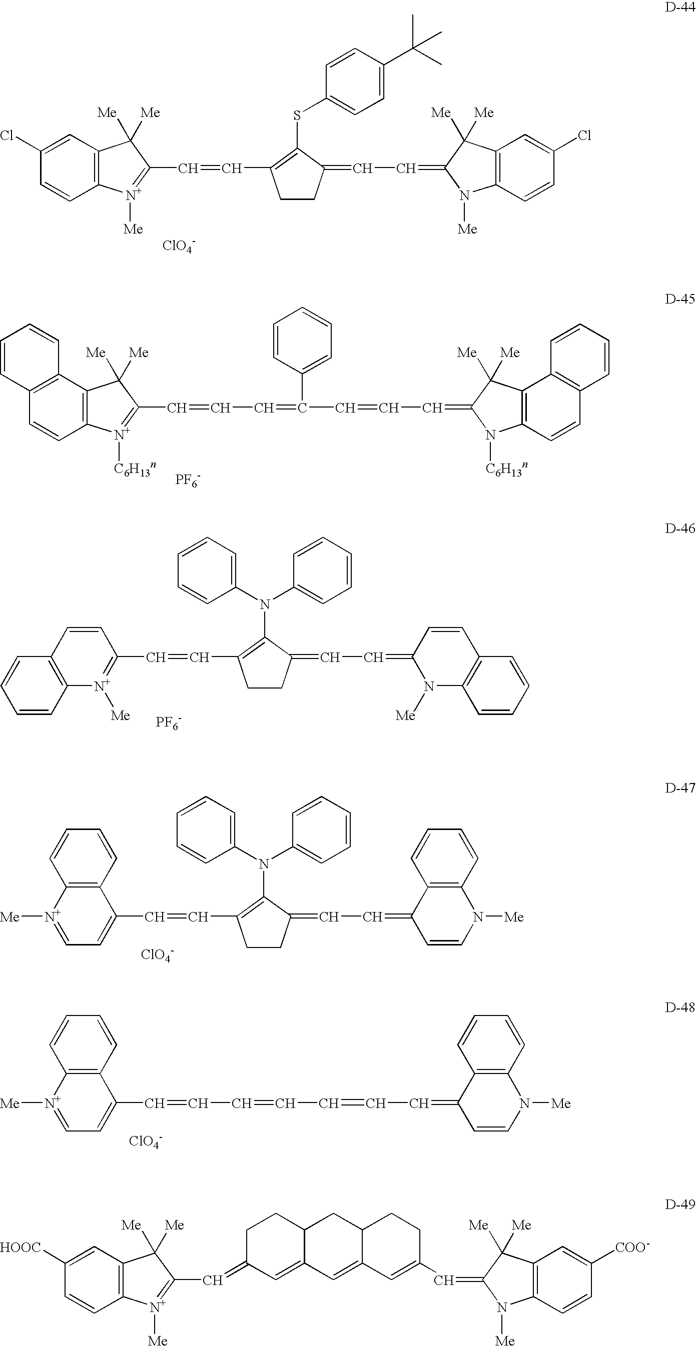

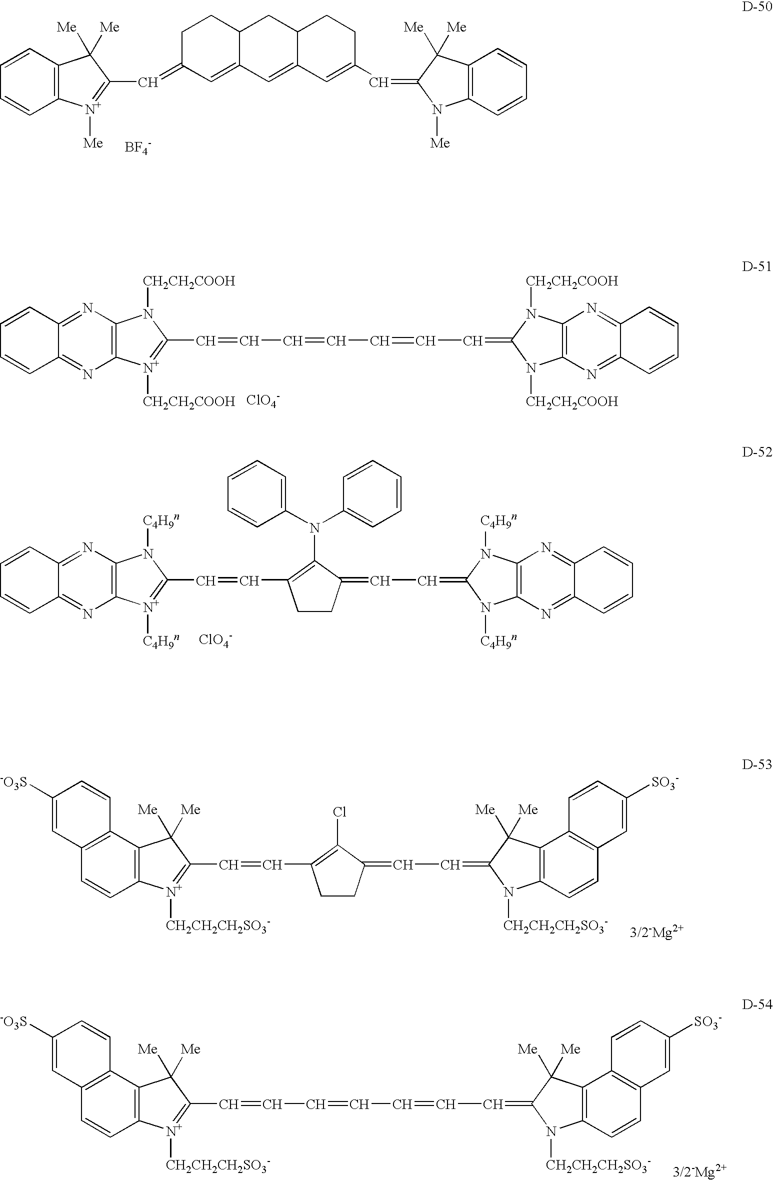

The above-described cyanine dyes can be synthesized with reference to F. M. Hamer, Heterocyclic Compounds Cyanine Dyes and Related Compounds, John Wiley & Sons Company, New York & London (publication date 1964); D. M. Sturmer, Heterocyclic Compounds-Special topics in heterocyclic chemistry, Chapter 18, Subchapter 14, p. 482-515, John Wiley & Sons Company, New York & London (publication date 1977); Rodds Chemistry of Carbon Compounds, 2^{nd} Ed., vol. IV, part B, (publication date 1977), Chapter 15, p. 369-422, published by Elsevier Science Publishing Company Inc., New York; JP-A-62-123252, JP-A-3-226736, JP-A-5-88293, JP-A-5-313305, JP-A-6-313939, JP-A-6-43583, and European Patent No. 0430244A.

The above-described cyanine dyes may be modified to a lake to use it as a lake cyanine dye. In formula (X-1), when the cyanine dye is substituted with an anionic dissociable group, the lake can be produced by forming a salt with a cation. Examples of the anionic dissociable group include a carboxyl group, a sulfo group, a phenolic hydroxyl group, a sulfonamide group, a sulfamoyl group, and a phosphono group. Among these groups, a carboxyl group, a sulfo group and a sulfonamide group are preferable; and a carboxyl group and a sulfo group are especially preferable. Examples of the inorganic cation to lake the cyanine dye include alkaline earth metal ions (for example, Mg²⁺, Ca²⁺, Ba²⁺, Sr²⁺), transition metal ions (for example, Ag⁺, Zn²⁺), and other metal ions (for example, Al³⁺). Examples of the organic cation to lake the cyanine dye include an ammonium ion, an amidinium ion, and a guanidium ion. As the organic cation, those having 4 or more carbon atoms are preferable, and divalent or trivalent cations are preferable. The lake cyanine dye may be a composite salt.

Next, the dihydroperimidinesquarylium dye represented by formula (X-3) is explained.

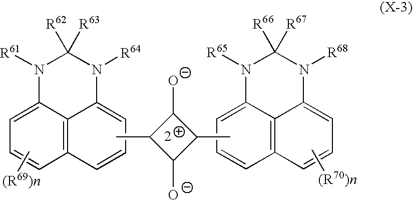

In formula (X-3), R⁶¹, R⁶², R⁶³, R⁶⁴, R⁶⁵, R⁶⁶, R⁶⁷, and R⁶⁸ each independently represent a hydrogen atom, an alkyl group, an aryl group, or a heterocyclic group; R⁶¹ and R⁶², R⁶³ and R⁶⁴, R⁶⁵ and R⁶⁶, R⁶⁷ and R⁶⁸, R⁶² and R⁶³, and R⁶⁶ and R⁶⁷ bind with each other to form a 5- or 6-membered ring, respectively; R⁶⁹ and R⁷⁰ each independently represent an alkyl group, an aryl group, an alkoxy group, an aryloxy group, a halogen atom, an alkoxycarbonyl group, an amino group, an amide group, a sulfoneamide group, a cyano group, a nitro group, a carboxyl group, or a sulfo group; and n represents an integer of 0 to 3.

In formula (X-3), the number of carbon atoms in the alkyl group is preferably in the range of 1 to 20, more preferably from 1 to 12, and further preferably from 1 to 8. Examples of the alkyl group include a methyl group, an ethyl group, a propyl group, a butyl group, a hexyl group, an undecyl group, a cyclopentyl group, an allyl group, a benzyl group, a phenetyl group, and a cyclohexyl group. The alkyl group may be branched. The alkyl group may be substituted with a substituent. Examples of the substituent include a halogen atom (for example, Cl, Br, F), an alkoxycarbonyl group (for example, methoxycarbonyl, ethoxycarbonyl), a hydroxyl group, an alkoxy group (for example, methoxy, ethoxy, isobutoxy), an aryloxy group (for example, phenoxy), and an acyloxy group (for example, acetyloxy, butyryloxy, hexylyloxy, benzolyoxy).

In formula (X-3), examples of the aryl group include a phenyl group and a naphthyl group. The aryl group may be substituted with a substituent. Examples of the substituent include an alkyl group having 1 to 8 carbon atoms (for example, methyl, ethyl, butyl), an alkoxy group having 1 to 6 carbon atoms (for example, methoxy, ethoxy), an aryloxy group (for example, phenoxy, p-chlorophenoxy), a halogen atom (for example Cl, Br, F), an alkoxycarbonyl group (for example, methoxycarbonyl, ethoxycarbonyl), an amino group, an alkyl-substituted amino group (for example, methylamino), an amide group (for example, acetoamide), a sulfonamide group (for example, methane sulfonamide), a cyano group, a nitro group, and a carboxyl group.

In formula (X-3), examples of the halogen atom include Cl, Br, and F.

In formula (X-3), the heterocyclic group is preferably a 5-member or 6-member saturated or unsaturated heterocyclic group, and is preferably 2-furyl, 2-tetrahydrofuryl, 2-pyrrolyl, 3-pyrrolyl, 2-pyridyl, 3-pyridyl, 4-pyridyl, or the like. The heterocyclic group may further have a substituent.

In formula (X-3), the number of carbon atoms in the alkoxyl group represented by R⁶⁹ and R⁷⁰ is preferably in the range of 1 to 6. Examples of the alkoxy group include a methoxy group and an ethoxy group.

In formula (X-3), the aryloxy group represented by R⁶⁹ and R⁷⁰ may be substituted with a substituent. Examples of the substituent include a halogen atom (for example, Cl). Examples of the aryloxy group include a phenoxy group, and a p-chlorophenoxy group.

In formula (X-3), examples of the alkoxycarbonyl group represented by R⁶⁹ and R⁷⁰ include a methoxycarbonyl group, and an ethoxycarbonyl group.

In formula (X-3), examples of the amino group represented by R⁶⁹ and R⁷⁰ include a methylamino group.

In formula (X-3), examples of the amido group represented by R⁶⁹ and R⁷⁰ include an acetoamide group.

In formula (X-3), examples of the sulfonamido group represented by R⁶⁹ and R⁷⁰ include a methane sulfonamide group.

Examples of the ring that is formed by binding R⁶¹ to R⁶², R⁶³ to R⁶⁴, R⁶⁵ to R⁶⁶, R⁶⁷ to R⁶⁸, R⁶² to R⁶³, and R⁶⁶ to R⁶⁷ include a cyclopentane ring and a cyclohexane ring.

It is preferable that the position at which the squarylium ring bonds to the dihydroperimidine ring is an ortho- or para-position relative to the position at which the nitrogen atom bonds to the benzene ring of the dihydroperimidine ring. The ortho position is more preferable.

Specific examples of the dihydroperimidinesquarylium dye represented by formula (X-3) are described below. However, the present invention is not limited thereto.

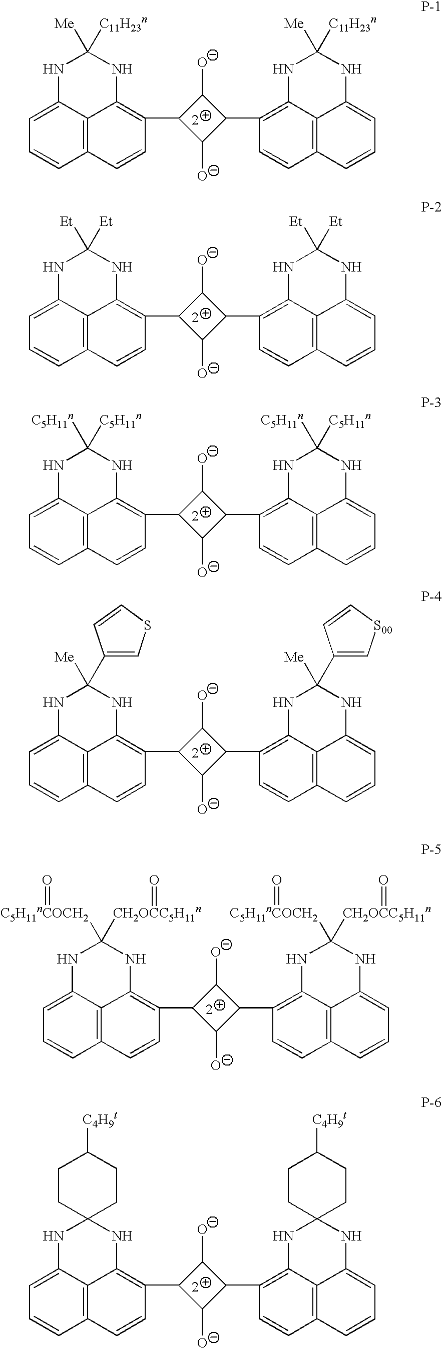

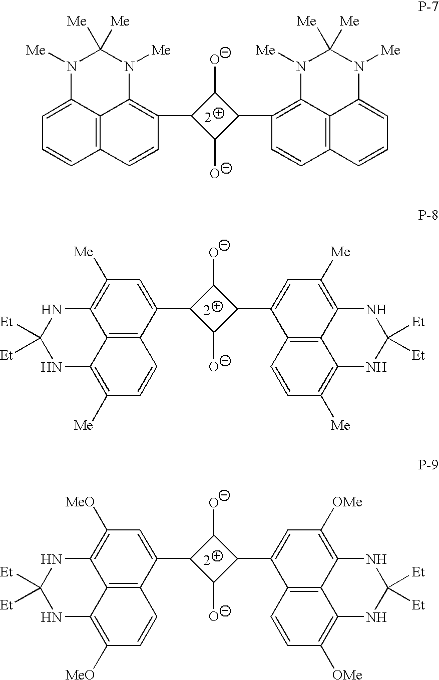

The dihydroperimidinesquarylium dye represented by formula (X-3) can be synthesized with reference to synthetic methods described in U.S. Pat. No. 5,380,635.

Next, the naphthooxazinesquarylium dye represented by formula (X-4) is explained.

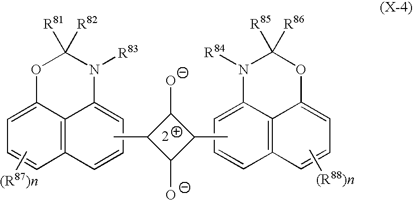

In formula (X-4), R⁸¹, R⁸², R⁸³, R⁸⁴, R⁸⁵, and R⁸⁶ each independently represent a hydrogen atom, an alkyl group, an aryl group, or a heterocyclic group; R⁸¹ and R⁸², R⁸⁵ and R⁸⁶ may bind with each other to form a 5- or 6-membered ring, respectively; R⁸⁷ and R⁸⁸ each independently represent an alkyl group, an aryl group, an alkoxy group, an aryloxy group, a halogen atom, an alkoxycarbonyl group, an amino group, an amide group, a sulfoneamide group, a cyano group, a nitro group, or a carboxyl group; and n represents an integer of 0 to 3.

The alkyl group, the aryl group, the heterocyclic group, the alkoxy group, the aryloxy group, the halogen atom, the alkoxycarbonyl group, the amide group and the sulfone amide group in formula (X-4) have the same meanings as those in formula (X-3), respectively, Examples of the ring that is formed by combining R⁸¹ to R⁸², and R⁸⁵ to R⁸⁶ include a cyclopentane ring and a cyclohexane ring.

It is preferable that the position at which the squarylium ring bonds to the naphthooxazinine ring is an ortho- or para-position relative to the position at which the nitrogen atom bonds to the benzene ring of the naphthooxazinine ring. The ortho-position is more preferable.

Specific examples of the naphthooxazininesquarylium dye represented by formula (X-4) are described below. However, the present invention is not limited thereto.

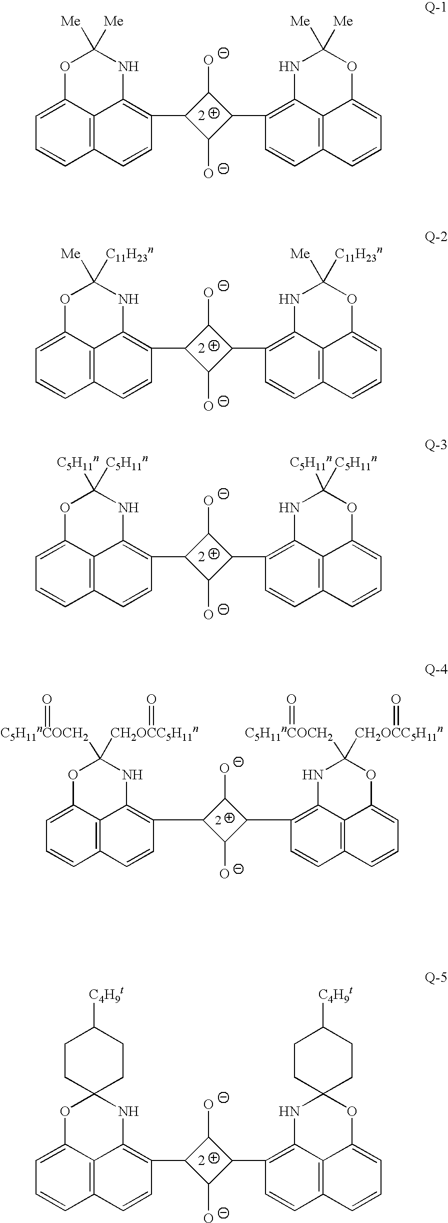

Other squarylium dyes or croconium dyes may be used. Specific examples of the other squarylium dyes and croconium dyes are described below.

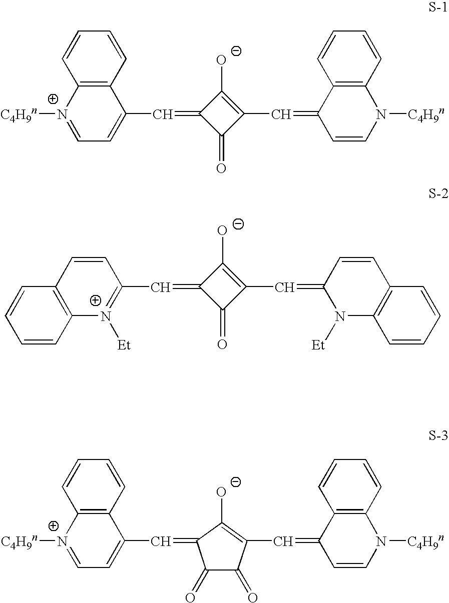

Next, the diimonium dye represented by formula (X-5) is explained.

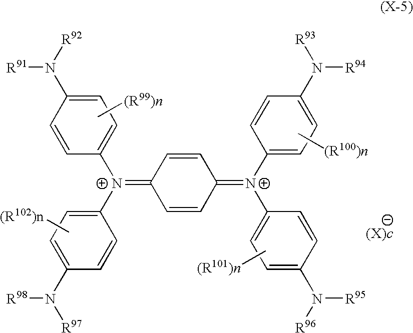

In formula (X-5), R⁹¹, R⁹², R⁹³, R⁹⁴, R⁹⁵, R⁹⁶, R⁹⁷ and R⁹⁸ each independently represent a hydrogen atom or an alkyl group; R⁹⁹, R¹⁰⁰, R¹⁰¹ and R¹⁰² each independently represent an alkyl group, an aryl group, an alkoxy group, an aryloxy group, a halogen atom, an alkoxycarbonyl group, an amino group, an amide group, a sulfonamide group, a cyano group, nitro group, or a carboxyl group; R⁹¹ and R⁹², R⁹³ and R⁹⁴, R⁹⁵ and R⁹⁶, R⁹⁷ and R⁹⁸, R⁹¹ and R⁹⁹, R⁹² and R⁹⁹, R⁹³ and R¹⁰⁰, R⁹⁴ and R¹⁰⁰, R⁹⁵ and R¹⁰¹, R⁹⁶ and R¹⁰¹, R⁹⁷ and R¹⁰² and R⁹⁸ and R¹⁰² may bind with each other to form a 5- or 6-membered ring, respectively; n represents an integer of 0 to 3; X represents an anion or a cation necessary to neutralize the charge in the molecule; and c represents an integer of 0 to 6.

In formula (X-5), the number of carbon atoms in the alkyl group is preferably in the range of 1 to 20, more preferably from 1 to 12, further preferably from 1 to 8, and still further preferably 4. Examples of the alkyl group include a methyl group, an ethyl group, a propyl group, a n-butyl group, an iso-butyl group, a sec-butyl group, a hexyl group, a cyclopentyl group, a cyclohexyl group and an undecyl group. The alkyl group may be branched. The alkyl group may be substituted with a substituent. Examples of the substituent include a halogen atom (for example, F, Cl, Br), an alkoxycarbonyl group (for example, methoxycarbonyl, ethoxycarbonyl), a hydroxyl group, an alkoxy group (for example, methoxy, ethoxy, isobutoxy), an aryloxy group (for example, phenoxy), an acyloxy group (for example, acetyloxy, butyryloxy, hexyloxy, benzolyoxy), a carboxyl group, and a sulfo group.

In formula (X-5), the number of carbon atoms in the aryl group represented by R⁹⁹ to R¹⁰² is preferably in the range of 6 to 12. Examples of the aryl group include a phenyl group and a naphthyl group. The aryl group may be substituted with a substituent. Examples of the substituent include an alkyl group having 1 to 8 carbon atoms (for example, methyl, ethyl, butyl), an alkoxy group having 1 to 6 carbon atoms (for example, methoxy, ethoxy), an aryloxy group (for example, phenoxy, p-chlorophenoxy), a halogen atom (for example Cl, Br, F), an alkoxycarbonyl group (for example, methoxycarbonyl, ethoxycarbonyl), an amino group, an alkyl-substituted amino group (for example, methylamino), an amide group (for example, acetoamide), a sulfonamide group (for example, methane sulfonamide), a cyano group, a nitro group, a carboxyl group, and a sulfo group.

In formula (X-5), the number of carbon atoms in the alkoxyl group represented by R⁹⁹ to R¹⁰² is preferably in the range of 1 to 6. Examples of the alkoxy group include a methoxy group and an ethoxy group.

In formula (X-5), the aryloxy group represented by R⁹⁹ to R¹⁰² may be substituted with a substituent. Examples of the substituent include a halogen atom (for example, Cl). Examples of the aryloxy group include a phenoxy group, and a p-chlorophenoxy group.

In formula (X-5), examples of the alkoxycarbonyl group represented by R⁹⁹ to R¹⁰² include a methoxycarbonyl group, and an ethoxycarbonyl group.

In formula (X-5), examples of the amino group represented by R⁹⁹ to R¹⁰² include a methylamino group.

In formula (X-5), examples of the amido group represented by R⁹⁹ to R¹⁰² include an acetoamide group.

In formula (X-5), examples of the sulfonamido group represented by R⁹⁹ to R¹⁰² include a methane sulfonamide group.

In formula (X-5), examples of the halogen atom represented by R⁹⁹ to R¹⁰² include Cl, Br, and F.

In formula (X-5), examples of the ring that is formed by combining R⁹¹ to R⁹², R⁹³ to R⁹⁴, R⁹⁵ to R⁹⁶, and R⁹⁷ to R⁹⁸ include piperazine, piperidine, morpholine, and pyrrolidine rings. Examples of the ring that is formed by combining R⁹¹ to R⁹⁹, R⁹² to R⁹⁹, R⁹³ to R¹⁰⁰, R⁹⁴ to R¹⁰⁰, R⁹⁵ to R¹⁰¹, R⁹⁶ to R¹⁰¹, R⁹⁷ to R¹⁰², and R⁹⁸ to R¹⁰² include a julolidine ring and a tetrahydroquinoline ring. When R⁹⁹, R¹⁰⁰, R¹⁰¹ or R¹⁰² forms a ring by combining with R⁹¹, R⁹², R⁹³, R⁹⁴, R⁹⁵, R⁹⁶R⁹⁷ or R⁹⁸, it is preferable that the position of R⁹⁹, R¹⁰⁰, R¹⁰¹ or R¹⁰² is adjacent to the position of R⁹¹, R⁹², R⁹³, R⁹⁴, R⁹⁵, R⁹⁶, R⁹⁷ or R⁹⁸.

In formula (X-5), examples of the anion represented by X include a halogen atom (for example, F⁻, Cl⁻, Br⁻, I⁻), a p-toluene sulfonic acid ion, a methylsulfate ion, an ethylsulfate ion, PF₆⁻, BF₄⁻, CLO₄⁻, a bis(trifluoromethane sulfonyl) imide ion, a saccharin anion, and a tris (trifluoromethane sulfonyl)methide ion. When the compound represented by formula (X-5) has two carboxyl groups or sulfo groups in its molecule, c is 0. When the compound represented by formula (X-5) has three or more carboxyl groups or sulfo groups in its molecule, a cation is necessary. Examples of the cation include alkali metal ions (for example, sodium, potassium, and lithium ions), ammonium ions (for example, triethyl ammonium ions), and pyridinium ions.

Specific examples of the diimonium dye represented by formula (X-5) are described below. However, the present invention is not limited thereto.

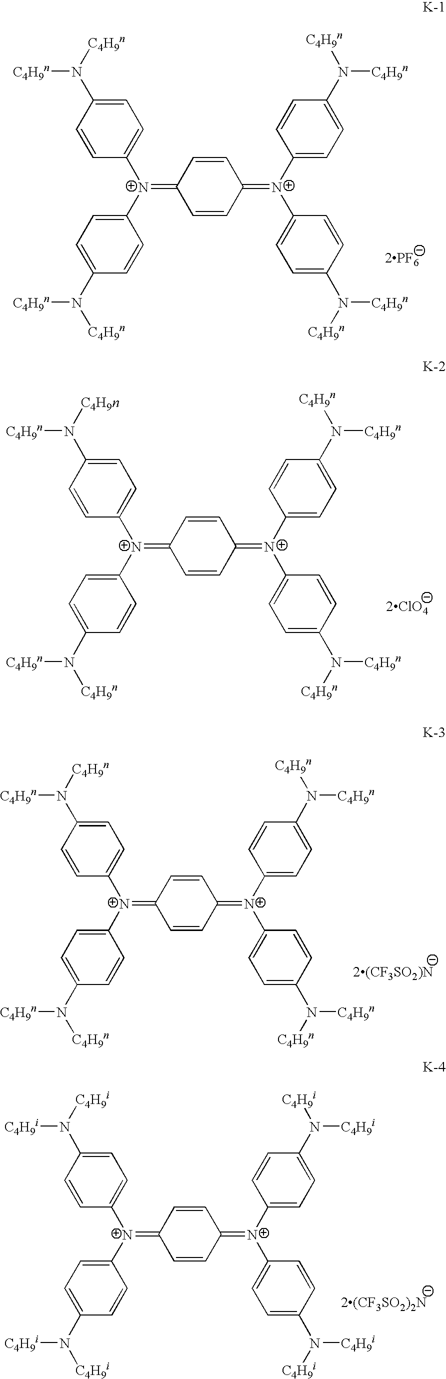

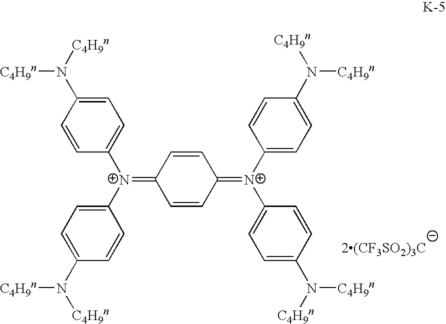

The diimonium dye represented by formula (X-5) can be synthesized with reference to synthetic methods described in JP-B-43-25335 (“JP-B” means examined Japanese patent publication).

Next, the polymethine dyes represented by formula (X-6) are explained.

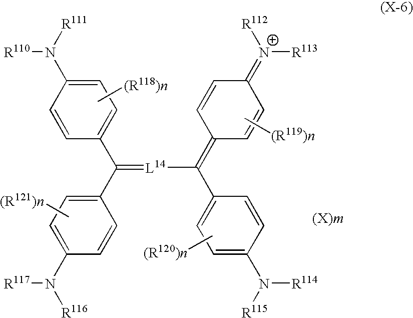

In formula (X-6), R¹¹⁰, R¹¹¹, R¹¹², R¹¹³, R¹¹⁴, R¹¹⁵, R¹¹⁶ and R¹¹⁷ each independently represent a hydrogen atom, an alkyl group, or an aryl group; R¹¹⁸, R¹¹⁹, R¹²⁰ and R¹²¹ each independently represent an alkyl group, an aryl group, an alkoxy group, an aryloxy group, a halogen atom, an alkoxycarbonyl group, an amino group, an amide group, a sulfonamide group, a cyano group, a nitro group, or a carboxyl group; R¹¹⁰ and R¹¹¹, R¹¹² and R¹¹³, R¹¹⁴ and R¹¹⁵, R¹¹⁶ and R¹¹⁷, R¹¹⁰ and R¹¹⁸, R¹¹¹ and R¹¹⁸, R¹¹² and R¹¹⁹, R¹¹³ and R¹¹⁹, R¹¹⁴ and R¹²⁰, R¹¹⁵ and R¹²⁰, R¹¹⁶ and R¹²¹, or R¹¹⁷ and R¹²¹ may bind with each other to form a 5- or 6-membered ring, respectively; L¹⁴ represents a trimethine group, or a pentamethine group; n represents an integer of 0 to 3; X represents an anion or a cation necessary to neutralize the charge in the molecule; and m represents an integer of 0 to 6.

The alkyl group, the aryl group, the alkoxy group, the aryloxy group, the halogen atom, the alkoxycarbonyl group, the amino group, the amide group and the sulfonamide group in formula (X-6) have the same meanings as those in formula (X-5), respectively. In formula (X-6), examples of the ring that is formed by combining R¹¹⁰ to R¹¹¹, R¹¹² to R¹¹³, R¹¹⁴ to R¹¹⁵, or R¹¹⁶ to R¹¹⁷ include piperazine, piperidine, morpholine, and pyrrolidine rings. Examples of the ring that is formed by combining R¹¹⁰ to R¹¹⁸, R¹¹¹ to R¹¹⁸, R¹¹² to R¹¹⁹, R¹¹³ to R¹¹⁹, R¹¹⁴ to R¹²⁰, R¹¹⁵ to R¹²⁰, R¹¹⁶ to R¹²¹, or R¹¹⁷ to R¹²¹ include a julolidine ring and a tetrahydroquinoline ring. When R¹¹⁸, R¹¹⁹, R¹²⁰ or R¹²¹ forms a ring by combining with R¹¹⁰, R¹¹¹, R¹¹², R¹¹³, R¹¹⁴, R¹¹⁵, R¹¹⁶ or R¹¹⁷, it is preferable that the position of R¹¹⁸, R¹¹⁹, R¹²⁰ or R¹²¹ is adjacent to the position of R¹¹⁰, R¹¹¹, R¹¹², R¹¹³, R¹¹⁴, R¹¹⁵, R¹¹⁶ or R¹¹⁷.

The methine group in L¹⁴ may be substituted with a substituent. The substituent of the methine group in L¹⁴ is the same as that of the methine group (L) in formula (X-1).

In formula (X-6), X and m have the same meanings as those in formula (X-5), respectively.

Specific examples of the polymethine dye represented by formula (X-6) is described below. However, the present invention is not limited thereto.

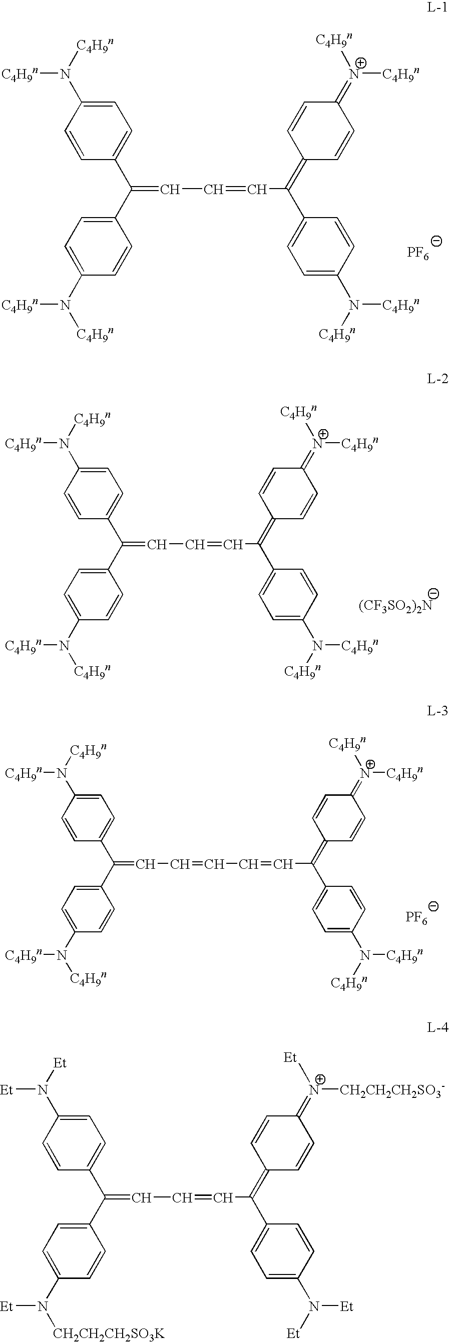

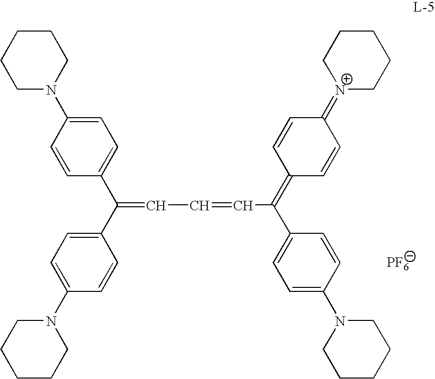

The polylmethine dyes represented by formula (X-6) may be synthesized with reference to synthetic methods described in J. Am. Chem. Soc., vol. 80, p. 3772-3777 (1958).

Next, the azomethine dye represented by formula (X-7) is explained.

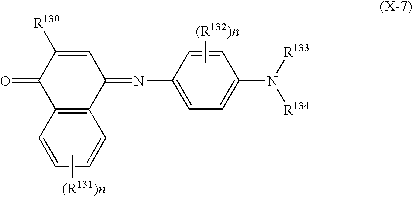

In formula (X-7), R¹³⁰ represents a hydrogen atom, a halogen atom, a carboxyl group, a sulfo group, R¹³⁵—NH(C═O)—, R¹³⁵—NHSO₂—, R¹³⁵—SO₂NH—, R¹³⁵—CONH—, or R¹³⁵—NHCONH—; R¹³¹ represents a hydrogen atom, an alkyl group, R¹³⁶—SO₂NH—, or R¹³⁶—CONH—; R¹³⁵ and R¹³⁶ each independently represent an alkyl group, an aryl group, or a heterocyclic group; R¹³² represents an alkyl group, an aryl group, alkoxy group, an aryloxy group, a hydroxyl group, an amino group, an amide group, a sulfonamide group, or a halogen atom; n represents an integer of 0 to 3; R¹³³ and R¹³⁴ each independently represent an alkyl group, an aryl group, or a heterocyclic group; and R¹³² and R¹³³, R¹³³ and R¹³⁴, or R¹³² and R¹³⁴ may bind with each other to form a 5- or 6-membered ring.

In formula (X-7), the number of carbon atoms in the alkyl group is preferably in the range of 1 to 20, more preferably from 1 to 12, further preferably from 1 to 8, and still further preferably 4. Examples of the alkyl group include a methyl group, an ethyl group, a propyl group, a n-butyl group, a iso-butyl group, a sec-butyl group, a hexyl group, a cyclopentyl group, a cyclohexyl group and an undecyl group, The alkyl group may be branched. The alkyl group may be substituted with a substituent. Examples of the substituent include a halogen atom (for example, F, Cl, Br), an alkoxycarbonyl group (for example, methoxycarbonyl, ethoxycarbonyl), a hydroxyl group, an alkoxy group (for example, methoxy, ethoxy, isobutoxy), an aryloxy group (for example, phenoxy), an acyloxy group (for example, acetyloxy, butyryloxy, hexyloxy, benzolyoxy), a carboxyl group, and a sulfo group.

In formula (X-7), the number of carbon atoms in the aryl group is preferably in the range of 6 to 12. Examples of the aryl group include a phenyl group and a naphthyl group. The aryl group may be substituted with a substituent. Examples of the substituent include an alkyl group having 1 to 8 carbon atoms (for example, methyl, ethyl, butyl), an alkoxy group having 1 to 6 carbon atoms (for example, methoxy, ethoxy), an aryloxy group (for example, phenoxy, p-chlorophenoxy), a halogen atom (for example Cl, Br, F), an alkoxycarbonyl group (for example, methoxycarbonyl, ethoxycarbonyl), an amino group, an alkyl-substituted amino group (for example, methylamino), an amide group (for example, acetoamide), a sulfonamide group (for example, methane sulfonamide), a cyano group, a nitro group, a carboxyl group, and a sulfo group.

In formula (X-7), the number of carbon atoms in the alkoxyl group represented by R¹³² is preferably in the range of 1 to 6. Examples of the alkoxy group include a methoxy group and an ethoxy group.

In formula (X-7), the aryloxy group represented by R¹³² may be substituted with a substituent. Examples of the substituent include a halogen atom (for example, Cl). Examples of the aryloxy group include a phenoxy group, and a p-chlorophenoxy group.

In formula (X-7), examples of the amino group represented by R¹³² include a methylamino group.

In formula (X-7), examples of the amido group represented by R¹³² include an acetoamide group.

In formula (X-7), examples of the sulfonamido group represented by R¹³² include a methane sulfonamide group.

In formula (X-7), examples of the heterocyclic group-forming heterocyclic ring include a pyridine ring, a 1,3-thiazole ring, a 1,3,4-triazole ring, a benzothiazole ring, a benzimidazole ring, a benzoxazole ring, and a 1,2,4-thiadiazole ring.

In formula (X-7), examples of the halogen atom include F, Br, and Cl.

In formula (X-7), examples of the ring that is formed by combining R¹³³ to R¹³⁴ include a piperazine ring, a piperidine ring, a morpholine ring, and a pyrrolidine ring. In formula (X-7), examples of the ring that is formed by combining R¹³² to R¹³³, or R¹³² to R¹³⁴ include a julolidine ring and a tetrahydroquinoline ring.

Specific examples of the azomethine dye represented by formula (X-7) are described below. However, the present invention is not limited thereto.

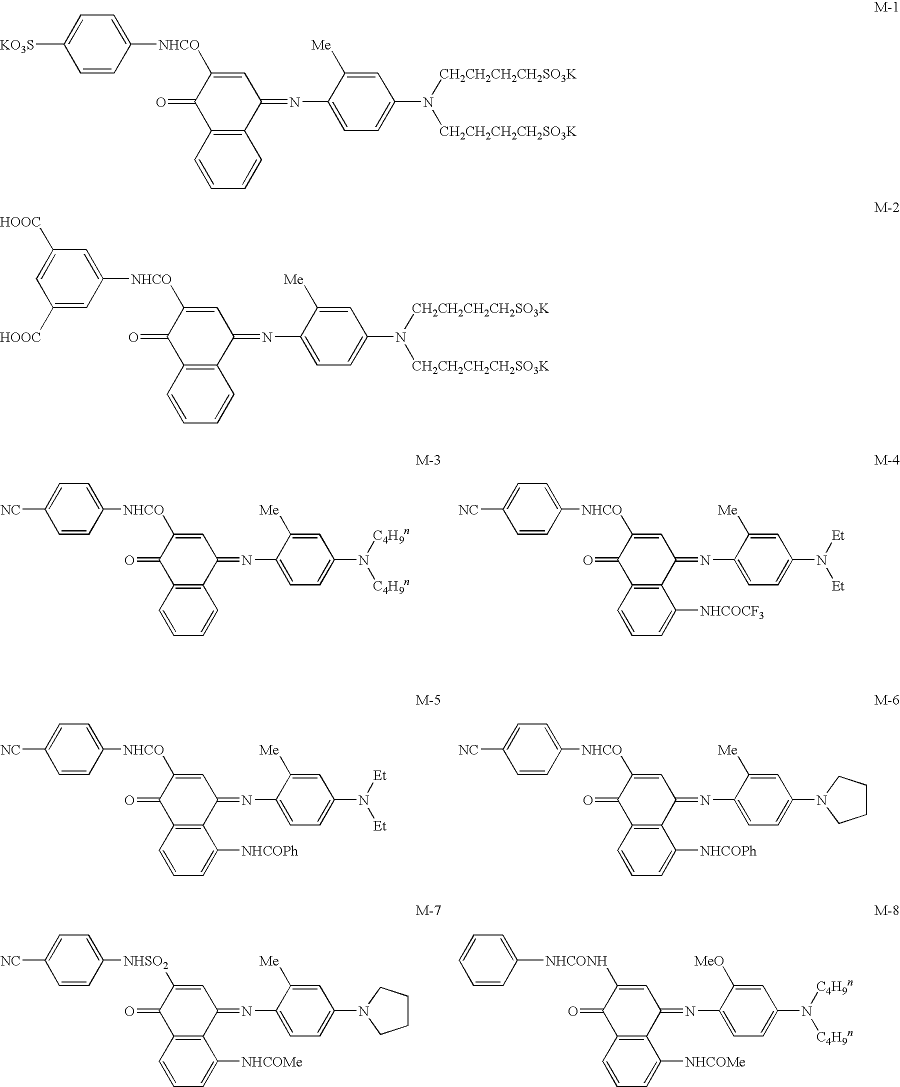

The azomethine dye represented by formula (X-7) may be synthesized with reference to synthetic methods described in JP-A-5-323500 and JP-A-5-323501. Next, the oxonol dyes represented by formula (X-8) are explained.

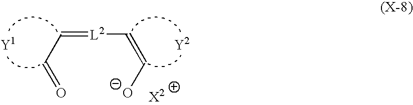

In formula (X-8), Y¹ and Y² each independently represent a group of non-metallic atoms necessary to form an aliphatic ring or a hetero ring; L² represents a methine chain composed of odd-numbered methine groups; and X² represents a hydrogen atom, or cation.

In formula (X-8), Y¹ and Y² each independently represent a group of non-metallic atoms necessary to form an aliphatic ring or a hetero ring. The hetero ring is more preferable than the aliphatic ring. Examples of the aliphatic ring include an indandione ring and a dimedone ring. Examples of the hetero ring include a 5-pyrazolone ring, an isooxazolone ring, a barbituric acid ring, a thiobarbituric acid ring, a pyridone ring, a rhodanine ring, a pyrazolidinedione, a pyrazolopyridone ring, and a meldrum's acid ring. Among these rings, a 5-pyrazolone ring, a pyrazolopyridone ring, and a barbituric acid ring are preferable. The aliphatic ring and the hetero ring may be substituted with a substituent. Examples of the substituent include a halogen atom, a cyano group, a nitro group, a hydroxyl group, a carboxyl group, an amino group, a formyl group, a carbamoyl group, an ureido group, a urethane group, a mercapto group, a sulfo group, a sulfamoyl group, an aliphatic group, an aromatic group, a heterocyclic group, —O—R, —CO—R, —CO—O—R, —O—CO—R, —NH—R, —NR₂, —NH—CO—R, —CO—NH—R, —CO—NR₂, —NH—CO—NH—R, —NH—CO—NR₂, —NH—CO—O—R, —S—R, —SO₂—R, —SO₂—O—R, —NH—SO₂—R, —SO₂—NH—R, and —SO₂—NR₂. R represents an aliphatic group, an aromatic group, or a heterocyclic group.

In formula (X-8), L² represents a methine chain composed of odd-numbered methine groups. It is preferable that L² represents a methine chain composed of 3, 5 or 7 methine groups; especially preferably 5 methine groups. The methine group may be substituted with a substituent. It is preferable that the methine group having a substituent is a central (meso-positioned) methine group. Examples of the substituent include a halogen atom, a cyano group, a nitro group, a hydroxyl group, a carboxyl group, an amino group, a formyl group, a carbamoyl group, an ureido group, a urethane group, a mercapto group, a sulfo group, a sulfamoyl group, an aliphatic group, an aromatic group, a heterocyclic group, —O—R, —CO—R, —CO—O—R, —O—CO—R, —NH—R, —NR₂—NH—CO—R, —CO—NH—R, —CO—NR₂, —NH—CO—NH—R, —NH—CO—NR₂, —NH—CO—O—R, —S—R, —SO₂—R, —SO₂—O—R, —NH—SO₂—R, —SO₂—NH—R, and —SO₂—NR₂. R represents an aliphatic group, an aromatic group, or a heterocyclic group. Two substituents of the methine chain may bind with each other to form a 5- or 6-membered ring.

In formula (X-8), X² represents a hydrogen atom, or cation. Examples of the cation include alkali metal ions (for example, Na⁺, K⁺), an ammonium ion, a triethyl ammonium ion, a tributyl ammonium ion, a pyridinium ion, and a tetrabutyl ammonium ion.

Specific examples of the oxonol dye are described below. However, the present invention is not limited thereto.

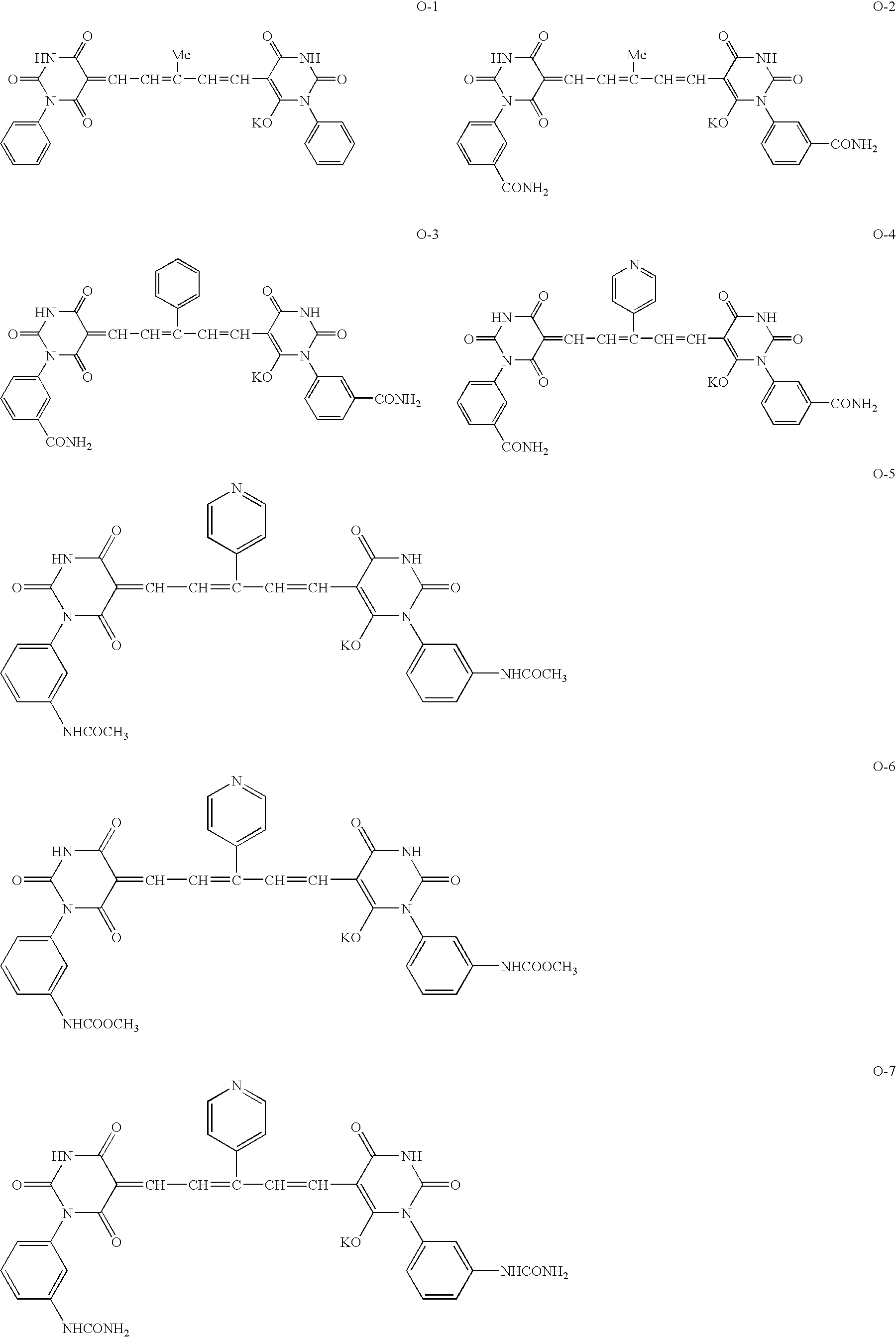

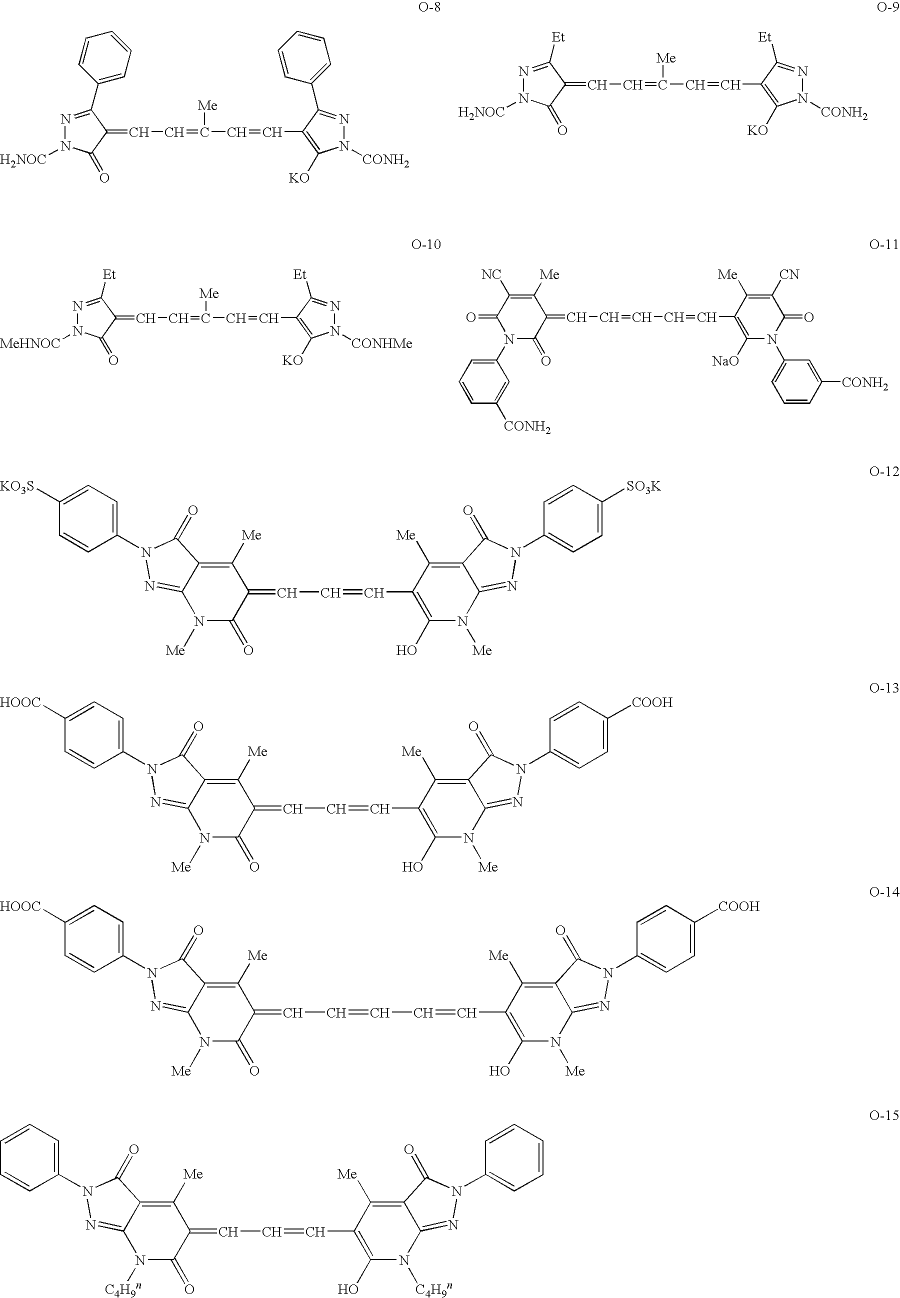

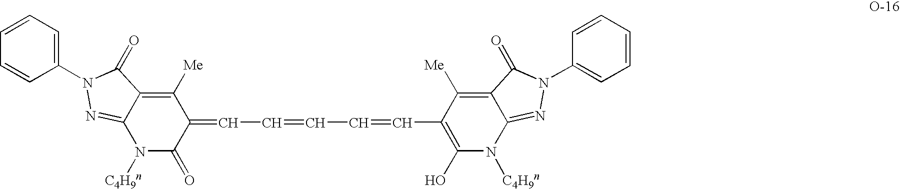

The oxonol dye represented by formula (X-8) may be synthesized with reference to synthetic methods described in JP-A-7-230671, European Patent No. 0778493, U.S. Pat. No. 5,459,265, JP-B-39-22069, JP-B-43-3504, and JP-B-54-38129.

Next, the phthalocyanine dye represented by formula (X-9) is explained.

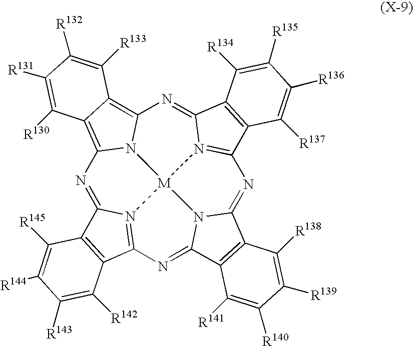

In formula (X-9), R¹³⁰, R¹³¹, R¹³², R¹³³, R¹³⁴, R¹³⁵, R¹³⁶, R¹³⁷, R¹³⁸, R¹³⁹, R¹⁴⁰, R¹⁴¹, R¹⁴², R¹⁴³, R¹⁴⁴, and R¹⁴⁵ each independently represent a hydrogen atom, a halogen atom, an alkyl group, an aryl group, a hydroxyl group, a cyano group, a nitro group, an alkoxy group, an aryloxy group, an alkylthio group, an arylthio group, an alkylsulfonyl group, an arylsulfonyl group, a sulfamoyl group, a carbamoyl group, or an amino group; two groups of R¹³⁰, R¹³¹, R¹³², R¹³³, R¹³⁴, R¹³⁵, R¹³⁶, R¹³⁷, R¹³⁸, R¹³⁹, R¹⁴⁰, R¹⁴¹, R¹⁴², R¹⁴³, R¹⁴⁴, and R¹⁴⁵ adjacent to each other may bind with each other to form a ring; and M represents a non-metal, a metal, a metal oxide, or a metal halide.

In formula (X-9), the halogen atom is preferably a fluorine atom, or a chlorine atom. The alkyl group is preferably an alkyl group having 1 to 18 carbon atoms (for example, methyl, ethyl, propyl, butyl, isobutyl, pentyl, hexyl). The aryl group is preferably an aryl group having 6 to 18 carbon atoms (for example, phenyl, 4-methylphenyl). The alkoxy group is preferably an alkoxy group having 1 to 18 carbon atoms (for example, methoxy, ethoxy, cyclohexyloxy, 2-ethylhexyloxy). The aryloxy group is preferably an aryloxy group having 6 to 18 carbon atoms (for example, phenoxy, p-chlorophenoxy). The alkylthio group is preferably an alkylthio group having 1 to 18 carbon atoms (for example, methylthio, ethylthio, butylthio, octylthio, 2-ethylhexylthio). The arylthio group is preferably an arylthio group having 6 to 18 carbon atoms (for example, phenylthio, p-chlorophenylthio, 4-methylphenylthio, 4-tert-butylphenylthio). The alkylsulfonyl group is preferably an alkylsulfonyl group having 1 to 18 carbon atoms (for example, methylsulfonyl, ethylsulfonyl, 2-ethylhexylsulfonyl). The arylsulfonyl group is preferably an arylsulfonyl group having 6 to 18 carbon atoms (for example, phenylsulfonyl). The sulfamoyl group is preferably a sulfamoyl group having 0 to 18 carbon atoms (for example, unsubstituted sulfamoyl, N-methyl sulfamoyl, morpholinosulfonyl). The carbamoyl group is preferably a carbamoyl group having 0 to 18 carbon atoms (for example, unsubstituted carbamoyl, N-methyl carbamoyl, N,N-dibutylcarbamoyl). The amino group may be unsubstituted or may be substituted with a substituent. Examples of the substituent include an acyl group, a carbamoyl group, and a sulfonyl group as well as the aforementioned alkyl group and aryl group. Examples of the substited amino group include an alkylamino group (such as methylamino, dimethylamino, diethylamino, morpholino, pyrrolidino, and piperidino), an arylamino group (such as anilino, N-methylanilino, diphenylamino, and indolino), an acylamino group (such as acetoamide, propionylamino, phthalimide, and N-methylacetoamide), a carbamoylamino group (such as N,N-dimethylaminocarbonylamino, and pyrrolidinocarbonylamino), and a sulfonylamino group (such as methanesulfonamide, ethansulfonamide, butanesulfonamide, and benzenesulfonamide).

M represents a non-metal, a metal, a metal oxide, or a metal halide. Herein, the non-metal means an atom other than metals, for example two hydrogen atoms. Examples of the metal include iron, magnesium, nickel, cobalt, copper, palladium, zinc, vanadium, titanium, indium, and tin. Examples of the metal oxide include titanyl, and vanadyl. Examples of the metal halide include aluminum chloride, indium chloride, germanium chloride, tin(II) chloride, tin(IV) chloride, and silicon chloride. Among these materials, metals, metal oxides, or metal halides are preferable. Specifically, copper, zinc, cobalt, nickel, iron, vanadyl, titanyl, indium chloride, and tin(II) chloride are preferable; and copper, vanadyl, and zinc are more preferable.

Specific examples of the phthalocyanine dye represented by formula (X-9) are described below. However, the present invention is not limited thereto.

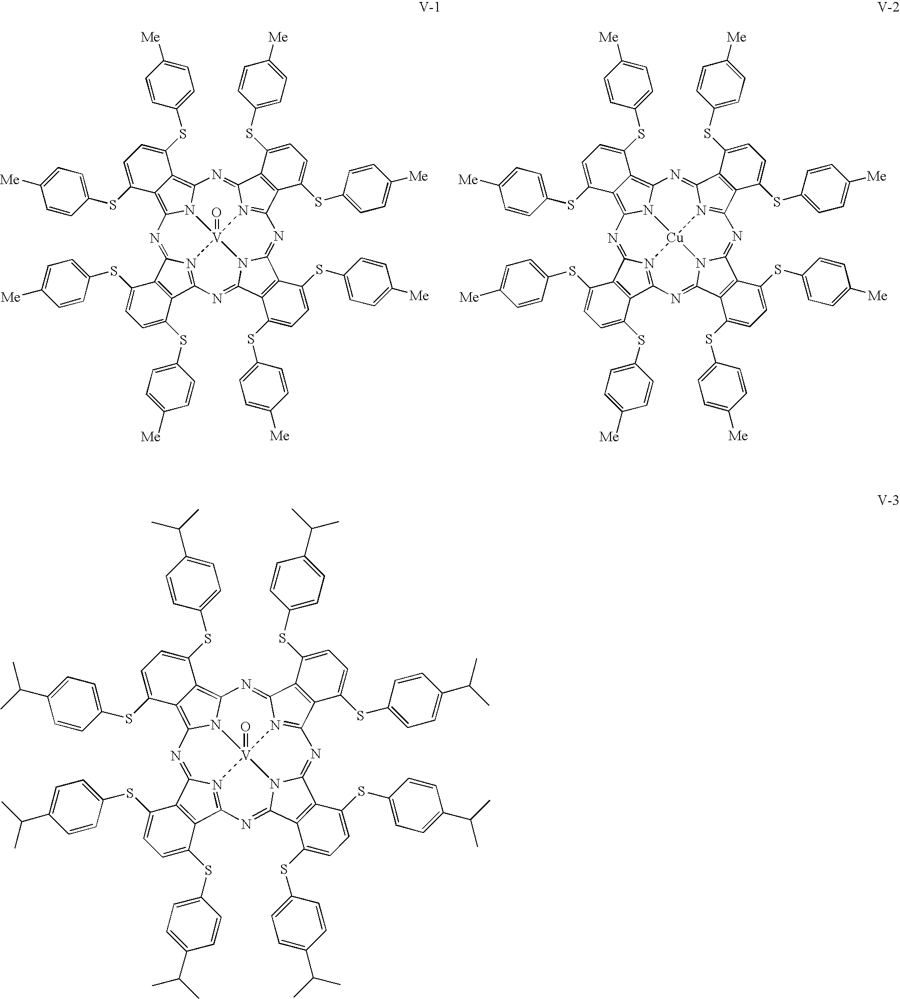

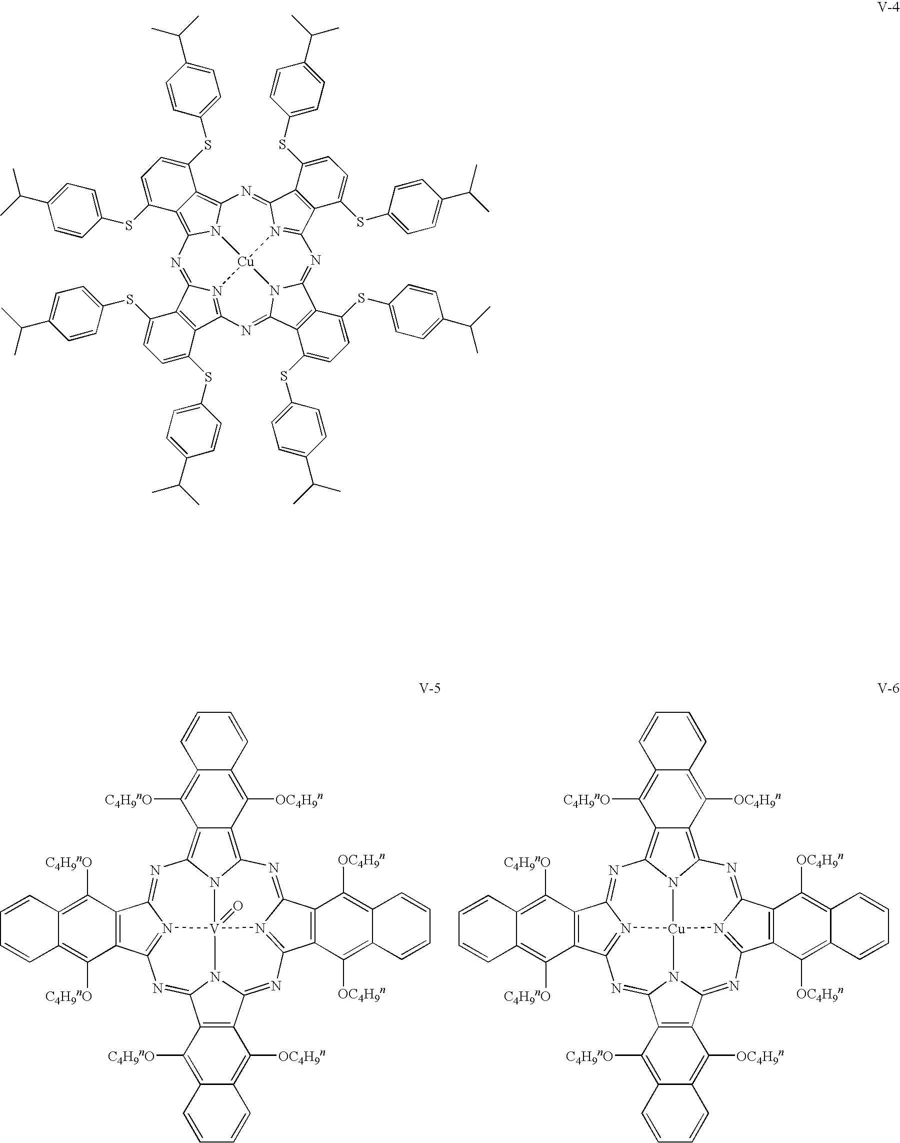

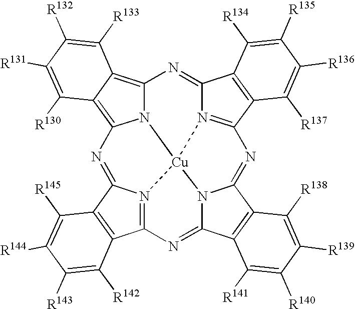

| Compound | |
|---|---|
| No. | |
| V-7 | R¹³¹ = R¹³² = R¹³⁵ = R¹³⁶ = R¹³⁹ = R¹⁴⁰ = R¹⁴³ = R¹⁴⁴ = |
| | R¹³⁰ = R¹³⁴ = R¹³⁸ = R¹⁴² = |
| | 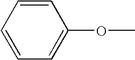 |
| | R¹³³ = R¹³⁷ = R¹⁴¹ = |
| | 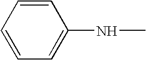 |
| | R¹⁴⁵ = F— |
| V-8 | R¹³¹ = R¹³² = R¹³⁵ = R¹³⁶ = R¹³⁹ = R¹⁴⁰ = R¹⁴³ = R¹⁴⁴ = |
| | 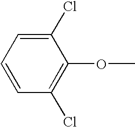 |
| | R¹³⁰ = R¹³⁴ = R¹³⁸ = R¹⁴² = |
| | 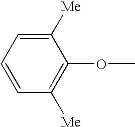 |
| | R¹³³ = R¹³⁷ = R¹⁴¹ = |
| | 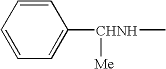 |
| | R¹⁴⁵ = F— |
| V-9 | R¹³¹ = R¹³² = R¹³⁵ = R¹³⁶ = R¹³⁹ = R¹⁴⁰ = R¹⁴³ = R¹⁴⁴ = |
| | 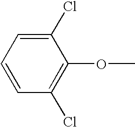 |
| | R¹³⁰ = R¹³⁴ = R¹³⁸ = R¹⁴² = |
| | 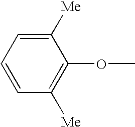 |
| | R¹³³ = R¹³⁷ = R¹⁴¹ = |
| | 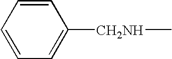 |
| | R¹⁴⁵ = F— |

These phthalocyanine dyes may be synthesized with reference to synthetic methods described in European Patent No. 0155780, JP-T-2005-537319, JP-A-2001-106689, and JP-A-2005-220060.

As a metal chelate dye, it is possible to use dyes described in, for example, JP-A-63-2275987, JP-A-2007-70499, JP-A-2007-119722, JP-A-2007-118227, JP-A-2008-111939, A. L. Balch et. al., Inorganic Chemistry, vol. 14, page 2724 (1975).

As a rylene-series dye, it is possible to use dyes described in, for example, K. Mullen et. al., Angew. Chem. Int. Ed., vol. 34, page 1323 (1995), K. Mullen et. al., Angew. Chem. Int. Ed., vol. 45, page 1401 (2006), K. Mullen et. al., Chem. Commun., page 2778 (2002), K. Mullen et. al., J. Org. Chem., vol. 72, page 10243 (2007).

As an aminium dye, it is possible to use dyes described in, for example, JP-A-2003-280247, JP-A-2003-295496, JP-A-2004-145036, JP-A-2007-92060.

As a quinone dye, it is possible to use dyes described in, for example, W. Ott et. al., Angew. Chem. Int. Ed., vol. 20, page 982 (1981), Y. Kubo et. al., Chemistry Letters, page 2057 (1987), K. Müllen et. al., Dyes and Pigments, vol. 75, page 1 (2007), JP-A-60-15458.

Further, it is possible to use other infrared absorbing dyes described in, for example, Angew. Chem., Int. Ed, published in 2006, vol. 45, No. 9, page 1401, and U.S. Pat. No. 5,986,099. Specific examples of these other infrared absorbing dyes are described below.

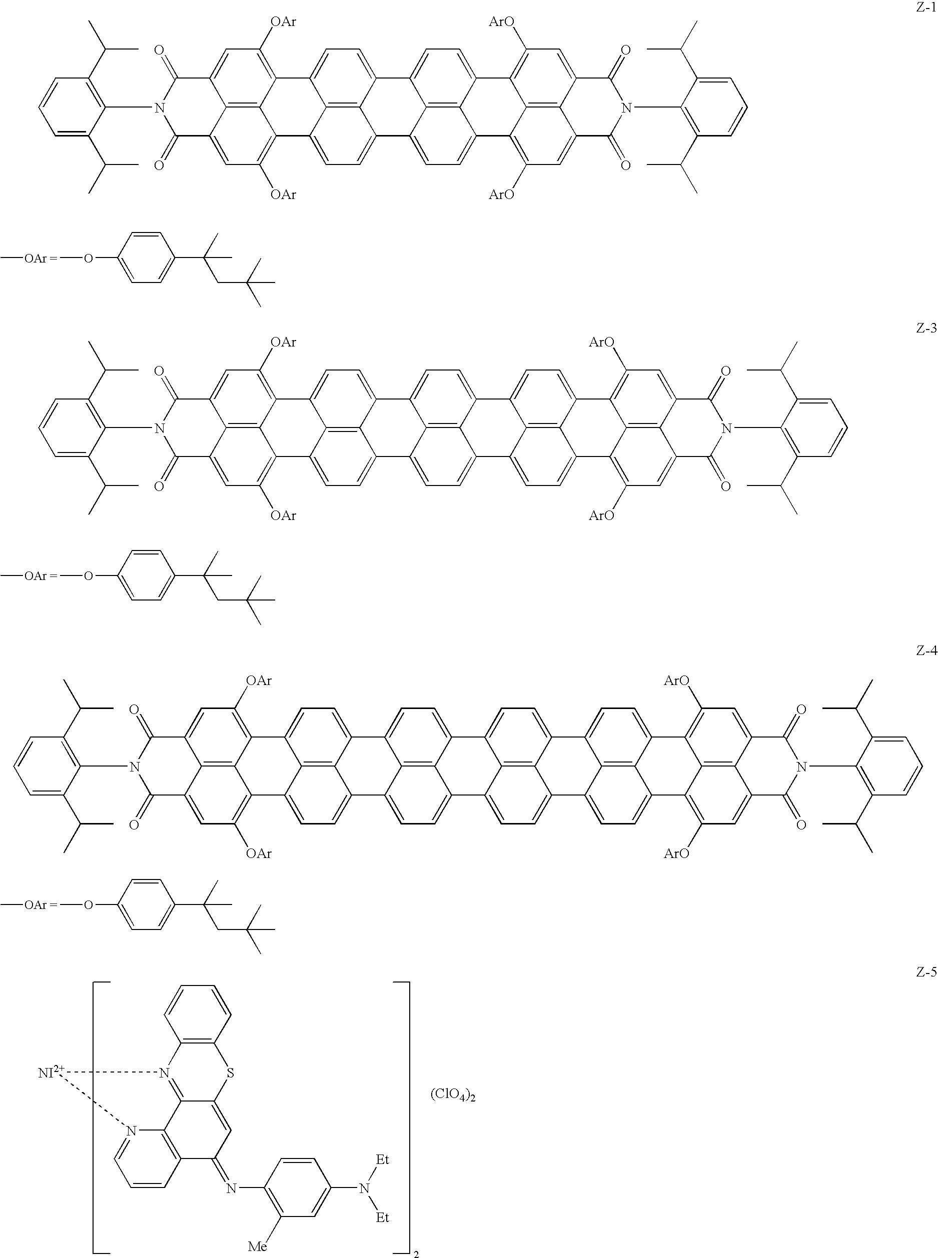

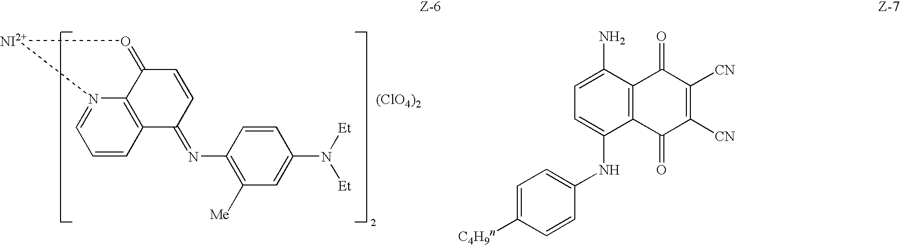

In the present invention, two or more kinds of infrared-absorbing dyes or pigments may be used in combination. The infrared-absorbing dye or pigment is dissolved in a proper solvent to prepare solution, and the solution may be added to the infrared absorbing layer-coating liquid. The used amount of the infrared-absorbing dye or pigment is preferably in the range of 0.01 g/m² to 2.00 g/m², and more preferably from 0.05 g/m² to 1.00 g/m². It is also possible to add a solid fine particle dispersion of the infrared absorbing dye (so-called pigments are embraced in this category) to the infrared absorbing layer-coating liquid. The solid fine particle dispersion of the dye is described in JP-A-2-282244, JP-A-3-138640, and Japanese Patent Application No. 7-269097. In order to obtain a solid fine particle dispersion of the infrared absorbing dye, a known disperser may be used. Examples of the disperser include ball mill, vibrating ball mill, planetary ball mill, sand mill, colloid disperser, jet mill, and roller mill. Details of the mill are described in JP-A-52-92716 and WO 88/074794. As the disperser, a vertical or horizontal medium disperser is preferable. The dispersion may be conducted in the presence of a suitable medium. A surfactant for dispersion may be also used.

### [Film]

An embodiment of the present invention is a film having an infrared range selective reflection layer formed by using the composition necessary for the present invention on the surface of a support made of a polymer film or the like. When a coat that has been formed by using the composition necessary for the present invention has a self-supporting property, the film of the present invention may be solely made of the coat.

According to the present invention, it is possible to provide coats and films, both of which reflect selectively a ray of light in the infrared wavelength, and enable to develop functions as advertising media and visual amenity developing media as well as a designing property, and/or the coat and film enabling to penetrate an infrared ray in a period, for example, the winter season in which light irradiation energy is small, although the coat and film enable to block the infrared ray in a period, for example, the summer season in which light irradiation energy is large.

In the present invention, it is possible to more easily control a selective reflection of light ray of various wavelengths by using a structural color represented by multilayer interference, photonic crystal, cholesteric crystal and the like, or by controlling change in its structure, compared to the previous techniques. In other words, according to the present invention, it is possible to provide an infrared region selective reflection coat and an infrared region selective reflection film, each of which is capable of control the selective reflection over a wide wavelength range by using a change in structure owing to light absorption of the light-sensitive functional group, or by using heat generation owing to light absorption of the infrared-absorbing dye or pigment.

Specifically, when a change in structure owing to light absorption of the light-sensitive functional group is used, a helical pitch becomes larger in a period, for example, the summer months in which light irradiation energy is lager than a period, for example, the winter months in which light irradiation energy is small, owing to the presence of a compound having a light-sensitive functional group capable of making the helical pitch larger upon exposure to light. As a result, the selective reflection wavelength is made longer, and a reflection amount of infrared ray can be increased. Namely, although the coat and the film of the present invention blocks infrared ray in sunlight during a period, for example the summer, the same compound is able to transmit the infrared ray during a period, for example the winter.

On the other hand, when an infrared-absorbing dye or pigment is used, heat is generated owing to light absorption of the infrared-absorbing dye or pigment. As a result, a layer exhibiting a structural color is swollen, thereby making reflection wavelength longer. The thickness of the layer exhibiting a structural color becomes larger in a period, for example, the summer months in which light irradiation energy is lager, compared to a period, for example, the winter months in which light irradiation energy is small. As a result, the selective reflection wavelength is made longer, and a reflection amount of infrared ray can be increased. Namely, although the coat and the film of the present invention blocks infrared ray in sunlight during a period, for example the summer, the same compound is able to transmit the infrared ray during a period, for example the winter.

Both infrared region selective reflection coat and infrared region selective reflection film of the present invention are able to form a pattern, and also able to change an infrared range selective reflection property in accordance with change of temperature. For this reason, according to the present invention, it is possible to easily prepare the infrared region selective reflection coat and the infrared region selective reflection film that provide a desirable designing property and/or exhibit climate change adaptability. This film is useful for application to a window glass as an infrared region selective reflection film.

### EXAMPLES

The present invention will be described in more detail based on the following examples. Any materials, reagents, amount and ratio of use and operations, as shown in the examples, may appropriately be modified without departing from the spirit and scope of the present invention. It is therefore understood that the present invention is by no means intended to be limited to the specific examples below.

### Example 1

### Effect of Infrared Absorbent

A solution was prepared by adding 3% by weight of Irg 907 (trade name, manufactured by Ciba Specialty Chemicals Inc.) and 1% by weight of DETX (trade name, manufactured by Nippon Kayaku Co., Ltd.) to a 2-butanone solution composed of 90% by weight of LC-1, 5% by weight of LC-2, and 5% by weight of LC-4 (chiral compound). The resultant solution was coated and dried on the surface of a glass substrate having coated thereon SE 150 (trade name, manufactured by Nissan Chemical Industries, Ltd.) as an alignment layer, and having been subjected to a rubbing treatment. A coating amount in this process was 2.9 g/m² with respect to the liquid crystalline compound, 0.15 g/m² with respect to the chiral compound, and 0.1 g/m² with respect to the photo polymerization initiator, respectively. Then, exposure (100 mW/cm², 10 seconds) was conducted with UV light (EXECURE 3000 (trade name, manufactured by HOYA CORPORATION)). On the thus-obtained coat, a liquid (infrared absorbent gelatin solution), that was obtained by adding 0.6 g of dispersion formed by dispersing a mixture of 0.5 g of Exemplified infrared pigment D-53, 0.05 g of EMULGEN A60 (trade name, manufactured by Kao Corporation), 10 g of zirconia beads (0.1 mm), and 4.5 g of distilled water, using a planetary type ball mill (a product of German FRITSCH), to 2.0 g of 4% by mass gelatin aqueous solution at 40° C., and then mixing the resultant, was coated and dried. The spectral absorption characteristics of the resultant film were optical density: 1.11, and half bandwidth: about 40 nm at λmax 980 nm. The coating amount of the Exemplified infrared pigment was 0.15 g/m². The thus-obtained sample was stored at 5° C. for 24 hours, and then exposed using a xenon lamp (a product of HAMAMATSU Photonics K.K.) for 30 minutes. The central wavelength of the selective reflection band was shifted from 750 nm to 760 nm owing to temperature increase of the sample. The selective reflection band was shifted from the range of 700 nm to 800 nm to that of 710 nm to 810 nm. As a result, the sample was able to reflect longer infrared rays than the previous one. However, the effect of infrared shift was minor. On the other hand, the same sample as the above was stored at 26° C. for 24 hours, and then exposed using a xenon lamp (a product of HAMAMATSU Photonics K.K.) for 30 minutes. The central wavelength of the selective reflection band was shifted from 750 nm to 800 nm owing to temperature increase of the sample. The selective reflection band was shifted from the range of 700 nm to 800 nm to that of 750 nm to 850 nm. As a result, the 26° C. stored sample was able to reflect longer infrared rays than the 5° C. stored sample.

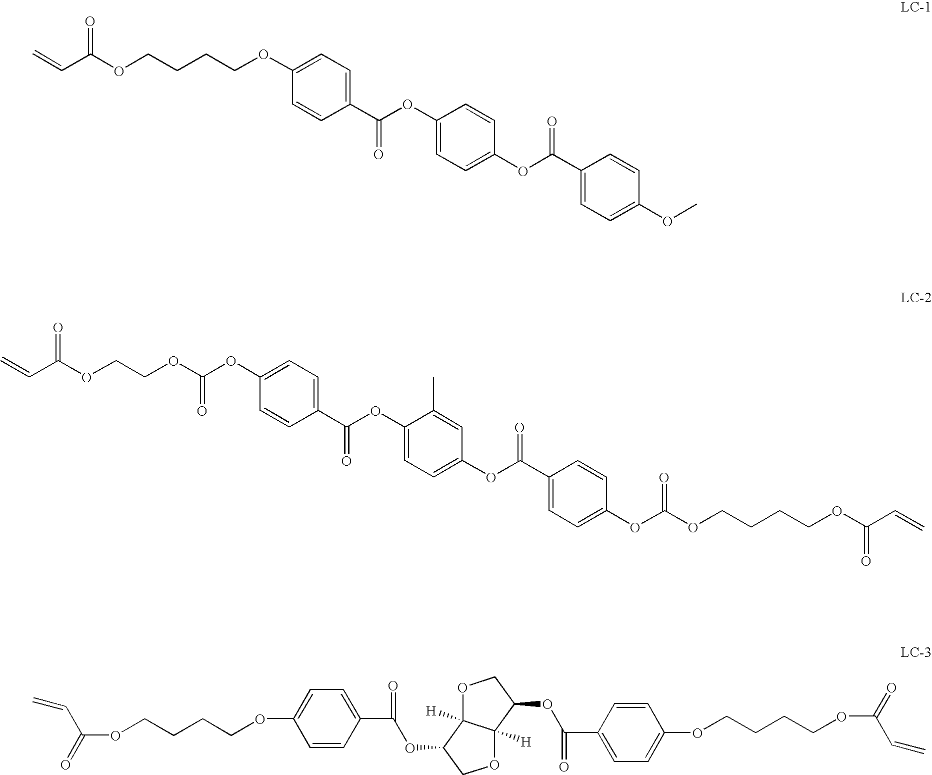

### Example 2

### Effect of Infrared Absorbent

A solution was prepared by adding 3% by weight of Irg 907 (trade name, manufactured by Ciba Specialty Chemicals Inc.) and 1% by weight of DETX (trade name, manufactured by Nippon Kayaku Co., Ltd.) to a 2-butanone solution composed of 90% by weight of LC-1, 5% by weight of LC-2, and 5% by weight of LC-4 (chiral compound). The resultant solution was coated and dried on the surface of a glass substrate having coated thereon SE 150 (trade name, manufactured by Nissan Chemical Industries, Ltd.) as an alignment layer, and having been subjected to a rubbing treatment. A coating amount in this process was 2.9 g/m² with respect to the liquid crystalline compound, 0.15 g/m² with respect to the chiral compound, and 0.1 g/m² with respect to the photo polymerization initiator, respectively. Then, exposure (100 mW/cm², 10 seconds) was conducted with UV light (EXECURE 3000 (trade name, manufactured by HOYA CORPORATION)). On the thus-obtained coat, a liquid (infrared absorbent gelatin solution), that was obtained by adding 0.72 g of dispersion formed by dispersing a mixture of 0.05 g of Exemplified infrared pigment P-1, 0.02 g of dodecylbenzenesulfonic acid, 5 g of zirconia beads (0.1 mm), and 5.0 g of distilled water, using a planetary type ball mill (a product of German FRITSCH), to 0.28 g of 10% by mass gelatin aqueous solution at 40° C., and then mixing the resultant, was coated and dried. The spectral absorption characteristics of the resultant film were optical density: 0.36, and half bandwidth: about 75 nm at λmax 851 nm. The coating amount of the Exemplified infrared pigment was 0.18 g/m². The thus-obtained sample was stored at 5° C. for 24 hours, and then exposed using a xenon lamp (a product of HAMAMATSU Photonics K.K.) for 30 minutes. The central wavelength of the selective reflection band was shifted from 750 nm to 755 nm. The selective reflection band was shifted from the range of 700 nm to 800 nm to that of 705 nm to 805 nm. The same sample as the above was stored at 26° C. for 24 hours, and then exposed using a xenon lamp (a product of HAMAMATSU Photonics K.K.) for 30 minutes. The central wavelength of the selective reflection band was shifted from 750 nm to 800 nm owing to temperature increase of the sample. The selective reflection band was shifted from the range of 700 nm to 800 nm to that of 750 nm to 850 nm.

### Example 3

### Effect of Infrared Absorbent

A solution was prepared by adding 3% by weight of Irg 907 (trade name, manufactured by Ciba Specialty Chemicals Inc.) and 1% by weight of DETX (trade name, manufactured by Nippon Kayaku Co., Ltd.) were added to a 2-butanone solution composed of 90% by weight of LC-1, 5% by weight of LC-2, and 5% by weight of LC-4 (chiral compound). The resultant solution was coated and dried on the surface of a glass substrate having coated thereon SE 150 (trade name, manufactured by Nissan Chemical Industries, Ltd.) as an alignment layer, and having been subjected to a rubbing treatment. A coating amount in this process was 2.9 g/m² with respect to the liquid crystalline compound, 0.15 g/m² with respect to the chiral compound, and 0.1 g/m² with respect to the photo polymerization initiator, respectively. Then, exposure (100 mW/cm², 10 seconds) was conducted with UV light (EXECURE 3000 (trade name, manufactured by HOYA CORPORATION)). On the thus-obtained coat, a liquid (infrared absorbent gelatin solution), that was obtained by adding 0.12 g of dispersion formed by dispersing a mixture of 0.3 g of Exemplified infrared pigment O-5, 0.78 g of NEOGEN SC (trade name, manufactured by Dai-ichi Kogyo Seiyaku Co., Ltd.), 5 g of zirconia beads (0.1 mm), and 1.49 g of distilled water, using a planetary type ball mill (a product of German FRITSCH), to 0.30 g of 10% by mass gelatin aqueous solution at 40° C., and further adding 0.58 g of distilled water, and then mixing the resultant, was coated and dried. The spectral absorption characteristics of the resultant film were optical density: 0.70, and half bandwidth: about 112 nm at λmax 858 nm. The coating amount of the Exemplified infrared pigment was 0.07 g/m². The thus-obtained sample was stored at 5° C. for 24 hours, and then exposed using a xenon lamp (a product of HAMAMATSU Photonics K.K.) for 30 minutes. The central wavelength of the selective reflection band was shifted from 750 nm to 760 nm. The selective reflection band was shifted from the range of 700 nm to 800 nm to that of 710 nm to 810 nm. The same sample as the above was stored at 26° C. for 24 hours, and then exposed using a xenon lamp (a product of HAMAMATSU Photonics K.K.) for 30 minutes. The central wavelength of the selective reflection band was shifted from 750 nm to 800 nm owing to temperature increase of the sample. The selective reflection band was shifted from the range of 700 nm to 800 nm to that of 750 nm to 850 nm.

### Example 4

### Effect of Polymerizable Liquid Crystalline Compound

An infrared ray selective reflection film was prepared in the same manner as the selective reflection film of Example 1, except that the Exemplified polymerizable liquid crystalline compound I-1) was used in place of LC-1. The thus-obtained sample was stored at 5° C. for 24 hours, and then exposed using a xenon lamp (a product of HAMAMATSU Photonics K.K.) for 30 minutes. The central wavelength of the selective reflection band was shifted from 750 nm to 760 nm. The selective reflection band was shifted from the range of 700 nm to 800 nm to that of 710 nm to 810 nm. Further, the same sample as the above was stored at 26° C. for 24 hours, and then exposed using a xenon lamp (a product of HAMAMATSU Photonics K.K.) for 30 minutes. The central wavelength of the selective reflection band was shifted from 750 nm to 800 nm owing to temperature increase of the sample. The selective reflection band was shifted from the range of 700 nm to 800 nm to that of 750 nm to 850 nm.

### Example 5

### Effect of Chiral Compound

An infrared ray selective reflection film was prepared in the same manner as the elective reflection film of Example 1, except that chiral compound A-1 was used in place of LC-4. The thus-obtained sample was stored at 5° C. for 24 hours, and then exposed using a xenon lamp (a product of HAMAMATSU Photonics K.K.) for 30 minutes. The central wavelength of the selective reflection band was shifted from 750 nm to 760 nm. The selective reflection band was shifted from the range of 700 nm to 800 nm to that of 710 nm to 810 nm. Further, the same sample as the above was stored at 26° C. for 24 hours, and then exposed using a xenon lamp (a product of HAMAMATSU Photonics K.K.) for 30 minutes. The central wavelength of the selective reflection band was shifted from 750 nm to 800 nm owing to temperature increase of the sample. The selective reflection band was shifted from the range of 700 nm to 800 nm to that of 750 nm to 850 nm.

### Example 6

### Patterning by Optical Irradiation

A solution was prepared by adding 3% by weight of Irg 907 (trade name, manufactured by Ciba Specialty Chemicals Inc.) and 1% by weight of DETX (trade name, manufactured by Nippon Kayaku Co., Ltd.) to a 2-butanone solution composed of 89.5% by weight of LC-1, 5% by weight of LC-2, and 5.5% by weight of LC-3 (chiral compound). The resultant solution was coated and dried so as to be 3 μm of thickness on the surface of a glass substrate having thereon coated SE 150 (trade name, manufactured by Nissan Chemical Industries, Ltd.) as an alignment layer and having been subjected to a rubbing treatment. The coating amount in this process was 2.8 g/m² with respect to the liquid crystalline compound, 0.16 g/m² with respect to the chiral compound, and 0.1 g/m² with respect to the photo polymerization initiator, respectively. Then, patterning exposure (100 mW/cm², 10 seconds) was conducted with UV light (EXECURE 3000 (trade name, manufactured by HOYA CORPORATION)) through a checkerwise patterned mask and a band-pass filter having a center of the band pass at 365 nm. Thereafter, both the mask and the band-pass filter were substituted with a sharp cut filter that transmitted light of 400 nm or more (50% transmission at 400 nm). Through the sharp cut filter, overall exposure was conducted with the same UV light source as described above, while splaying nitrogen gas to the sample. The selective reflection wavelength of the pattern exposed area was almost colorless (the central wavelength of the selective reflection band was 900 nm, and a half bandwidth (the selective wavelength band width) was 150 nm (selective reflection band: 825 nm to 975 nm)). On the other hand, the selective reflection wavelength of the non-pattern exposed area was almost red color (the central wavelength of the selective reflection band was 650 nm, and a half bandwidth was 150 nm (selective reflection band: 575 nm to 725 nm)). As a result, it is understood that it is possible to form a patterning with a designing property that has an infrared ray reflection portion and a visible range reflection portion in the same sample.

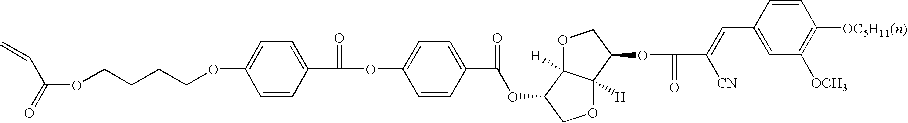

### Example 7

### Effect of Chiral Compound

A coat was formed in the same manner as the coat of Example 6, except that Exemplified chiral compound C-1 was used in place of the chiral compound LC-3. The selective reflection wavelength of the pattern exposed area was almost colorless (the central wavelength of the selective reflection band was 900 nm, and a half bandwidth was 150 nm (selective reflection band: 825 nm to 975 nm)). On the other hand, the selective reflection wavelength of the non-pattern exposed area was almost red color (the central wavelength of the selective reflection band was 640 nm, and a half bandwidth was 150 nm (selective reflection band: 565 nm to 715 nm)). As a result, it is understood that it is possible to form a patterning with a designing property that has an infrared ray reflection portion and a visible range reflection portion in the same sample.

### Example 8

### Effect of Chiral Compound

A coat was formed in the same manner as the coat of Example 6, except that Exemplified chiral compound C-5 was used in place of the chiral compound LC-3. The selective reflection wavelength of the pattern exposed area was almost colorless (the central wavelength of the selective reflection band was 900 nm, and a half bandwidth was 150 nm (selective reflection band: 825 nm to 975 nm)). On the other hand, the selective reflection wavelength of the non-pattern exposed area was almost red color (the central wavelength of the selective reflection band was 640 nm, and a half bandwidth was 150 nm (selective reflection band: 565 nm to 715 nm)). As a result, it is understood that it is possible to form a patterning with a designing property that has an infrared ray reflection portion and a visible range reflection portion in the same sample.

### Example 9

### Patterning by Light Exposure and Effect of Infrared Ray Absorber

A sample was prepare in the same manner as in Example 2, except that a 2-butanone solution, in which the amount of each of LC-1, LC-2 and LC-4 was changed to 87.8% by weight, 5% by weight, and 7.2% by weight, respectively, was used and then exposed to light in the same manner as in Example 2. The selective reflection wavelength of the exposed area was almost colorless (the central wavelength of the selective reflection band was 750 nm, and a half bandwidth was 150 nm (selective reflection band: 675 nm to 825 nm)). On the other hand, the selective reflection wavelength of the non-pattern exposed area was almost magenta color (the central wavelength of the selective reflection band was 550 nm, and a half bandwidth was 150 nm (selective reflection band: 475 nm to 625 nm)). On the thus-obtained sample, the same infrared absorbent gelatin solution as used in Example 1 was coated and dried. Then, exposure was conducted using a xenon lamp in the same manner as in Example 1. As a result, the central wavelength of the selective reflection band was shifted to the longer wavelength direction by about 50 nm with respect to both the exposure area and the non-exposure area. In view of the above, it is understood that it is possible to form a patterning with a designing property that has an infrared ray reflection portion and a visible range reflection portion in the same sample, and further it is possible to change infrared reflection properties.

Having described our invention as related to the present embodiments, it is our intention that the invention not be limited by any of the details of the description, unless otherwise specified, but rather be construed broadly within its spirit and scope as set out in the accompanying claims.

What we claim is:

1. An infrared region selective reflection coat, comprising a layer exhibiting a structural color of which a central wavelength of a selective reflection band is in the range of 700 nm to 2,000 nm,
wherein the infrared region selective reflection coat satisfies at least one of the following requirements A and B:
A: the layer exhibiting a structural color contains a compound having a light-sensitive functional group; and
B: the infrared region selective reflection coat further comprises a layer containing an infrared-absorbing dye or pigment having absorption maximum in the range of 700 nm to 2,000 nm and a half bandwidth of its absorption band in the range of 20 nm to 200 nm.

2. The infrared region selective reflection coat according to claim 1, wherein a selective reflection band width of the layer exhibiting a structural color is in the range of 100 nm to 400 nm.

3. The infrared region selective reflection coat according to claim 1, wherein the selective reflection band width of the layer exhibiting a structural color is wider than the half bandwidth of absorption band of the infrared-absorbing dye or pigment.

4. The infrared region selective reflection coat according to claim 1, wherein the layer exhibiting a structural color contains a cholesteric liquid crystalline phase.

5. The infrared region selective reflection coat according to claim 4, wherein at least one of compounds forming the cholesteric liquid crystalline phase is represented by formula (I):
Q¹-L¹-Cy¹-L²-(Cy²-L³)n-Cy³-L⁴-Q² Formula (I)
wherein at least one of Q¹ and Q² is a polymerizable group; when only one of Q¹ and Q² is a polymerizable group, the other represents a hydrogen atom or an alkyl group; L¹ and L⁴ each independently represent a divalent linking group; L² and L³ each independently represent a single bond or a divalent linking group; Cy¹, Cy² and Cy³ each independently represent a divalent cyclic group; and n represents 0, 1 or 2.

6. The infrared region selective reflection coat according to claim 1, wherein the layer containing an infrared-absorbing dye or pigment comprises at least one kind of a cyanine dye, an oxonol dye, a squarylium dye, a diimmonium dye, an azomethine dye, a phthalocyanine dye, a metal chelate dye, a rylene-series dye, an aminium dye, and a quinone dye.

7. The infrared region selective reflection coat according to claim 4, wherein the layer exhibiting a structural color contains a compound forming the cholesteric liquid crystalline phase together with a compound capable of changing a helical pitch owing to light sensitivity as the compound having a light-sensitive functional group.

8. The infrared region selective reflection coat according to claim 7, wherein the compound having a light-sensitive functional group is selected from the group consisting of cinnamic acid derivatives, azo benzene derivatives and binaphthol derivatives.

9. The infrared region selective reflection coat according to claim 1, comprising a pattern formed by at least one visible range selective reflection area and at least one infrared range selective reflection area.

10. An infrared region selective reflection film, comprising a transparent support, and the infrared range selective reflection coat according to claim 1 formed on the transparent support.

11. The infrared region selective reflection film according to claim 10, wherein the layer exhibiting a structural color and the layer containing an infrared-absorbing dye or pigment are provided with the transparent support in this order from the support.
